(19) United States
(12) Patent Application Publication
(10) Pub. No.: US 2017/0050349 A1
(43) Pub. Date: Feb. 23, 2017

(54) INORGANIC PARTICLE COMPOSITE BODY AND METHOD FOR PRODUCING INORGANIC PARTICLE COMPOSITE BODY

(71) Applicant: Sumitomo Chemical Company, Limited, Tokyo (JP)

(72) Inventors: Makiko HARA, Sodegaura-shi (JP); Makoto NAGATA, Chiba-shi (JP); Taiichi SAKAYA, (US)

(21) Appl. No.: 15/278,872

(22) Filed: Sep. 28, 2016

Related U.S. Application Data
(62) Division of application No. 13/376,008, filed on Jan. 19, 2012, now abandoned.

(30) Foreign Application Priority Data
Jun. 5, 2009 (JP) 2009-135913
Aug. 31, 2009 (JP) 2009-199765
Aug. 31, 2009 (JP) 2009-199766
Aug. 31, 2009 (JP) 2009-199767
Aug. 31, 2009 (JP) 2009-199768
Aug. 31, 2009 (JP) 2009-199769
Aug. 31, 2009 (JP) 2009-199770
Aug. 31, 2009 (JP) 2009-199771
Aug. 31, 2009 (JP) 2009-199772

(51) Int. Cl. B29C 43/00; B29C 70/64; B05D 1/30; B29C 70/60

(52) U.S. Cl. CPC B29C 43/003; B29C 70/606; B29C 70/64; B05D 1/30; B29K 2105/16

(57) ABSTRACT

There is provided an inorganic particle composite body comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate, wherein part of the solid material is in at least part of the gaps in the inorganic particle layer. This inorganic particle composite body is produced by a method including a preparation step of preparing an inorganic particle structural body comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate; and a filling step of plastically deforming at least part of the solid material contained in the inorganic particle structural body, thereby filling at least part of the gaps in the inorganic particle layer with part of the plastically deformed solid material.

### CROSS-REFERENCE TO RELATED APPLICATION

This application is a divisional of co-pending U.S. patent application Ser. No. 13/376,008, filed Dec. 2, 2011, which is a Section 371 of International Application No. PCT/JP2010/059894, filed Jun. 4, 2010, which was published in the Japanese language on Dec. 9, 2010 under International Publication No. WO 2010/140713 A1, the disclosures of which are all incorporated herein by reference herein.

### TECHNICAL FIELD

The present invention relates to inorganic particle composite bodies and methods for producing inorganic particle composite bodies.

### BACKGROUND ART

Front panels of flat panel displays, displays of portable instruments such as cellular phones, and the like have been provided with treatment to increase surface hardness for the purpose of prevention of scratching, more specifically, treatment to form a hardcoat layer. Conventionally known technologies to form a hardcoat layer on a substrate includes a method comprising applying a mixture of inorganic particles, an ultraviolet-curable resin, and so onto a substrate and then ultraviolet curing it, and a method comprising laminating a coating material made of only a silica precursor or a mixture of a silica precursor and inorganic particles on a substrate and the curing the coating material by the sol-gel method (see JP 2008-150484 A and JP 2007-529588 T).

In the above-described conventional technologies, however, since a hardcoat layer containing inorganic particles is different from a substrate in properties (e.g., modulus of elasticity and coefficient of linear expansion), the higher the surface hardness of a hardcoat layer is made, the more liable to peel off the hardcoat layer is. In addition, when a film made only of the hardcoat layer has been formed by removing the substrate, the harder the film is, the more brittle the film is, and the surface hardness of a film decreases as the brittleness of the film is reduced.

### DISCLOSURE OF THE INVENTION

An object of the present invention is to provide an inorganic particle composite body having reduced brittleness or reduced ease in peeling while having surface hardness derived from inorganic particles, and a method for producing such an inorganic particle composite body.

The present invention provides the following [1] through [12].

[1] Inorganic particle composite body comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate, wherein part of the solid material is in at least part of the gaps in the inorganic particle layer.
[2] The inorganic particle composite body according to [1], wherein the surface of the inorganic particle composite body has hydrophilicity.
[3] The inorganic particle composite body according to [1], wherein the surface of the inorganic particle composite body has hydrophobicity.
[4] The inorganic particle composite body according to [1], wherein the surface of the inorganic particle composite body is antireflective.
[5] The inorganic particle composite body according to [1], wherein the inorganic particle composite body further has a glass layer adjoining to the inorganic particle layer.
[6] The inorganic particle composite body according to [1], wherein the inorganic particles comprise silica.
[7] The inorganic particles composite body according to [1], wherein the inorganic particles comprise an inorganic layered compound.
[8] The inorganic particle composite body according to [1], wherein the solid material is a resin.
[9] The inorganic particle composite body according to [1], wherein the solid material is a metal.
[10] A method for producing an inorganic particle composite body comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate, wherein part of the solid material is in at least part of the gaps in the inorganic particle layer, wherein the method comprises:
a preparation step of preparing an inorganic particle structural body comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate, and
a filling step of plastically deforming at least part of the solid material contained in the inorganic particle structural body, thereby filling at least part of the gaps in the inorganic particle layer with at least part of the plastically deformed solid material.
[11] The method according to [10], wherein the solid material is plastically deformed by pressurizing the inorganic particle structural body in the filling step.
   [12] The method according to [10], wherein the solid material is plastically deformed by applying an electromagnetic wave to the inorganic particle structural body in the filling step.
   [13] The method according to [10], wherein the method further comprises a step of applying hydrophilization to the surface of the structural body produced by carrying out the filling step.
   [14] The method according to [10], wherein the method further comprises a step that is a step of applying hydrophilization to the surface of the inorganic particles structural body and that is carried out before carrying out the filling step.
   [15] The method according to [10], wherein the method further comprises a step of applying hydrophobization to the surface of the structural body produced by carrying out the filling step.
   [16] The method according to [10], wherein the method further comprises a step that is a step of applying hydrophobization to the surface of the inorganic particle structural body and that is carried out before carrying out the filling step.
   [17] The method according to [10], wherein the method further comprises a step of applying antireflecting treatment to the surface of the structural body produced by carrying out the filling step.
   [18] The method according to [10], wherein the method further comprises a step that is a step of applying antireflecting treatment to the surface of the inorganic particle structural body and that is carried out before carrying out the filling step.
   [19] The method according to [10], wherein the method further comprises a step of giving a glass layer to the surface of the structural body produced by carrying out the filling step.
   [20] The method according to [10], wherein the method further comprises a step that is a step of giving a glass layer to the surface of the inorganic particle structural body and that is carried out before carrying out the filling step.

According to the present invention, it is possible to obtain an inorganic particle composite body having reduced brittleness or reduced ease in peeling while keeping surface hardness derived from inorganic particles.

### BRIEF DESCRIPTION OF THE DRAWINGS

FIG. 1 is a schematic diagram of inorganic particle structural body 3a.

FIG. 2 is a schematic diagram of inorganic particle composite body 4a obtained by pressurizing inorganic particle structural body 3a.

FIG. 3 is a schematic diagram of inorganic particle structural body 3b.

FIG. 4 is a schematic diagram of inorganic particle composite body 4b obtained by pressurizing inorganic particle structural body 3b.

FIG. 5 is a schematic diagram of inorganic particle structural body 3c.

FIG. 6 is a schematic diagram of inorganic particle composite body 4c obtained by pressurizing inorganic particle structural body 3c.

FIG. 7 is a schematic diagram of inorganic particle structural body 3d.

FIG. 8 is a schematic diagram of inorganic particle composite body 4d obtained by pressurizing inorganic particle structural body 3d.

FIG. 9 is a schematic diagram of inorganic particle structural body 3e.

FIG. 10 is a schematic diagram of inorganic particle composite body 4e obtained by pressurizing inorganic particle structural body 3e.

FIG. 11 is a schematic diagram of inorganic particle structural body 3f.

FIG. 12 is a schematic diagram of inorganic particle composite body 4f obtained by pressurizing inorganic particle structural body 3f.

FIG. 13 is a schematic diagram of inorganic particle structural body 3g.

FIG. 14 is a schematic diagram of inorganic particle composite body 4g obtained by pressurizing inorganic particle structural body 3g.

FIG. 15 is a schematic diagram of inorganic particle structural body 3h.

FIG. 16 is a schematic diagram of inorganic particle composite body 4h obtained by pressurizing inorganic particle structural body 3h.

FIG. 17 is a schematic diagram of hydrophilic inorganic particle composite body 5a obtained by applying hydrophilization to inorganic particle composite body 4a.

FIG. 18 is a schematic diagram of hydrophilic inorganic particle composite body 5b obtained by applying hydrophilization to inorganic particle composite body 4b.

FIG. 19 is a schematic diagram of hydrophilic inorganic particle composite body 5c obtained by applying hydrophilization to inorganic particle composite body 4c.

FIG. 20 is a schematic diagram of hydrophilic inorganic particle composite body 5d obtained by applying hydrophilization to inorganic particle composite body 4d.

FIG. 21 is a schematic diagram of hydrophobic inorganic particle composite body 7a obtained by applying hydrophobization to inorganic particle composite body 4a.

FIG. 22 is a schematic diagram of hydrophobic inorganic particle composite body 7b obtained by applying hydrophobization to inorganic particle composite body 4b.

FIG. 23 is a schematic diagram of hydrophobic inorganic particle composite body 7c obtained by applying hydrophobization to inorganic particle composite body 4c.

FIG. 24 is a schematic diagram of hydrophobic inorganic particle composite body 7d obtained by applying hydrophobization to inorganic particle composite body 4d.

FIG. 25 is a schematic diagram of antireflective inorganic particle composite body 9a obtained by applying antireflecting treatment to inorganic particle composite body 4a.

FIG. 26 is a schematic diagram of antireflective inorganic particle composite body 9b obtained by applying antireflecting treatment to inorganic particle composite body 4b.

FIG. 27 is a schematic diagram of antireflective inorganic particle composite body 9c obtained by applying antireflecting treatment to inorganic particle composite body 4c.

FIG. 28 is a schematic diagram of antireflective inorganic particle composite body 9d obtained by applying antireflecting treatment to inorganic particle composite body 4d.

FIG. 29 is a schematic diagram of stacked inorganic particle composite body 11a obtained by stacking glass to a surface of the inorganic particle layer of inorganic particle composite body 4a.

FIG. 30 is a schematic diagram of stacked inorganic particle composite body 11b obtained by stacking glass to a surface of the inorganic particle layer of inorganic particle composite body 4b.

FIG. 31 is a schematic diagram of inorganic particle structural body 3a.

FIG. 32 is schematic diagram 4a of an inorganic particle composite molded article obtained by molding inorganic particle structural body 3a.

FIG. 33 is a schematic diagram of inorganic particle structural body 3b.

FIG. 34 is schematic diagram 4b of an inorganic particle composite molded article obtained by molding inorganic particle structural body 3b.

FIG. 35 is a schematic diagram of the process (press molding) by which inorganic particle composite body 4a was molded.

FIG. 36 is a schematic diagram concerning a method of determining a volume fraction V (%) of a solid material with which an inorganic particle layer has been filled.

FIG. 37 is an SEM observation photograph of the inorganic particle composite body according to Example 2.

FIG. 38 is an SEM observation photograph of the inorganic particle composite body according to Example 4.

FIG. 39 is an SEM observation photograph of the inorganic particle structural body according to Comparative Example 1.

FIG. 40 is an SEM observation photograph of the inorganic particle structural body according to Comparative Example 9.

FIG. 41 is an SEM observation photograph of the inorganic particle composite body according to Example 17.

FIG. 42 is an SEM observation photograph of the inorganic particle composite body according to Example 24.

FIG. 43 is an SEM observation photograph of the inorganic particle structural body according to Comparative Example 11.

FIG. 44 is an SEM observation photograph of the inorganic particle composite body according to Example 39.

FIG. 45 is a cross-sectional SEM photograph of the inorganic particle structural body according to Comparative Example 25.

In the drawings, 1, 1a, 1b, 1c, 1d, 1e, 1f: inorganic particle; 2: solid material; 3a, 3b, 3c, 3d, 3e, 3f, 3g, 3h: inorganic particle structural body; 4a, 4b, 4c, 4d, 4e, 4f, 4g, 4h: inorganic particle composite body; 5a, 5b, 5c, 5d: hydrophilic inorganic particle composite body; 6: hydrophilized layer; 7a, 7b, 7c, 7d: hydrophobic inorganic particle composite body; 8: hydrophobized layer; 9a, 9b, 9c, 9d: antireflective inorganic particle composite body; 10: antireflective layer; 11a, 11b: inorganic particle composite body with glass stacked; 12: glass; 13: pressing mold; 14: inorganic particle existing region; 15: support.

### MODE FOR CARRYING OUT THE INVENTION

In a first aspect, the present invention is an inorganic particle composite body comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate, wherein part of the solid material is in at least part of the gaps in the inorganic particle layer.

In one preferable embodiment, the surface of the above-mentioned inorganic particle composite body is hydrophilic.

In another preferable embodiment, the surface of the above-mentioned inorganic particle composite body is hydrophobic.

In another preferable embodiment, the surface of the above-mentioned inorganic particle composite body is antireflective.

In another preferable embodiment, the above-mentioned inorganic particle composite body further has a glass layer adjoining to the aforementioned inorganic particle layer.

In another preferable embodiment, the aforementioned inorganic particles of the above-mentioned inorganic particle composite body comprise silica.

In another preferable embodiment, the aforementioned inorganic particles of the above-mentioned inorganic particle composite body comprise an inorganic layered compound.

In another preferable embodiment, the aforementioned solid material of the above-mentioned inorganic particle composite body is a resin.

In another preferable embodiment, the aforementioned solid material of the above-mentioned inorganic particle composite body is a metal.

In a second aspect, the present invention is a method for producing an inorganic particle composite body comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate, wherein part of the solid material is in at least part of the gaps in the inorganic particle layer, wherein the method comprises:

a preparation step of preparing an inorganic particle structural body comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate, and

a filling step of plastically deforming at least part of the solid material contained in the inorganic particle structural body, thereby filling at least part of the gaps in the inorganic particle layer with at least part of the plastically deformed solid material.

In one preferable embodiment of the above-described method, the inorganic particle structural body is prepared in the step of preparing the inorganic particle structural body by stacking the substrate on the aforementioned inorganic particle layer formed beforehand.

In another preferable embodiment of the above-described method, the inorganic particle structural body is prepared in the step of preparing the inorganic particle structural body by forming the inorganic particle layer on the substrate.

In another preferable embodiment of the above-described method, the solid material is plastically deformed in the filling step by pressurizing the inorganic particle structural body.

In another preferable embodiment of the above-described method, the solid material is plastically deformed in the filling step by applying an electromagnetic wave to the inorganic particle structural body.

In another preferable embodiment, the above-described method further includes a step of applying hydrophilization to the surface of the structural body obtained by carrying out the filling step.

In another preferable embodiment, the above-described method further includes a step of applying hydrophilization to the surface of the inorganic particles structural body, the step being a step that is carried out before carrying out the filling step.

In another preferable embodiment, the above-described method further includes a step of applying hydrophobization to the surface of the structural body obtained by carrying out the filling step.

In another preferable embodiment, the above-described method further includes a step of applying hydrophobization to the surface of the aforementioned inorganic particles structural body, the step being a step that is carried out before carrying out the filling step.

In another preferable embodiment, the above-described method further includes a step of applying antireflecting treatment to the surface of the structural body obtained by carrying out the filling step.

In another preferable embodiment, the above-described method further includes a step of applying antireflecting treatment to the surface of the inorganic particles structural body, the step being a step that is carried out before carrying out the filling step.

In another preferable embodiment, the above-described method further includes a step of giving a glass layer to the surface of the structural body obtained by carrying out the filling step.

In another preferable embodiment, the above-described method further includes a step of giving a glass layer to the surface of the inorganic particles structural body, the step being a step that is carried out before carrying out the filling step.

The material that constitutes the substrate in the inorganic particle composite body of the present invention or in the inorganic particle structural body, which is a precursor of the inorganic particle composite body, is a solid material that can undergo plastic deformation, i.e., a solid material with plasticity. The plasticity as referred to herein is a property to deform continuously with generation of permanent strain when a stress has exceeded the limit of elasticity. That a solid material plastically deforms means that a stress exceeding the limit of elasticity is applied to the material and, as a result, a permanent strain is produced, so that the solid material is deformed and the solid material is brought into a state that the deformed condition is maintained even if the stress is removed. Examples of such a solid material include metals such as platinum, gold, palladium, silver, copper, nickel, zinc, aluminum, iron, cobalt, rhodium, ruthenium, tin, lead, bismuth, tungsten, and indium, alloys and solders composed of two or more metals, and resins such as thermoplastic resins and thermosetting resins.

Examples of a thermosetting resin applicable to the present invention include aramid resins, polyimide resins, epoxy resins, unsaturated polyester resins, phenol resins, urea resins, polyurethane resins, melamine resins, benzoguanamine resins, silicone resins, and melamine-urea resins.

Examples of a thermoplastic resin applicable to the present invention include polycondensation-produced thermoplastic resins and resins obtainable by polymerizing vinyl monomers.

Examples of the polycondensation-produced thermoplastic resins include polyester resins, such as polyethylene terephthalate, polyethylene naphthalate, polylactic acid, biodegradable polyesters, and polyester-based liquid crystal polymers; polyamide resins, such as an ethylene diamine-adipic acid polycondensate (Nylon-66), Nylon-6, Nylon-12, and polyamide-based liquid crystal polymers; polyether resins, such as polycarbonate resins, polyphenylene oxide, polymethylene oxide, and acetal resins; and polysaccharide resins, such as cellulose and its derivatives.

Examples of the resins obtainable by polymerizing vinyl monomers include polyolefin resins described in detail below; resins containing constitutional units derived from aromatic hydrocarbon compounds, such as polystyrene, poly-α-methylstyrene, styrene-ethylene-propylene copolymers (polystyrene-poly(ethylene/propylene) block copolymers), styrene-ethylene-butene copolymers (polystyrene-poly(ethylene/butene) block copolymers), styrene-ethylene-propylene-styrene copolymers (polystyrene-poly(ethylene/propylene)-polystyrene block copolymers), and ethylene-styrene copolymers; polyvinyl alcohol resins, such as polyvinyl alcohol and polyvinyl butyral; polymethyl methacrylate, acrylic resins containing methacrylic esters, acrylic esters, methacrylamides, or acrylamides as a monomer; chlorine-containing resins, such as polyvinyl chloride and polyvinylidene chloride; fluorine-containing resins, such as polytetrafluoroethylene, ethylene-tetrafluoroethylene copolymers, tetrafluoroethylene-hexafluoropropylene copolymers, ethylene-tetrafluoroethylene-hexafluoropropylene copolymers, and polyvinylidene fluoride.

The above-mentioned polyolefin resins include resins obtainable by polymerizing one or more monomers selected from among α-olefins, cycloolefins, and polar vinyl monomers. A polyolefin resin may be a modified resin formed by further modifying a polyolefin resin formed by the polymerization of monomers. When a polyolefin resin is a copolymer, the copolymer may be either a random copolymer or a block copolymer.

Examples of polyolefin resins include propylene-based resins and ethylene-based resins. These are described in detail below.

Propylene-based resins are resins primarily composed of constituent units derived from propylene and include copolymers of propylene and a comonomer copolymerizable therewith as well as homopolymers of propylene.

Examples of the comonomer to be copolymerized with propylene include ethylene and α-olefins having 4 to 20 carbon atoms. Examples of the α-olefins in this case include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 2-methyl-3-ethyl-1-butene, 1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene, 2,3-diethyl-1-butene, 1-nonene, 1-decene, 1-undecene, 1-dodecene, 1-tridecene, 1-tetradecene, 1-pentadecene, 1-hexadecene, 1-heptadecene, 1-octadecene, and 1-nonadecene.

Preferred among the α-olefins are α-olefins having 4 to 12 carbon atoms, and specific examples thereof include 1-butene, 2-methyl-1-propene; 1-pentene, 2-methyl-1-butene, 3-methyl-1-butene; 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene; 1-heptene, 2-methyl-1-hexene, 2,3-dimethyl-1-pentene, 2-ethyl-1-pentene, 2-methyl-3-ethyl-1-butene; 1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene, 2,3-diethyl-1-butene; 1-nonene; 1-decene; 1-undecene; and 1-dodecene. From the viewpoint of copolymerizability, 1-butene, 1-pentene, 1-hexene and 1-octene are preferred and, especially, 1-butene and 1-hexene are more preferred.

Examples of preferred propylene-based copolymers can include propylene/ethylene copolymers and propylene/1-butene copolymers. The content of constitutional units derived from ethylene or the content of constitutional units derived from 1-butene in a propylene/ethylene copolymer or a propylene/1-butene copolymer can be determined on the basis of an infrared (IR) spectrum measured in accordance with, for example, the method disclosed on page 616 of “Polymer Analysis Handbook” (published by Kinokuniya Co., Ltd., 1995).

A propylene-based resin can be produced using a catalyst for polymerization by a method of homopolymerizing propylene or a method of copolymerizing propylene with other copolymerizable comonomers. Examples of the catalyst for polymerization can include known catalysts like the following (1) through (3):

(1) Ti—Mg based catalysts comprising a solid catalyst component essentially containing magnesium, titanium, and halogen,
(2) catalyst systems comprising a combination of a solid catalyst component essentially containing magnesium, titanium, and halogen with an organoaluminum compound and, if necessary, a third component such as an electron donating compound,
(3) metallocene catalysts.

Examples of the solid catalyst component essentially containing magnesium, titanium and halogen in the above (1) and (2) include catalyst systems disclosed in, for example, JP 61-218606 A, JP 61-287904 A, and JP 7-216017.

Preferable examples of the organoaluminum compound in the above (2) include triethylaluminum, triisobutylaluminum, and a mixture of triethylaluminum and diethylaluminum chloride, and preferable examples of the electron donating compound include cyclohexylethyldimethoxysilane, tert-butylpropyldimethoxysilane, tert-butylethyldimethoxysilane, and dicyclopentyldimethoxysilane.

The propylene-based resin can be produced by a solvent polymerization process, in which an inert solution represented by hydrocarbon compounds such as hexane, heptane, octane, decane, cyclohexane, methylcyclohexane, benzene, toluene and xylene is used, a bulk polymerization process, in which a liquefied monomer is used as a solvent, and a gas phase polymerization process, in which a gaseous monomer is polymerized. Polymerization using such processes may be carried out either in a batch system or a continuous system.

The structure of a propylene-based resin may be any structure selected from among an isotactic structure, a syndiotactic structure, and an atactic structure, which are described in “Polypropylene Handbook” (edited by Edward P. Moore Jr., published by Kogyo Chosakai Publishing (1998)), or alternatively may be a mixture of these structures. From the viewpoint of the heat resistance of a product, a syndiotactic or isotactic propylene-based resin is preferably used in the present invention.

As the metallocene catalyst in the above (3) is used a conventional catalyst, examples of which can include the metallocene catalysts disclosed in JP 58-19309 A, JP 60-35005 A, JP 60-35006 A, JP 60-35007 A, JP 60-35008 A, JP 61-130314,A, JP 3-163088 A, JP 4-268307 A, JP 9-12790 A, JP 9-87313 A, JP 11-80233 A, JP 10-508055 T, JP 1-301704 A, JP 3-74411 A, JP 3-12406 A, and JP 2003-183463 A. Among such metallocene catalysts, complexes of transition metals of Group 3 through Group 12 of the periodic table having at least one cyclopentadiene type anion skeleton and having a Cl symmetric structure are preferred, and the metallocene catalyst disclosed in JP 2003-183463 A is particularly preferred.

The propylene-based resin having a syndiotactic structure is a propylene-based resin such that in a ¹³C-NMR spectrum measured in a 1, 2, 4-trichlorobenzene solution of 135° C., a value obtained by dividing the intensity of a peak observed at 20.2 ppm with reference to tetramethylsilane by the sum total of the intensities of the peaks assigned to methyl groups of propylene units (i.e., syndiotactic pentad fraction [rrrr]) is usually from 0.3 to 0.9, preferably from 0.5 to 0.9, and more preferably from 0.7 to 0.9. Assignment of a peak is performed in accordance with the method disclosed by A. Zambelli et al, Macromolecules, 6, 925 (1973).

As to the method for producing of a propylene-based resin of a syndiotactic structure, it is produced by polymerizing propylene using a metallocene catalyst having homogeneous active species as described in JP 5-17589 A, JP 5-131558 A, etc.

The above-mentioned metallocene catalyst is a catalyst that is uniform in the property of active species, and a propylene-based resin of a syndiotactic structure produced using such a metallocene catalyst has a characteristic that molecular weight distribution or composition distribution is narrow. The molecular weight can be adjusted or the regularity can be controlled by, for example, selecting the ligand of a metallocene catalyst.

The above-mentioned propylene-based resin of a syndiotactic structure has a melting point of about 130° C. to about 150° C., a density of about 880 kg/m³, and a degree of crystallization as low as about 30% to about 40%. For this reason, a product superior in transparency, glossiness, and so on can be obtained.

From the viewpoint of moldability, the propylene-based resin to be used for the present invention preferably has a melt flow rate (MFR), measured at a temperature of 230° C. and a load of 21.18 N in accordance with JIS K7210, of 0.1 to 200 g/10 min, and more preferably 0.5 to 50 g/10 min.

Ethylene-based resins are resins primarily composed of constituent units derived from ethylene and include copolymers of ethylene and a comonomer copolymerizable therewith as well as homopolymers of ethylene. Examples thereof include ethylene-α-olefin copolymers, high density polyethylene, high pressure process low density polyethylene, and ethylene-ethylenically unsaturated carboxylic acid copolymers.

From the viewpoint of the balance between processability, the mechanical strength and heat resistance of a product, the melt flow rate (MFR) of an ethylene-based resin is usually 0.01 to 100 g/10 min, preferably 0.1 to 80 g/10 min, and more preferably 0.5 to 70 g/10 min. The MFR of an ethylene-based resin is measured at a temperature of 190° C. and a load of 21.18 N in accordance with JIS K7210.

Ethylene-α-olefin copolymers are ethylene-α-olefin copolymers produced by copolymerizing ethylene with an α-olefin having 4 to 12 carbon atoms and they are usually produced using a metallocene catalyst, a Ziegler Natta catalyst, or the like.

Examples of a polymerization method include a solution polymerization process, a slurry polymerization, a high pressure ionic polymerization process, a gas phase polymerization process, and so on; a gas phase polymerization process, a solution polymerization process, and a high pressure ionic polymerization process are preferred, and a gas phase polymerization process is more preferred.

Examples of an α-olefin having 4 to 12 carbon atoms include butene-1, pentene-1, hexene-1, heptene-1, octene-1, nonene-1, decene-1, dodecene-1, 4-methyl-pentene-1, 4-methyl-hexene-1, vinylcyclohexane, vinylcyclohexene, styrene, norbornene, butadiene; isoprene, and hexene-1, 4-methyl-pentene-1, and octene-1 are preferred. Moreover, cycloolefins are also α-olef ins in a broad sense and norbornene and dimethanooctahydronaphthalene (DMON) are also preferred. The above-mentioned α-olefin having 4 to 12 carbon atoms may be used singly or alternatively at least two members thereof may be used in combination.

Examples of the ethylene-α-olefin copolymer include ethylene-butene-1 copolymers, ethylene-4-methyl-pentene-1 copolymers, ethylene-hexene-1 copolymers, and ethylene-octene-1 copolymers; ethylene-hexene-1 copolymers, ethylene-4-methyl-pentene-1, and ethylene-octene-1 copolymers are preferred, and ethylene-hexene-1 copolymers are more preferred.

From the viewpoint of the balance between the heat fusion resistance, impact strength, and transparency of a product, the density of the ethylene-α-olefin copolymer is usually 880 to 945 kg/m³, preferably 890 to 930 kg/m³, and more preferably 900 to 925 kg/m³.

Preferred as the metallocene catalyst is a catalyst system containing a transition metal compound having a group having a cyclopentadiene type anion skeleton. The transition metal compound having a group having a cyclopentadiene type anion skeleton is a so-called metallocene compound, which is represented by, for example, a formula MLₐXₙ₋ₐ wherein M is a transition metal atom of Group 4 of the periodic table of elements or of a lanthanide series; L is each a group containing a group having a cyclopentadiene type anion skeleton or a group containing a hetero atom, at least one of which is a group having a cyclopentadiene type anion skeleton, provided that two or more L may be bridged with each other; X is a halogen atom, hydrogen, or a hydrocarbon group having 1 to 20 carbon atoms; n represents the valence of the transition metal atom, and a is an integer of 0<a≦n. Such compounds may be used singly or alternatively at least two compounds may be used in combination.

The above-mentioned metallocene catalyst is used in combination with an organoaluminum compound, such as triethylaluminum and triisobutylaluminum, an alumoxane compound, such as methylalumoxane, and/or an ionic compound, such as trityl tetrakis(pentafluorophenyl)borate and N,N-dimethylanilinium tetrakis(pentafluorophenyl)borate.

The above-mentioned metallocene catalyst may be a catalyst prepared by making a particle state organic polymer carrier, such as a particulate inorganic support, such as SiO₂ and Al₂O₃, or a particulate organic polymer carrier, such as polyethylene and polystyrene, support or contain the above-mentioned metallocene system compound, an organoaluminum compound, an alumoxane compound and/or an ionic compound.

Examples of an ethylene-α-olefin copolymer obtainable by polymerization using the above-mentioned metallocene catalyst include the ethylene-α-olefin copolymer disclosed in JP 9-183816 A. Ethylene-α-olefin copolymers can also be produced using late transition metal complex catalysts, which are homogeneous catalysts.

From the viewpoint of balance between the heat fusion resistance and the impact strength of a product, the density of a high density polyethylene to be used for the present invention is usually 945 to 970 kg/m³ and preferably 945 to 965 kg/m³.

Examples of a method of producing a high density polyethylene to be used for the present invention include a method of polymerizing monomers using a polymerization catalyst. Examples of such a polymerization catalyst include known Ziegler-Natta catalysts and examples of such a polymerization method include methods the same as known polymerization methods to be used for the method for producing the aforementioned ethylene-α-olefin copolymer. An example of the method for producing a high density polyethylene is a slurry polymerization process using a Ziegler-Natta catalyst. From the viewpoint of balance between the heat fusion resistance and the impact strength of a product, the density of a high pressure process low density polyethylene is preferably from 915 to 935 kg/m³, more preferably from 915 to 930 kg/m³, and even more preferably from 918 to 930 kg/m³.

An example of the method for producing a high pressure process low density polyethylene to be used for the present invention is a method that comprises polymerizing ethylene in the presence of a radical generator under a polymerization pressure of from 140 to 300 MPa at a polymerization temperature of from 200 to 300° C. by using a tank reactor or a tubular reactor, and hydrogen and hydrocarbons, such as methane and ethane, are used as a molecular weight controller in order to adjust the melt flow rate of a product.

Ethylene-ethylenically unsaturated carboxylic acid copolymers are copolymers of ethylene with ethylenically unsaturated carboxylic acids. Ethylenically unsaturated carboxylic acids are compounds that are carboxylic acids having an ethylenically unsaturated bond, which is a polymerizable carbon-carbon unsaturated bond such as a carbon-carbon double bond.

Examples of ethylenically unsaturated carboxylic acids include vinyl esters of saturated carboxylic acids, vinyl esters of unsaturated carboxylic acids, and esters of α,β-unsaturated carboxylic acids.

Preferred as the vinyl esters of saturated carboxylic acids are vinyl esters of saturated aliphatic carboxylic acids having 2 to about 4 carbon atoms, examples of which include vinyl acetate, vinyl propionate, and vinyl butyrate. Preferred as the vinyl esters of unsaturated carboxylic acids are vinyl esters of unsaturated aliphatic carboxylic acids having 2 to about 5 carbon atoms, examples of which include vinyl acrylate and vinyl methacrylate. Preferred as the esters of α,β-unsaturated carboxylic acids are esters of α,β-unsaturated carboxylic acids having 3 to about 8 carbon atoms, examples of which include alkyl esters of acrylic acid, such as methyl acrylate, ethyl acrylate, n-propyl acrylate, isopropyl acrylate, n-butyl acrylate, isobutyl acrylate, and tert-butyl acrylate, and alkyl esters of methacrylic acid, such as methyl methacrylate, ethyl methacrylate, n-propyl methacrylate, isopropyl methacrylate, n-butyl methacrylate, isobutyl methacrylate, and tert-butyl methacrylate. Among ethylenically unsaturated carboxylic acids, vinyl acetate, methyl acrylate, ethyl acrylate, n-butyl acrylate, and methyl methacrylate are preferred, and vinyl acetate is more preferred. Such ethylenically unsaturated carboxylic acids are used singly or two or more members thereof are used in combination. Moreover, hydrolysates of ethylenically unsaturated carboxylic acids, for example, saponified ethylene-vinyl acetate copolymers obtainable by hydrolysis of ethylene-vinyl acetate copolymers, are also preferably used. Ethylene-ethylenically unsaturated carboxylic acid copolymers may have constituent units derived from other monomers.

The content of constituent units derived from ethylene in an ethylene-ethylenically unsaturated carboxylic acid copolymer is usually from 20 to 99% by weight, preferably from 40 to 99% by weight, and more preferably from 60 to 99% by weight and the content of constituent units derived from ethylenically unsaturated carboxylic acid is usually from 80 to 1% by weight, preferably from 60 to 1% by weight, and more preferably from 40 to 1% by weight, provided that the ethylene-ethylenically unsaturated carboxylic acid copolymer is 100% by weight.

An example of the method for producing an ethylene-ethylenically unsaturated carboxylic acid copolymer is a method that comprises copolymerizing ethylene with an ethylenically unsaturated carboxylic acid copolymer in the presence of a radical generator under a polymerization pressure of from 140 to 300 MPa at a polymerization temperature of from 200 to 300° C. by using a tank reactor or a tubular reactor, and hydrogen and hydrocarbons, such as methane and ethane, are used as a molecular weight controller in order to adjust the melt flow rate of a product. These days, a method in which a late transition metal complex catalyst or the like is used as a homogeneous catalyst may also be used.

Polyolefin resins represented by the above-mentioned propylene-based resins and ethylene-based resins may have been modified. Examples of such modified polyolefin resins include resins of the following (1) through (3):

(1) a modified polyolefin resin obtainable by graft polymerizing an unsaturated carboxylic acid and/or a derivative thereof to a homopolymer of an olefin,
(2) a modified polyolefin resin obtainable by graft polymerizing an unsaturated carboxylic acid and/or a derivative thereof to a copolymer of at least two olefins,
(3) a modified polyolefin resin obtainable by graft polymerizing an unsaturated carboxylic acid and/or a derivative thereof to a block copolymer obtainable by homopolymerizing an olefin and then copolymerizing at least two olefins.

Examples of the method for producing a modified polyolefin resin include the methods disclosed in “Practical Design of Polymer Alloy” Fumio IDE, Kogyo Chosakai Publishing Co. (1996), Prog. Polym. Sci., 24, 81-142 (1999), and JP 2002-308947 A, and any process among a solution process, a bulk process, and a melt-kneading process may be used. Moreover, a production method comprising a combination of these processes can also be used.

Examples of the unsaturated carboxylic acid to be used for the production of the modified polyolefin resin include maleic acid, fumaric acid, itaconic acid, acrylic acid, and methacrylic acid. Examples of unsaturated carboxylic acid derivatives include anhydrides, ester compounds, amide compounds, imide compounds, and metal salts of unsaturated carboxylic acids, and specific examples thereof include maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, monoethylester maleate, diethylester maleate, monomethylester fumarate, dimethylesterfumarate, acrylamide, methacrylamide, maleic acid monoamide, maleic acid diamide, fumaric acid monoamide, maleimide, N-butylmaleimid, and sodium methacrylate. Moreover, a compound, e.g., citric acid and malic acid, which undergoes dehydration during a step of grafting to a polyolefin-based resin such as a propylene-based resin to afford an unsaturated carboxylic acid may also be used.

Preferred as an unsaturated carboxylic acid and/or a derivative thereof are glycidyl esters of acrylic acid and methacrylic acid, and maleic anhydride.

Examples of preferred modified polyolefin resins include resins of the following (4) and (5):

(4) a modified polyolefin resin obtainable by graft polymerizing maleic anhydride to a polyolefin resin containing units derived from ethylene and/or propylene as main constitutional units of a polymer,
(5) a modified polyolefin resin obtainable by copolymerizing an olefin comprising ethylene and/or propylene as a main component with glycidyl methacrylate or maleic anhydride.

From the viewpoint of the mechanical strength of a product, the amount of constitutional units derived from an unsaturated carboxylic acid and/or a derivative thereof contained in a modified polyolefin resin is preferably from 0.1 to 10% by weight, provided that the weight of the modified polyolefin resin is 100% by weight.

Examples of other modified polyolefin resins include products obtained by reacting a monomer (coupling agent) containing an element such as silicon, titanium and fluorine or a polymer containing them with a polyolefin resin. These resins may be used singly or alternatively two or more members thereof may be used in combination.

The above-mentioned resins may contain one or more additives for resin. The amount of such additives contained in a resin is up to 2 parts by weight relative to 100 parts by weight of the resin, preferably up to 0.5 parts by weight, more preferably up to 0.3 parts by weight, even more preferably up to 0.1 parts by weight, and particularly preferably up to 0.05 parts by weight.

Examples of additives can include phenolic antioxidants, phosphorus-containing antioxidants, sulfur-containing antioxidants, UV absorbers, light stabilizers, metal deactivators, hydroxylamine, a neutralizers, lubricants, antistatic agents, surfactants (including antifogging agents), peroxide scavengers, plasticizers, flame retardants, nucleating agents, pigments, fillers, anti-blocking agents, processing aids, blowing agents, foaming aids, emulsifiers, brighteners, coloring improvers, such as 9,10-dihydro-9-oxa-10-phosphophenanthrene-10-oxide, auxiliary stabilizers, such as and benzofuranones (U.S. Pat. Nos. 4,325,853, 4,338,244, 5,175,312, 5,216,053, 5,252,643, and 4,316,611, German Unexamined Patent Publication Nos. 4316622 and 4316876, and European Unexamined Patent Publication Nos. 589839 and 591102, etc.) and indolines.

Examples of the phenolic antioxidant include alkylated monophenols, such as 6-tert-butyl-4-[3-[(2,4,8,10-tetra-tert-butylbenzo[d,f][1,3,2]dioxaphosphepin-6-yl)oxy]propyl]-2-methylphenol, 2,6-di-tert-butyl-4-methylphenol, 2,4,6-tri-tert-butylphenol, 2,6-di-tert-butylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-diocdadecyl-4-methylphenol, 2,4,6-tricyclohexylphenol, 2,6-di-tert-butyl-4-methoxymethylphenol, 2,6-di-nonyl-4-methylphenol, 2,4-dimethyl-6-(1′-methylundecyl-1′-yl) phenol, 2,4-dimethyl-6-(1′-methylheptadecyl-1′-yl)phenol, 2,4-dimethyl-6-(1′-methyltridecyl-1′-yl)phenol, and mixtures thereof, alkylthiomethylphenols, such as 2,4-dioctylthiomethyl-6-tert-butylphenol, 2,4-dioctyl thiomethyl-6-methylphenol, 2,4-dioctylthiomethyl-6-ethylphenol, 2,6-didodecylthiomethyl-4-nonyl phenol, and mixtures thereof, hydroquinone and alkylated hydroquinones, such as 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyphenyl stearate, bis(3,5-di-tert-butyl-4-hydroxyphenyl) adipate, and mixtures thereof, tocopherols, such as α-tocopherol, β-tocopherol, γ-tocopherol, δ-tocopherol and mixtures thereof, hydroxylated thiodiphenyl ethers, such as 2,2′-thiobis(6-tert-butylphenol), 2,2′-thiobis(4-methyl-6-tert-butylphenol), 2,2′-thiobis(4-octylphenol), 4,4′-thiobis(3-methyl-6-tert-butylphenol), 4,4′-thiobis(2-methyl-6-tert-butylphenol), 4,4′-thiobis(3,6-di-tert-amylphenol), and 4,4′-(2,6-dimethyl-4-hydroxyphenyl)disulfide, alkylidenebisphenols and derivatives thereof, such as 2,2′-methylenebis(4-methyl-6-tert-butylphenol), 2,2′-methylenebis(4-ethyl-6-tert-butylphenol), 2,2′-methylenebis[4-methyl-6-(α-methylcyclohexyl)phenol)], 2,2′-methylenebis(4-methyl-6-cyclohexylphenol), 2,2′-methylenebis(4-methyl-6-nonylphenol), 2,2′-methylenebis(4,6-di-tert-butylphenol), 2,2′-ethylidenebis(4,6-di-tert-butylphenol), 2,2′-ethylidenebis(4-isobutyl-6-tert-butylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(6-tert-butyl-2-methyl phenol), 4,4′-methylenebis(2,6-di-tert-butylphenol), 4,4′-butylidenebis(3-methyl-6-tert-butylphenol), 1,1-bis(4-hydroxyphenyl)cyclohexane, 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercapto butane, ethylene glycol bis[3,3-bis-3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane, 2-tert-butyl-6-(3′-tert-butyl-5′-methyl-2′-hydroxybenzyl)-4-methylphenyl acrylate, 2,4-di-tert-pentyl-6-[1-(2-hydroxy-3,5-di-tert-pentylphenyl) ethyl]phenyl acrylate, and mixtures thereof, O-, N-, and S-benzyl derivatives, such as 3,5,3′,5′-tetra-tert-butyl-4,4′-dihydroxydibenzyl ether, octadecyl-4-hydroxy-3,5-dimethylbenzyl mercaptoacetate, tris(3,5-di-tert-butyl-4-hydroxybenzyl)amine, bis(4-tert-butyl-3-hydroxy-2,6-dimethylbenzyl) dithioterephthalate, bis(3,5-di-tert-butyl-4-hydroxybenzyl)sulfide, isooctyl-3,5-di-tert-butyl-4-hydroxybenzyl mercaptoacetate, and mixtures thereof, hydroxybenzylated malonate derivatives, such as dioctadecyl-2,2-bis(3,5-di-tert-butyl-2-hydroxybenzyl) malonate, dioctadecyl-2-(3-tert-butyl-4-hydroxy-5-methylbenzyl) malonate, di-dodecylmercaptoethyl-2,2-bis(3,5-di-tert-butyl-4-hydroxy benzyl) malonate, bis[4-(1,1,3,3-tetrametylbutyl)phenyl]-2,2-bis(3,5-di-tert-butyl-4-hydroxybenzyl) malonate, and mixtures thereof, aromatic hydroxybenzyl derivatives, such as 1,3,5-trimethyl-2,4,6-tris(3,5-di-tert-butyl-4-hydroxybenzyl)benzene, 1,4-bis(3,5-di-tert-butyl-4-hydroxybenzyl)-2,3,5,6-tetramethyl benzene, 2,4,6-tris(3,5-tert-butyl-4-hydroxybenzyl)phenol, and those mixtures, triazine derivatives, such as 2,4-bis(n-octylthio)-6-(4-hydroxy-3,5-di-tert-butylanilino)-1,3,5-triazine, 2-n-octylthio-4,6-bis(4-hydroxy-3,5-di-tert-butylanilino)-1,3,5-triazine, 2-n-octylthio-4,6-bis(4-hydroxy-3,5-di-tert-butylphenoxy)-1,3,5-triazine, 2,4,6-tris(3,5-di-tert-butyl-4-phenoxy)-1,3,5-triazine, tris(4-tert-butyl-3-hydroxy-2,6-dimethylbenzyl) isocyanurate, tris(3,5-di-tert-butyl-4-hydroxybenzyl) isocyanurate, 2,4,6-tris(3,5-di-tert-butyl-4-hydroxyphenylethyl)-1,3,5-triazine, 2,4,6-tris(3,5-di-tert-butyl-4-hydroxyphenylpropyl)-1,3,5-triazine, tris(3,5-dicyclohexyl-4-hydroxybenzyl) isocyanurate, tris[2-(3′,5′-di-tert-butyl-4′-hydroxycinnamoyloxy)ethyl]isocyanurate, and mixtures thereof, benzyl phosphonate derivatives, such as dimethyl-3,5-di-tert-butyl-4-hydroxybenzyl phosphonate, diethyl-3,5-di-tert-butyl-4-hydroxybenzyl phosphonate, dioctadecyl-3,5-di-tert-butyl-4-hydroxybenzyl phosphonate, dioctadecyl-5-tert-butyl-4-hydroxy-3-methylbenzyl phosphonate, calcium salt of 3,5-di-tert-butyl-4-hydroxybenzylphosphonic acid monoester, and mixtures thereof, acylaminophenol derivatives, such as anilide 4-hydroxylauramide, 4-hydroxystearamide, octyl-N-(3,5-di-tert-butyl-4-hydroxyphenyl) carbanate, and mixtures thereof, esters of β-(3,5-di-tert-butyl-4-hydroxyphenyl)propionic acid with monohydric or polyhydric alcohols, such as methanol, ethanol, octanol, octadecanol, ethylene glycol, 1,3-propanediol, 1,4-butanediol, 1,6-hexanediol, 1,9-nonanediol, neopentyl glycol, diethylene glycol, thioethylene glycol, spiroglycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2,2,2]octane, and mixtures thereof, esters of β-(5-tert-butyl-4-hydroxy-3-methylphenyl)propionic acid with monohydric or polyhydric alcohols, such as methanol, ethanol, octanol, octadecanol, ethylene glycol, 1,3-propanediol, 1,4-butanediol, 1,6-hexanediol, 1,9-nonanediol, neopentyl glycol, diethylene glycol, thioethylene glycol, spiroglycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2,2,2]octane, and mixtures thereof, esters of β-(3,5-dicyclohexyl-4-hydroxyphenyl)propionic acid with monohydric or polyhydric alcohols, such as methanol, ethanol, octanol, octadecanol, ethylene glycol, 1,3-propanediol, 1,4-butanediol, 1,6-hexanediol, 1,9-nonanediol, neopentyl glycol, diethylene glycol, thioethylene glycol, spiroglycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2,2,2]octane, and mixtures thereof, esters of 3,5-di-tert-butyl-4-hydroxyphenylacetic acid with monohydric or polyhydric alcohols, such as methanol, ethanol, octanol, octadecanol, ethylene glycol, 1,3-propanediol, 1,4-butanediol, 1,6-hexanediol, 1,9-nonanediol, neopentyl glycol, diethylene glycol, thioethylene glycol, spiroglycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2, 2, 2]octane, and mixtures thereof, and amides of β-(3,5-di-tert-butyl-4-hydroxyphenyl)propionic acid, such as N,N′-bis[3-(3′,5′-di-tert-butyl-4′-hydroxyphenyl)propionyl]hydrazine, N,N′-bis[3-(3′,5′-di-tert-butyl-4′-hydroxyphenyl)propionyl]hexamethylenediamine, N,N′-bis[3-(3′,5′-di-tert-butyl-4′-hydroxyphenyl) propionyl]trimethylenediamine, and mixtures thereof. Moreover, a composite type phenolic antioxidant having unit having both a phenol type antioxidant mechanism and a phosphorus type antioxidant mechanism in one molecule can also be used.

Examples of phosphorus-containing antioxidants include triphenyl phosphite, tris(nonylphenyl) phosphite, tris(2,4-di-tert-butylphenyl) phosphite, trilauryl phosphite, trioctadecyl phosphite, distearylpentaerythritoldiphosphite, diisodecylpentaerythritol diphosphite, bis(2,4-di-tert-butylphenyl)pentaerythritol diphosphite, bis(2,4-di-tert-butyl-6-methylphenyl)pentaerythritol diphosphite, bis(2,6-di-tert-butyl-4-methylphenyl)pentaerythritol diphosphite, bis(2,4,6-tri-tert-butylphenyl)pentaerythritol diphosphite, tristearylsorbitol triphosphite, tetrakis(2,4-di-tert-butylphenyl)-4,4′-diphenylene diphosphonite, 2,2′-methylenebis(4,6-di-tert-butylphenyl)-2-ethylhexyl phosphite, 2,2′-ethylidenebis(4,6-di-tert-butylphenyl) fluorophosphite, bis(2,4-di-tert-butyl-6-methylphenyl)ethyl phosphite, bis(2,4-di-tert-butyl-6-methylphenyl)methyl phosphite, 2-(2,4,6-tri-tert-butylphenyl)-5-ethyl-5-butyl-1,3,2-oxaphosphorinane, 2,2′,2″-nitrilo[triethyltris(3,3′,5,5′-tetra-tert-buytyl-1,1′-biphenyl-2,2′-diyl) phosphite, and mixtures thereof. The phosphorus-containing antioxidants disclosed in JP 2002-69260 A are also preferred.

Examples of sulfur-containing antioxidants include dilauryl 3,3′-thiodipropionate, tridecyl 3,3′-thiodipropionate, dimyristyl 3,3′-thiodipropionate, distearyl 3,3′-thiodipropionate, lauryl stearyl 3,3′-thiodipropionate, and neopentanetetrayl tetrakis(3-laurylthiopropionate).

Examples of UV absorbers include salicylate derivatives such as phenyl salicylate, 4-tert-butylphenyl salicylate, 2,4-di-tert-butylphenyl 3′,5′-di-tert-butyl-4′-hydroxybenzoate, 4-tert-octylphenyl salicylate, bis(4-tert-butylbenzoyl)resorcinol, benzoyl resorcinol, hexadecyl 3′,5′-di-tert-butyl-4′-hydroxybenzoate, octadecyl 3′,5′-di-tert-butyl-4′-hydroxybenzoate, 2-methyl-4,6-di-tert-butylphenyl 3′,5′-di-tert-butyl-4′-hydroxybenzoate, and mixtures thereof, 2-hydroxybenzophenone derivatives such as 2,4-dihydroxybenzophenone, 2-hydroxy-4-methoxybenzophenone, 2-hydroxy-4-octoxybenzophenone, 2,2′-dihydroxy-4-methoxybenzophenone, bis(5-benzoyl-4-hydroxy-2-methoxyphenyl)methane, 2,2′,4,4′-tetrahydroxybenzophenone, and mixtures thereof, and 2-(2′-hydroxyphenyl)benzotriazoles, such as 2-(2-hydroxy-5-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-tert-octylphenyl)benzotriazole, 2-(3-tert-butyl-2-hydroxy-5-methylphenyl)-5-chlorobenzotriazole, 2-(3′-s-butyl-2′-hydroxy-5′-tert-butylphenyl)benzotriazole, 2-(2′-hydroxy-4′-octyloxy phenyl)benzotriazole, 2-(3′,5′-di-tert-amyl-2′-hydroxyphenyl)benzotriazole, 2-[2′-hydroxy-3′,5′-bis(α,α-dimethylbenzyl)phenyl]-2H-benzotriazole, 2-[(3′-tert-butyl-2′-hydroxyphenyl)-5′-(2-octyloxycarbonylethyl)phenyl]-5-chlorobenzotriazole, 2-[3′-tert-butyl-5′-[2-(2-ethylhexyloxy)carbonylethyl]-2′-hydroxyphenyl]-5-chlorobenzotriazole, 2-[3′-tert-butyl-2′-hydroxy-5′-(2-methoxycarbonylethyl)phen yl]-5-chlorobenzotriazole, 2-[3′-tert-butyl-2′-hydroxy-5′-(2-methoxycarbonylethyl)phen yl]benzotriazole, 2-[3′-tert-butyl-2′-hydroxy-5-(2-octyloxycarbonylethyl)phen yl]benzotriazole, 2-[3′-tert-butyl-2′-hydroxy-5′-[2-(2-ethylhexyloxy)carbonyl ethyl]phenyl]benzotriazole, 2-[2-hydroxy-3-(3,4,5,6-tetrahydrophthalimidomethyl)-5-methylphenyl]benzotriazole, 2-(3,5-di-tert-butyl-2-hydroxyphenyl)-5-chlorobenzotriazole, mixtures of 2-(3′-dodecyl-2′-hydroxy-5′-methylphenyl)benzotriazole and 2-[3′-tert-butyl-2′-hydroxy-5′-(2-isooctyloxycarbonylethyl) phenyl]benzotriazole, 2,2′-methylenebis[6-(2H-benzotriazol-2-yl)-4-(1,1,3,3-tetrametylbutyl)phenol, 2,2′-methylenebis[(4-tert-butyl-6-(2H-benzotriazol-2-yl)phenol)]condensates of poly(3-11) (ethylene glycol) with 2-[3′-tert-butyl-2′-hydroxy-5′-(2-methoxycarbonylethyl)phen yl]benzotriazole, condensates of poly(3-11)(ethylene glycol) with methyl 3-[3-(2H-benzotriazol-2-yl)-5-tert-butyl-4-hydroxyphenyl]propionate, 2-ethylhexyl 3-[3-tert-butyl-5-(5-chloro-2H-benzotriazol-2-yl)-4-hydroxy phenyl]propionate, octyl 3-[3-tert-butyl-5-(5-chloro-2H-benzotriazol-2-yl)-4-hydroxy phenyl]propionate, methyl 3-[3-tert-butyl-5-(5-chloro-2H-benzotriazol-2-yl)-4-hydroxy phenyl]propionate, 3-[3-tert-butyl-5-(5-chloro-2H-benzotriazol-2-yl)-4-hydroxy phenyl]propionic acid, and mixtures thereof.

Examples of light stabilizers include hindered amine light stabilizers such as bis(2,2,6,6-tetramethyl-4-piperidyl) sebacate bis(2,2,6,6-tetramethyl-4-piperidyl) succinate, bis(1,2,2,6,6-pentamethyl-4-piperidyl) sebacate, bis(N-octoxy-2,2,6,6-tetramethyl-4-piperidyl) sebacate, bis(N-benzyloxy-2,2,6,6-tetramethyl-4-piperidyl) sebacate, bis(N-cyclohexyloxy-2,2,6,6-tetramethyl-4-piperidyl) sebacate, bis(1,2,2,6,6-pentamethyl-4-piperidyl) 2-(3,5-di-tert-butyl-4-hydroxybenzyl)-2-butylmalonate, bis(1-acroyl-2,2,6,6-tetramethyl-4-piperidyl) 2,2-bis(3,5-di-tert-butyl-4-hydroxybenzyl)-2-butylmalonate, bis(1,2,2,6,6-pentamethyl-4-piperidyldecanedioate, 2,2,6,6-tetramethyl-4-piperidyl methacrylate, 4-[3-(3,5-di-tert-butyl-4-hydroxyphenyl)propionyloxy]-1-[2-(3-(3,5-di-tert-butyl-4-hydroxyphenyl)propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propionamide, tetrakis(2,2,6,6-tetramethyl-4-piperidyl) 1,2,3,4-butanetetracarboxylate, tetrakis(1,2,2,6,6-pentamethyl-4-piperidyl) 1,2,3,4-butanetetracarboxylate, mixed esters of 1,2,3,4-butantetracarboxylic acid with 1,2,2,6,6-pentamethyl-4-piperidinol and 1-tridecanol, mixed esters of 1,2,3,4-butantetracarboxylic acid with 2,2,6,6-tetramethyl-4-piperidinol and 1-tridecanol, mixed esters of 1,2,3,4-butanetetracarboxylic acid with 1,2,2,6,6-pentamethyl-4-piperidinol and 3,9-bis(2-hydroxy-1,1-dimethylethyl)-2,4,8,10-tetraoxaspiro[5.5]undecane, mixed esters of 1,2,3,4-butanetetracarboxylic acid with 2,2,6,6-tetramethyl-4-piperidinol and 3,9-bis(2-hydroxy-1,1-dimethylethyl)-2,4,8,10-tetraoxaspiro[5•5]undecane, polycondensates of dimethyl succinate with 1-(2-hydroxyethyl)-4-hydroxy-2,2,6,6-tetramethylpiperidine, poly[(6-morpholino-1,3,5-triazine-2,4-diyl)((2,2,6,6-tetramethyl-4-piperidyl)imino)hexamethylene((2,2,6,6-tetramethyl-4-piperidyl)imino)], poly[(6-(1,1,3,3-tetrametylbutyl)imino-1,3,5-triazine-2,4-diyl((2,2,6,6-tetramethyl-4-piperidyl)imino)hexamethylene(2, 2,6,6-tetramethyl-4-piperidyl)imino)], polycondensates of N,N′-bis(2,2,6,6-tetramethyl-4-piperidyl)hexamethylenediamine with 1,2-dibromoethane, N,N′,4,7-tetrakis[4,6-bis(N-butyl-N-(2,2,6,6-tetramethyl-4-piperidyl)amino)-1,3,5-triazin-2-yl]-4,7-diazadecane-1,10-diamine, N,N′,4-tris[4,6-bis(N-butyl-N-(2,2,6,6-tetramethyl-4-piperidyl)amino)-1,3,5-triazin-2-yl]-4,7-diazadecane-1,10-diamine, N,N′,4,7-tetrakis[4,6-bis(N-butyl-N-(1,2,2,6,6-pentamethyl-4-piperidyl)amino)-1,3,5-triazin-2-yl]-4,7-diazadecane-1,10-diamine, N,N′,4-tris[4,6-bis(N-butyl-N-(1,2,2,6,6-pentamethyl-4-piperidyl)amino)-1,3,5-triazin-2-yl]-4,7-diazadecane-1,10-diamine, and mixtures thereof, acrylate type light stabilizers such as ethyl α-cyano-β,β-diphenyl acrylate, isooctyl α-cyano-β,β-diphenyl acrylate, methyl α-carbomethyloxycinnamate, methyl α-cyano-β-methyl-p-methoxycinnamate, butyl α-cyano-β-methyl-p-methoxycinnamate, methyl α-carbomethyloxy-p-methoxycinnamate, N-(β-carbomethyloxy-β-cyanovinyl)-2-methylindoline, and mixtures thereof, nickel-containing light stabilizers such as nickel complexes of 2,2′-thiobis-[4-(1,1,3,3-tetrametylbutyl)phenol], nickel dibutyldithiocarbamate, nickel salts of monoalkyl esters, nickel complexes of ketoximes, and mixtures thereof, oxamide type light stabilizers such as 4,4′-dioctyloxyoxanilide, 2,2′-diethoxyoxanilide, 2,2′-dioctyloxy-5,5′-di-tert-butylanilide, 2,2′-didodecyloxy-5,5′-di-tert-butyoanilide, 2-ethoxy-2′-ethyloxanilide, N,N′-bis(3-dimethylaminopropyl)oxamide, 2-ethoxy-5-tert-butyl-2′-ethoxyanilide, 2-ethoxy-5,4′-di-tert-butyl-2′-ethyloxanilide, and mixtures thereof, and 2-(2-hydroxyphenyl)-1,3,5-triazine-based light stabilizers such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-[2,4-dihydroxyphenyl-4,6-bis(2,4-dimethylphenyl]-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethylphenyl)-1,3,5-triazine, 2-[2-hydroxy-4-(2-hydroxy-3-octyloxypropoxy)phenyl]-4,6-bis(2,4-dimethylphenyl)-1,3,5-triazine, and mixtures thereof.

Examples of metal deactivators include N,N′-diphenyloxamide, N-salicylal-N′-salicyloylhydrazine, N,N′-bis(salicyloyl) hydrazine, N,N′-bis(3,5-di-tert-butyl-4-hydroxyphenylpropionyl)hydrazine, 3-salicyloylamino-1,2,4-triazole, bis(benzylidene)oxalyldihydrazide, oxanilide, isophthaloyldihydrazide, sebacoylbisphenylhydrazide, N,N′-bis(salicyloyl)oxalyldihydrazide, N,N′-bis(salicyloyl)thiopropionyldihydrazide, and mixtures thereof.

Examples of hydroxylamines include N,N-dibenzylhydroxyamine, N,N-diethylhydroxyamine, N,N-dioctylhydroxyamine, N,N-dilaurylhydroxyamine, N,N-ditetradecylhydroxyamine, N,N-dihexadecylhydroxyamine, N,N-dioctadecylhydroxyamine, N-hexadecyl-N-octadecylhydroxyamine, N-heptadecyl-N-octadecylhydroxyamine, and mixtures thereof.

Examples of neutralizers include calcium stearate, zinc stearate, magnesium stearate, hydrotalcite (basic magnesium aluminum hydroxy carbonate hydrate), melamine, amines, polyamides, polyurethanes, and mixtures thereof.

Examples of lubricants include aliphatic hydrocarbons such as paraffins and waxes, higher fatty acids having 8 to 22 carbon atoms, salts of metals (Al, Ca, Mg, Zn) with higher fatty acids having 8 to 22 carbon atoms, aliphatic alcohols having 8 to 22 carbon atoms, polyglycols, esters of higher fatty acids having 4 to 22 carbon atoms with aliphatic monohydric alcohols having 4 to 18 carbon atoms, higher aliphatic amides having 8 to 22 carbon atoms, silicone oil, and rosin derivatives. Specific examples include erucamide, oleamide, ethylenebisstearylamide, erucylamide, and dimethylpolysiloxane.

Antistatic agents may be of any of a polymer type, an oligomer type, and a monomer type. Their examples include polyhydric alcohol fatty acid esters such as glycerol fatty acid esters, polyoxyethylene alkylamine mixed compositions, and nonionic surfactants. Specific examples include alkyl diethanolamides, monoesters of alkyl diethanols, lauryl diethanolamide, myristyl diethanolamide, palmityl diethanolamide, stearyl diethanolamide, monoesters of alkyl diethanolamides with lauric acid, monoesters of alkyl diethanolamides with myristic acid, monoesters of alkyl diethanolamides with palmitic acid, and monoesters of alkyl diethanolamides with stearic acid.

Surfactants include cationic surfactants, anionic surfactants, amphoteric surfactants, and nonionic surfactants, and there are no particular limitations. From the viewpoint of compatibility with resin and thermal stability, nonionic surfactants are preferably used.

Specific examples include sorbitan based surfactants such as sorbitan fatty acid esters, such as sorbitan monopalmitate, sorbitan monostearate, sorbitan monopalmitate, sorbitan monomontanate, sorbitan monooleate, and sorbitan dioleate, and their alkylene oxide adducts, glycerol-based surfactants such as glycerol fatty acid esters, e.g. glycerol monopalmitate, glycerol monostearate, diglycerol distearate, triglycerol monostearate, tetraglycerol dimontanate, glycerol monooleate, diglycerol monooleate, diglycerol sesquioleate, tetraglycerol monooleate, hexaglycerol monooleate, hexaglycerol trioleate, tetraglycerol trioleate, tetraglycerol monolaurate and hexaglycerol monolaurate, and their alkylene oxide adducts, polyethylene glycol-based surfactants such as polyethylene glycol monopalmitate and polyethylene glycol monostearate, alkylene oxide adducts of alkylphenols, esters of sorbitan/glycerol condensates with organic acids, polyoxyethylene alkylamines, such as polyoxyethylene (2 mol) stearylamine, polyoxyethylene (4 mol) stearylamine, polyoxyethylene (2 mol) stearylamine monostearate, polyoxyethylene (4 mol) laurylamine monosterarate, and their fatty acid esters. Further examples include fluorine compounds having a perfluoroalkyl group, an omega-hydrofluoroalkyl group, or the like (especially, fluorine-containing surfactants), and silicone type compounds having an alkylsiloxane group (especially, silicone type surfactants). Specific examples of fluorine-containing surfactants include UNIDYNE DS-403, DS-406, DS-401 (trade names) produced by Daikin Industries, Ltd., and SURFLON KC-40 (trade name) produced by SEIMI CHEMICAL Co., Ltd. Examples of silicone type surfactants include SH-3746 (trade name) produced by Toray Dow Corning Silicone Co.

As the solid material to constitute a substrate, only a single kind of solid material may be used and two or more solid materials may be used in combination.

In an inorganic particle composite body of the present invention or an inorganic particle structural body, which is a precursor of the composite body, the inorganic particles that constitute their inorganic particle layer are typically particles made of an elemental metal or an alloy, or an inorganic compound, or a mixture of an elemental metal or an alloy with an inorganic compound. As to the chemical composition of inorganic particles, only a single kind of inorganic particles may be used and two or more kinds of inorganic particles may be used in combination. Moreover, an inorganic particle structural body may be formed by combining particles differing in average particle diameter.

Examples of inorganic particles include metal oxides, such as iron oxide, magnesium oxide, aluminum oxide, silicon oxide (silica), titanium oxide, cobalt oxide, copper oxide, zinc oxide, cerium oxide, yttrium oxide, indium oxide, silver oxide, tin oxide, holmium oxide, bismuth oxide, and indium tin oxide, complex oxides, such as indium tin oxide, metal salts, such as calcium carbonate and barium sulfate, and inorganic layered compounds, such as clay minerals and carbon-based intercalation compounds.

As an inorganic layered compound, an inorganic layered compound having a property that it is swollen and cleaved by a solvent is used preferably from a viewpoint that a large aspect ratio can be obtained easily.

As such an inorganic layered compound is swollen and cleaved by a solvent, a clay mineral that exhibits swellability and cleavability in a solvent is used particularly preferably. Clay minerals are generally classified into a type having a two-layer structure having, on a silica tetrahedral layer, an octahedral layer containing aluminum, magnesium or the like as a central metal, and a type having a three-layer structure in which an octahedral layer containing aluminum, magnesium or the like as a central metal is sandwiched on its both sides by silica tetrahedral layers. Examples of the former type can include kaolinite series, antigorite series, and so on, whereas examples of the latter type can include smectite series, vermiculite series, mica series, and so on depending on the number of interlayer cations.

Clay minerals are minerals primarily made of silicate minerals having a layered crystal structure. Examples thereof can include kaolinite series, antigorite series, smectite series, vermiculite series, and mica series. Specific examples can include kaolinite, dickite, nacrite, halloysite, antigorite, chrysotile, pyrophyllite, montmorillonite, hectorite, tetrasilylic mica, sodium taeniolite, muscovite, margarite, talc, vermiculite, phlogopite, xanthophyllite, and chlorite.

The shape of inorganic particles may be any shape, such as spherical shape, needle-like shape, scaly shape, and fibrous shape. In the present invention, the particle diameter of inorganic particles refers to an average particle diameter measured by the dynamic light scattering method, the Sears method, or the laser diffraction scattering method or a spherical equivalent diameter calculated from a BET specific surface area. In the case of fibrous particles, the particle diameter of such a particle refers to the diameter of a section perpendicular to the longitudinal direction of the particle. The Sears method, which is disclosed in Analytical Chemistry, Vol. 28, p. 1981-1983, 1956, is an analytical method to be applied to the measurement of the average particle diameter of silica particles; it is a method in which the surface area of silica particles is determined from the amount of NaOH to be consumed for making a colloidal silica dispersion liquid from pH=3 to pH=9 and then a sphere equivalent diameter is calculated from the determined surface area.

When inorganic particles have an aspect ratio of up to 2, the average particle diameter thereof can be determined also from an image observed using an optical microscope, a laser microscope, a scanning electron microscope, a transmission electron microscope, an atomic force microscope, or the like.

The particle diameter of inorganic particles is preferably from 1 to 10000 nm from the viewpoint of interaction force between particles, such as atomic force and van der Waals force. When the inorganic particles have an aspect ratio of 2 or less, the particle diameter is from 1 to 500 nm, preferably from 1 to 200 nm, and more preferably from 2 to 100 nm. When the inorganic particles are made of an inorganic layered compound, the particle diameter is from 10 to 3000 nm, preferably from 20 to 2000 nm, and more preferably from 100 to 1000 nm.

The layer of the substrate can be used in the form of, for example, a laminated material with a metal foil or with a support (meta, resin, glass, ceramics, paper, cloth, etc.) having a metal foil as at least one surface layer, or a laminated material with a plate or film made of the aforementioned resin or with a support (metal, resin, glass, ceramics, paper, cloth, etc.) having such a resin layer as at least one surface layer. This metal foil can be obtained easily by conventional metal processing methods, such as a rolling method, and the plate or film made of resin can be obtained easily by conventional resin film-forming processes, such as a T-shaped die extrusion process, a blow-extrusion process, and a solvent casting process. Stacked substrates having a metal thin film as at least one surface layer can be formed by a metal deposition process, a sputtering process, or the like. Stacked substrate having a resin layer as at least one surface layer can be formed by conventional methods, such as a co-extrusion process, an extrusion lamination process, and a solvent casting process.

The support to be used for the present invention refers to a material that supports an inorganic particle structural body. The support is not particularly limited if it can support an inorganic particle structural body. Specifically, metal, resin, glass, ceramics, paper, cloth, and the like are used in a form (tabular form such as film form and sheet form, rod form, fibrous form, spherical form, three-dimensional structural form, etc.), if necessary.

Hereafter the inorganic particle structural body to be used in the present invention is described. The inorganic particle structural body is a precursor of the inorganic particle composite body of the present invention.

The inorganic particle structural body is an article comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate.

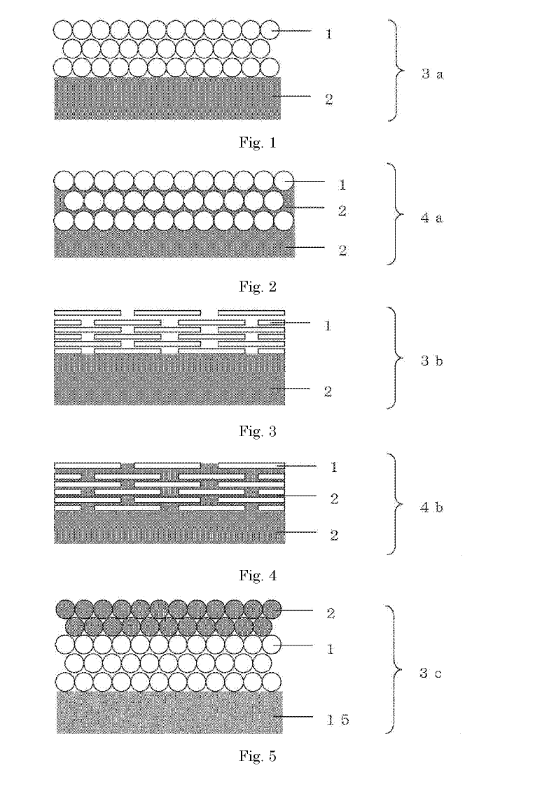

The shape of the inorganic particle structural body of the present invention has no particular limitations, and representative examples thereof are shown in FIGS. 1, 3, 5 and 7. As illustrated in these drawings, the inorganic particle structural body of the present invention usually has a porous structure, and it is preferred that at least some of the pores interconnect. Because of such interconnection, it becomes easy, in plastically deforming a substrate by pressuring an inorganic particle structural body, to fill up gaps in the inorganic particle structural body with the material of the substrate plastically deformed.

Methods for producing an inorganic particle structural body include the following, for example.

Method 1: A method by which a coating liquid containing inorganic particles and a liquid dispersion medium is applied to a plate-shaped substrate, and then an inorganic particle layer is formed by removing the liquid dispersion medium from the coating liquid applied, in other words, by drying the coating liquid applied.
Method 2: A method by which a coating liquid containing inorganic particles and a liquid dispersion medium is applied to a support, and then an inorganic particle layer is formed by drying the coating liquid applied, and then a coating liquid containing solid material particles for forming a substrate and a liquid dispersion medium to the inorganic particle layer, and then a substrate layer is formed by drying the coating liquid applied.
Method 3: A method by which a coating liquid containing inorganic particles and a liquid dispersion medium is applied to a support, and then an inorganic particle layer is formed by drying the coating liquid applied, and then a substrate layer is formed by laminating a plate-shaped substrate to the aforementioned inorganic particle layer.

FIG. 1 is a schematic diagram of an inorganic particle structural body 3a formed by the above-described Method 1. In FIG. 1, some of inorganic particles 1 and a substrate 2 are in contact with each other. Illustrated in FIG. 1 is a case in which the inorganic particles 1 are spherical and the substrate 2 is plate-shaped. An inorganic particle layer formed of spherical inorganic particles has gaps between the particles. By pressurizing the inorganic particle structural body 3a, a part of the substrate 2 mainly in contact with the inorganic particles plastically deform and it gradually fills the gaps in the inorganic particle structural body 3a. The inorganic particle composite body of the present invention is an object formed by filling at least some of the gaps in the inorganic particle structural body 3a with the material of the substrate plastically deformed. The inorganic particle composite body of the present invention in the case of filling some gaps is the inorganic particle composite body 4a of FIG. 2.

An inorganic particle structural body formed by applying a coating liquid containing metal particles to a support, then forming a metal layer by drying the coating liquid, subsequently applying a coating liquid containing inorganic particles to the metal layer, and then drying the coating liquid can also be used. In this case, the metal layer is a substrate layer.

FIG. 3 is a schematic diagram of an inorganic particle structural body formed by the above-described Method 1. In FIG. 3, some of inorganic particles 1 and a substrate 2 are in contact with each other. Illustrated in FIG. 3 is a case in which the inorganic particles 1 are plate-shaped and the substrate 2 is also plate-shaped. An inorganic particle layer formed of plate-shaped inorganic particles has gaps between the particles. By pressurizing the inorganic particle structural body 3b, a part of the substrate 2 mainly in contact with the inorganic particles plastically deform and it gradually fills the gaps in the inorganic particle structural body 3b. The inorganic particle composite body of the present invention is an object formed by filling at least some of the gaps in the inorganic particle structural body 3b with the material of the substrate plastically deformed. The inorganic particle composite body of the present invention in the case of filling up all gaps is the inorganic particle composite body 4b of FIG. 4.

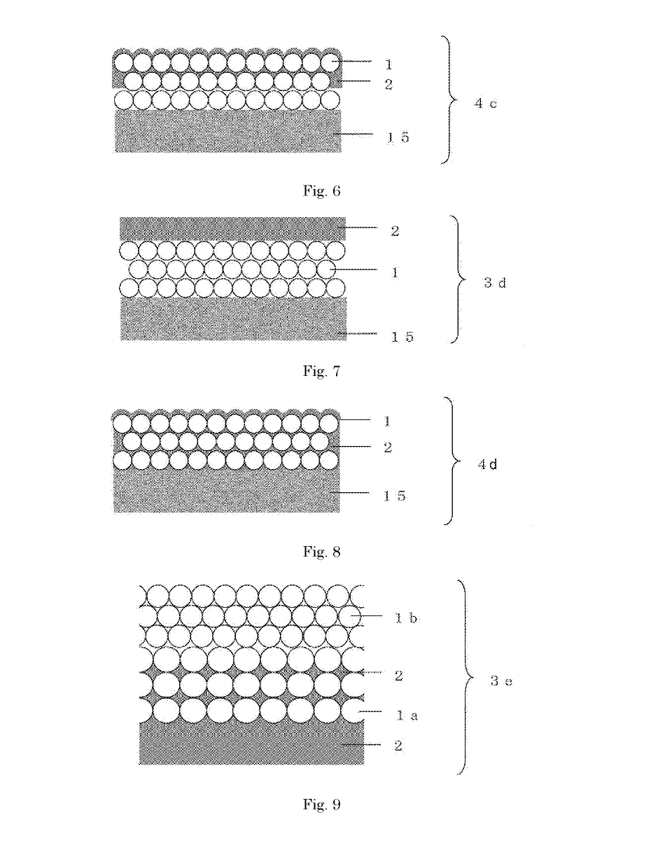

FIG. 5 is a schematic diagram of an inorganic particle structural body 3c formed by the above-described Method 2. In FIG. 5, an inorganic particle layer is disposed on a support 5, and some of inorganic particles 1 are in contact with the substrates 2 each other. Illustrated in FIG. 5 is a case in which the inorganic particles 1 are spherical and the substrate 2 is an aggregate of solid material particles. An inorganic particle layer formed of spherical inorganic particles has gaps between the particles. By pressurizing the inorganic particle structural body 3c, a part of the substrate 2 mainly in contact with the inorganic particles plastically deform and it gradually fills the gaps in the inorganic particle structural body 3c. The inorganic particle composite body of the present invention is an object formed by filling at least some of the gaps in the inorganic particle structural body 4c with the material of the substrate plastically deformed. The inorganic particle composite body of the present invention in the case of filling some gaps is the inorganic particle composite body 4c of FIG. 6.

An inorganic particle structural body formed by applying a coating liquid containing substrate particles to a support, then forming a substrate layer by drying the coating liquid, subsequently applying the coating liquid containing inorganic particles to the substrate layer, and then drying the coating liquid can also be used.

FIG. 7 is a schematic diagram of an inorganic particle structural body 3d formed by the above-described Method 3. In FIG. 7, an inorganic particle layer is disposed on a support 5, and some of inorganic particles 1 are in contact with the substrates 2 each other. Illustrated in FIG. 7 is a case in which the inorganic particles 1 are spherical and the substrate 2 is plate-shaped. An inorganic particle layer formed of spherical inorganic particles 1 has gaps between the particles. By pressurizing the inorganic particle structural body 3d, a part of the substrate 2 mainly in contact with the inorganic particles plastically deform and it gradually fills the gaps of the inorganic particle structural body 3d. The inorganic particle composite body of the present invention is an object formed by filling at least some of the gaps of the inorganic particle structural body 3d with the material of the substrate plastically deformed. The inorganic particle composite body of the present invention in the case of filling up all gaps is the inorganic particle composite body 4d of FIG. 8.

It is also permitted to use an inorganic particle structural body formed by stacking a plate-shaped substrate on a support, then applying a coating liquid containing inorganic particles to the substrate, and subsequently drying the coating liquid.

In the above-mentioned Methods 1 and 3, a coating liquid containing inorganic particles and a liquid dispersion medium is prepared, and in the aforementioned Method 2, a coating liquid containing inorganic particles and a liquid dispersion medium and a coating liquid containing particles of a solid material for forming a substrate and a liquid dispersion medium are prepared.

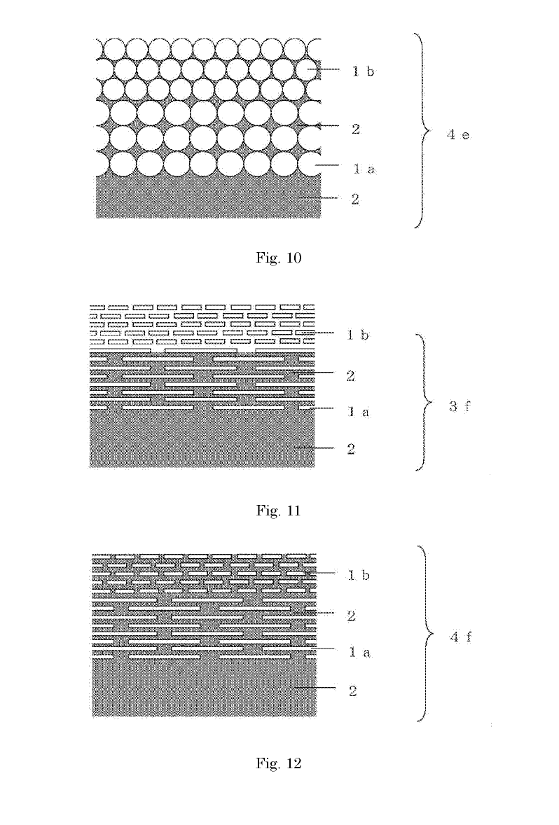

FIG. 9 is a schematic diagram of an inorganic particle structural body produced by preparing a hybridized inorganic particle structural body 3e using an inorganic particle structural body formed by the above-described Method 1 (the structural body used is hereinafter referred to as an initial inorganic particle structural body), and then further forming, on the inorganic particle layer of the prepared structural body (this layer is hereinafter referred to as a first inorganic particle layer), a second inorganic particle layer. In FIG. 9, some of inorganic particles 1a of the first inorganic particle layer and a substrate 2 are in contact with each other. Illustrated in FIG. 9 is a case in which the inorganic particles 1a and 1b are spherical and the substrate 2 is plate-shaped. The first inorganic particle layer formed of the spherical inorganic particles 1a has gaps between the particles in the initial condition. The substrate 2, mainly its part in contact with inorganic particles 1a, in the initial inorganic particle structural body is plastically deformed to gradually fill gaps defined by the inorganic particles 1a, so that the hybridized inorganic particle structural body 3e is formed. Then, onto the hybridized inorganic particle structural body 3e is stacked a layer (second inorganic particle layer) made of inorganic particles 1b that differ in composition from the inorganic particles 1a contained in the hybridized inorganic particle structural body. Since the second inorganic particle layer stacked in this step is also made of particles, it has gaps therein. Then, the substrate 2 contained in the hybridized inorganic particle structural body 3e with the second inorganic particle layer stacked thereon is plastically deformed. The substrate, mainly its part in contact with in inorganic particles, in the inorganic particle structural body 3e is plastically deformed, so that the gaps of the hybridized inorganic particle structural body 3e and/or the gaps of the second inorganic particle layer are filled gradually with the solid material of the plastically deformed substrate 2. When all or at least part of the gaps is filled, an inorganic particle composite body 4e of FIG. 10 is formed. It is preferred to fill at least part of the gaps of the stacked inorganic particle layer by plastically deforming the substrate.

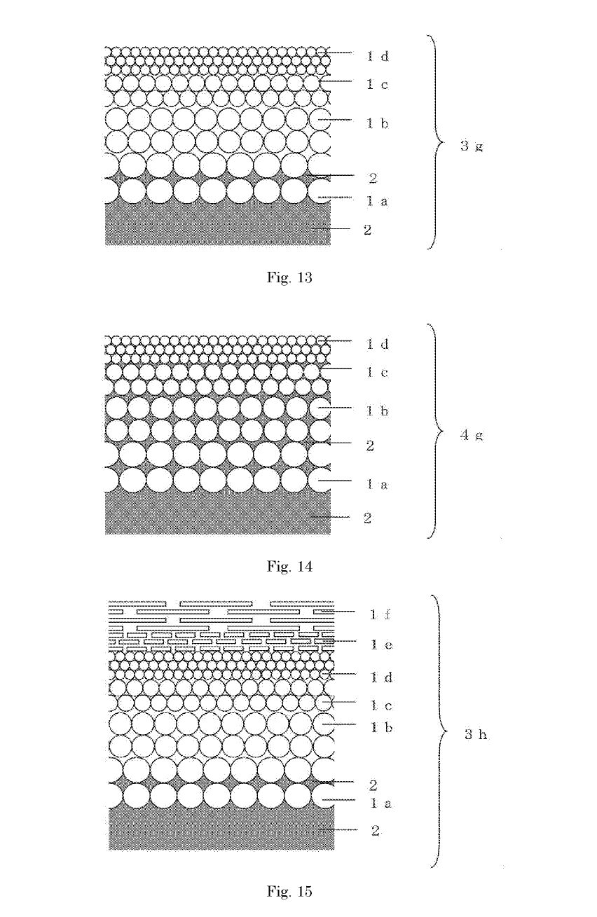

FIG. 11 is a schematic diagram of an inorganic particle structural body produced by preparing a hybridized inorganic particle structural body 3f using an inorganic particle structural body formed by the above-described Method 1 (the structural body used is hereinafter referred to as an initial inorganic particle structural body), and then further forming, on the inorganic particle layer of the prepared structural body (this layer is hereinafter referred to as a first inorganic particle layer), a second inorganic particle layer. In FIG. 11, some of inorganic particles 1a of the first inorganic particle layer and a substrate 2 are in contact with each other. Illustrated in FIG. 11 is a case in which the inorganic particles are plate-like in shape and the substrate 2 is also plate-shaped. An inorganic particle layer formed of plate-shaped inorganic particles has gaps between the particles. The substrate 2, mainly its part in contact with inorganic particles 1a, in the initial inorganic particle structural body is plastically deformed to gradually fill gaps defined by the inorganic particles 1a, so that the hybridized inorganic particle structural body 3f is formed. Then, onto the hybridized inorganic particle structural body 3f is stacked a layer (second inorganic particle layer) made of inorganic particles 1b that differ in composition from the inorganic particles 1a contained in the hybridized inorganic particle structural body. Since the second inorganic particle layer stacked in this step is also made of particles, it has gaps therein. Then, the substrate 2 contained in the hybridized inorganic particle structural body 3f with the second inorganic particle layer stacked thereon is plastically deformed. The substrate, mainly its part in contact with in inorganic particles, in the inorganic particle structural body 3f is plastically deformed, so that the gaps of the hybridized inorganic particle structural body 3f and/or the gaps of the second inorganic particle layer are filled gradually with the solid material of the plastically deformed substrate 2. When all or at least part of the gaps is filled, the inorganic particle composite body 4f of FIG. 12 is formed. It is preferred to fill at least part of the gaps of the stacked inorganic particle layer by plastically deforming the substrate.

FIG. 13 is a schematic diagram of an inorganic particle structural body produced by preparing a hybridized inorganic particle structural body 3g using an inorganic particle structural body formed by the above-described Method 1 (the structural body used is hereinafter referred to as an initial inorganic particle structural body), and then further stacking, on the inorganic particle layer of the prepared structural body (this layer is hereinafter referred to as a first inorganic particle layer), two or more inorganic particle layers. In FIG. 13, some of inorganic particles 1a of the first inorganic particle layer and a substrate 2 are in contact with each other. Illustrated in FIG. 13 is a case in which the inorganic particles 1a, 1b, 1c and 1d are spherical and the substrate 2 is plate-shaped. An inorganic particle layer formed of spherical inorganic particles has gaps between the particles. The substrate 2, mainly its part in contact with inorganic particles 1a, in the initial inorganic particle structural body is plastically deformed to gradually fill gaps defined by the inorganic particles 1a, so that the hybridized inorganic particle structural body is formed. Then, onto the hybridized inorganic particle structural body is stacked a layer (second inorganic particle layer) made of inorganic particles 1b that differ in composition from the inorganic particles 1a contained in the hybridized inorganic particle structural body. Since the second inorganic particle layer stacked in this step is also made of particles, it has gaps therein. Then, the substrate 2 contained in the hybridized inorganic particle structural body with the second inorganic particle layer stacked thereon is plastically deformed. The substrate 2, mainly its part in contact with in inorganic particles, in the aforementioned hybridized inorganic particle structural body is plastically deformed, so that the gaps of the hybridized inorganic particle structural body and/or the gaps of the second inorganic particle layer are filled gradually with the solid material of the plastically deformed substrate 2.

The structural body of FIG. 13 has four inorganic particle layers and the rate of gaps of the inorganic particle layers become smaller stepwise from the side closer to the substrate 2 toward the side further from the substrate 2. The furthest inorganic particle layer from the substrate 2 has almost no gaps. An inorganic particle composite body can be produced by stacking a plurality of inorganic particle layers so that the rate of gaps may vary stepwise to produce a stacked inorganic particle structural body and then plastically deforming the substrate contained in the stacked inorganic particle structural body. The rate of gaps of an inorganic particle layer can be adjusted by changing the particle diameter of the inorganic particles that constitute the layer. If the substrate 2 is filled to the inorganic particle layer furthest from the substrate 2, an inorganic particle composite body 4g of FIG. 14 is formed. The resulting inorganic particle composite body has both a region where the property of the substrate is dominant and a region where the property of the inorganic particles is dominant. If the combination of inorganic particles and a substrate is optimized, completely different properties can be given to one inorganic particle composite body.

The inorganic particle layer that is highest in the rate of gaps and nearest to the substrate and the inorganic particle layer that is lowest in the rate of gaps and furthest from the substrate are considered. When all the gaps of the inorganic particle layer nearest to the substrate have been filled up with the material of the substrate, the presence ratio of the material of the substrate to the inorganic particles in this layer is high, so that this layer has a property that is a combination of the property of the inorganic particles and the property of the substrate.

On the other hand, when the material of the substrate has been filled in the gaps of the inorganic particle layer that is lowest in the rate of gaps and furthest from the substrate, this layer has a property the same as that of the inorganic particles because the presence ratio of the material of the substrate to the inorganic particles in this layer is very low and therefore this layer is hardly influenced by the property of the substrate.

Usually, if substances differing in property have been united, adhesiveness will become poor because of the difference in properties between the substances. For example, a laminate of glass and a resin film easily delaminates because the coefficient of linear expansion of an interface between glass and resin is different.

However, in an inorganic particle composite body in which the rate of gaps is varied stepwise as illustrated in FIG. 14 and thereby properties of respective layers are varied stepwise, adhesiveness between layers is high since a property varies gradually within the composite body. As a result, completely different properties can be imparted to an inorganic particle composite body while keeping the adhesiveness between layers good.

It is preferred to fill at least part of the gaps of the stacked inorganic particle layer by plastically deforming the substrate.

FIG. 15 is a schematic diagram of a stacked inorganic particle structural body produced by preparing a hybridized inorganic particle structural body 3h using an inorganic particle structural body formed by the above-described Method 1 (the structural body used is hereinafter referred to as an initial inorganic particle structural body), and then further stacking, on the inorganic particle layer of the prepared structural body (this layer is hereinafter referred to as a first inorganic particle layer), two or more inorganic particle layers. In FIG. 15, some of inorganic particles 1a of the first inorganic particle layer and a substrate 2 are in contact with each other. Illustrated in FIG. 15 is a case in which the inorganic particles are spherical or plate-like in shape and the substrate 2 is plate-shaped.

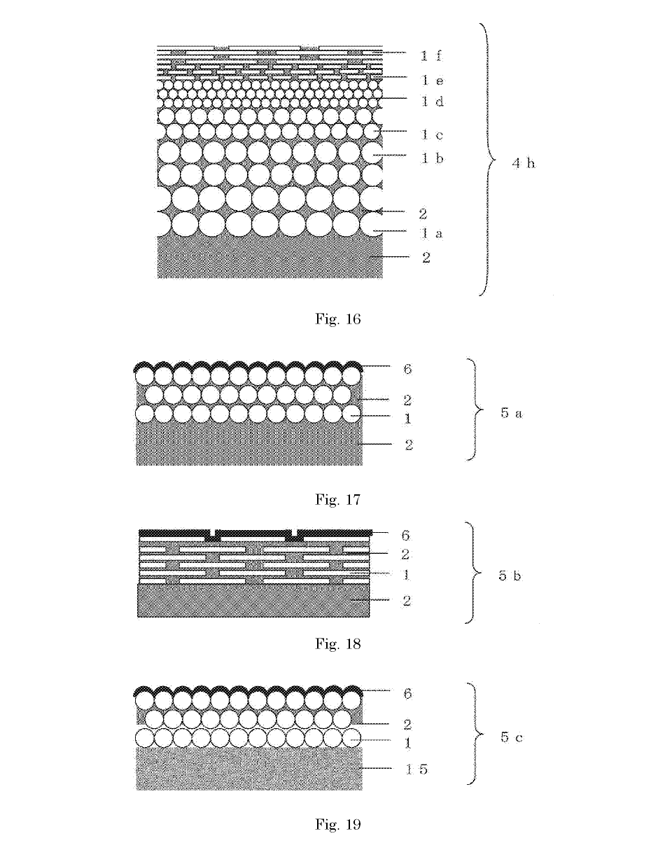

By further providing a plurality of inorganic particle layers on the surface of the first inorganic particle layer of the aforementioned initial inorganic particle structural body and then pressurizing it, a part of the substrate 2 mainly in contact with the inorganic particles 1a plastically deforms and it gradually fills the gaps of the inorganic particle layers of the stacked inorganic particle structural body. There are five inorganic particle layers and the material of the plastically deformed substrate continuously fills the gaps of the stacked inorganic particle structural body gradually, so that the interlayer adhesion strength becomes very high. The inorganic particle composite body of the present invention in the case of filling up all gaps is the inorganic particle composite body 4h of FIG. 16.

FIG. 17 is a schematic diagram of a hydrophilic inorganic particle composite body 5a obtained by applying hydrophilization to the surface of the inorganic particle composite body 4a illustrated in FIG. 2. Although there is no limitation with such hydrophilization, preferred is a method comprising stacking a layer containing a hydrophilizing agent onto at least a part of the surface of an inorganic particle composite body and/or a method comprising reacting a hydrophilizing agent to at least a part of the surface of an inorganic particle composite body.

FIG. 18 is a schematic diagram of a hydrophilic inorganic particle composite body 5b obtained by applying hydrophilization to the surface of the inorganic particle composite body 4b illustrated in FIG. 4. Although there is no limitation with such hydrophilization, preferred is a method comprising stacking a layer containing a hydrophilizing agent onto at least a part of the surface of an inorganic particle composite body and/or a method comprising reacting a hydrophilizing agent to at least a part of the surface of an inorganic particle composite body.

FIG. 19 is a schematic diagram of a hydrophilic inorganic particle composite body 5c obtained by applying hydrophilization to the surface of the inorganic particle composite body 4c illustrated in FIG. 6. Although there is no limitation with such hydrophilization, preferred is a method comprising stacking a layer containing a hydrophilizing agent onto at least a part of the surface of an inorganic particle composite body surface and/or a method comprising reacting a hydrophilizing agent to at least a part of the surface of an inorganic particle composite body.

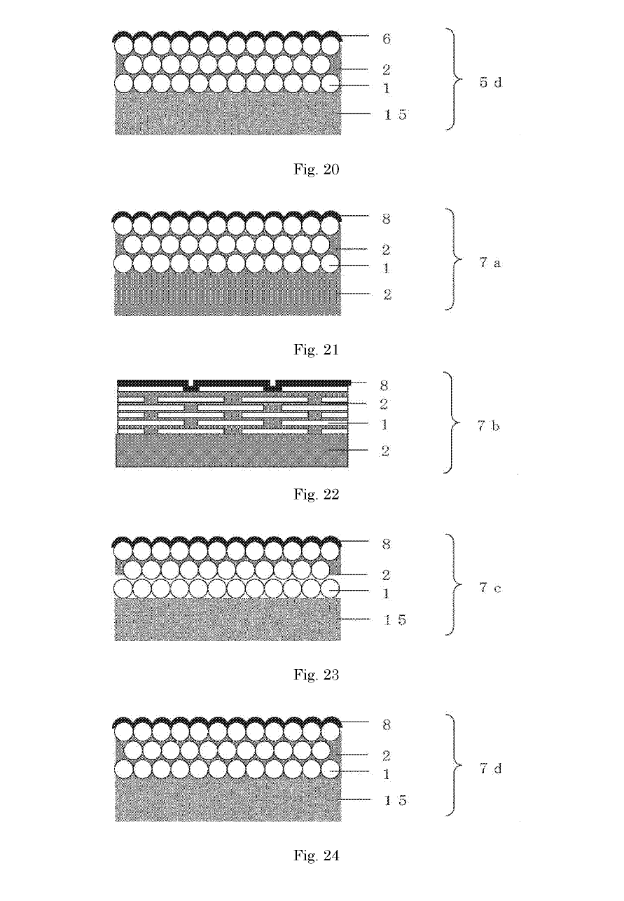

FIG. 20 is a schematic diagram of a hydrophilic inorganic particle composite body 5d obtained by applying hydrophilization to the surface of the inorganic particle composite body 4d illustrated in FIG. 8. Although there is no limitation with such hydrophilization, preferred is a method comprising stacking a layer containing a hydrophilizing agent onto at least a part of the surface of an inorganic particle composite body and/or a method comprising reacting a hydrophilizing agent to at least a part of the surface of an inorganic particle composite body.

FIG. 21 is a schematic diagram of a hydrophobic inorganic particle composite body 7a obtained by applying hydrophobization to the surface of the inorganic particle composite body 4a illustrated in FIG. 2. Although there is no limitation with such hydrophobization, preferred is a method comprising stacking a layer containing a hydrophobizing agent onto at least a part of the surface of an inorganic particle composite body and/or a method comprising reacting a hydrophobizing agent to at least a part of the surface of an inorganic particle composite body.

FIG. 22 is a schematic diagram of a hydrophobic inorganic particle composite body 7b obtained by applying hydrophobization to the surface of the inorganic particle composite body 4b illustrated in FIG. 4. Although there is no limitation with such hydrophobization, preferred is a method comprising stacking a layer containing a hydrophobizing agent onto at least a part of the surface of an inorganic particle composite body and/or a method comprising reacting a hydrophobizing agent to at least a part of the surface of an inorganic particle composite body.

FIG. 23 is a schematic diagram of a hydrophobic inorganic particle composite body 7c obtained by applying hydrophobization to the surface of the inorganic particle composite body 4c illustrated in FIG. 6. Although there is no limitation with such hydrophobization, preferred is a method comprising stacking a layer containing a hydrophobizing agent onto at least a part of the surface of an inorganic particle composite body and/or a method comprising reacting a hydrophobizing agent to at least a part of the surface of an inorganic particle composite body.

FIG. 24 is a schematic diagram of a hydrophobic inorganic particle composite body 7d obtained by applying hydrophobization to the surface of the inorganic particle composite body 4d illustrated in FIG. 8. Although there is no limitation with such hydrophobization, preferred is a method comprising stacking a layer containing a hydrophobizing agent onto at least a part of the surface of an inorganic particle composite body and/or a method comprising reacting a hydrophobizing agent to at least a part of the surface of an inorganic particle composite body.

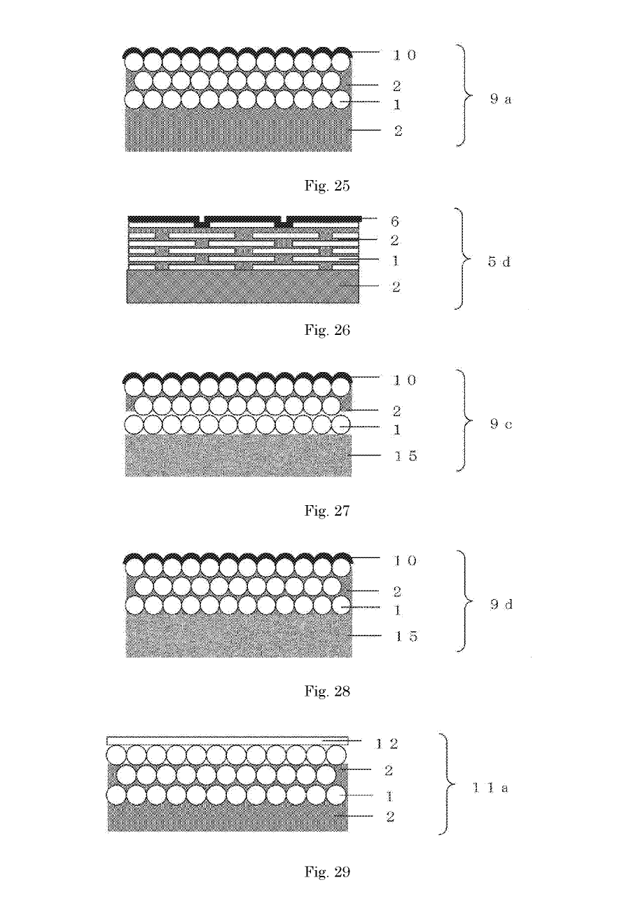

FIG. 25 is a schematic diagram of an antireflective inorganic particle composite body 9a obtained by applying antireflecting treatment to the surface of the inorganic particle composite body 4a illustrated in FIG. 2. Although antireflecting treatment is not particularly limited, it is preferably a method of coating the surface of an inorganic particle composite body with an antireflecting agent by a wet coating process and/or a dry coating process. In the present invention, the wet coating method includes methods comprising applying a coating liquid containing a treating agent and drying it, such as a reverse coating method, a die coating method, a dip coating method, a gravure coating method, a flexographic coating method, an ink jet coating method, and a screen printing; the dry coating method include a sputtering method, a chemical vapor deposition (CVD) method, a plasma CVD method, a plasma polymerization method, and a vacuum deposition method. These may be used singly or two or more of them may be used in combination.

FIG. 26 is a schematic diagram of an antireflective inorganic particle composite body 9b obtained by applying antireflecting treatment to the surface of the inorganic particle composite body 4b illustrated in FIG. 4. Although antireflecting treatment is not particularly limited, it is preferably a method of coating the surface of an inorganic particle composite body with an antireflecting agent by a wet coating process and/or a dry coating process.

FIG. 27 is a schematic diagram of an antireflective inorganic particle composite body 9c obtained by applying antireflecting treatment to the surface of the inorganic particle composite body 4c illustrated in FIG. 6. Although antireflecting treatment is not particularly limited, it is preferably a method of coating the surface of an inorganic particle composite body with an antireflecting agent by a wet coating process and/or a dry coating process.

FIG. 28 is a schematic diagram of an antireflective inorganic particle composite body 9d obtained by applying antireflecting treatment to the surface of the inorganic particle composite body 4d illustrated in FIG. 8. Although antireflecting treatment is not particularly limited, it is preferably a method of coating the surface of an inorganic particle composite body with an antireflecting agent by a wet coating process and/or a dry coating process.

FIG. 29 is a schematic diagram of an inorganic particle composite body 11a obtained by stacking a glass layer 12 on the inorganic particle composite body 4a illustrated in FIG. 2. Although the method for stacking a glass layer is not limited, preferred are a method in which a glass sheet and an inorganic particle composite body are bonded together via an adhesive, a method in which an inorganic particle composite body is coated with a glass precursor and then the glass precursor is vitrified, and a method in which molten glass is extrusion-laminated to an inorganic particle composite body.

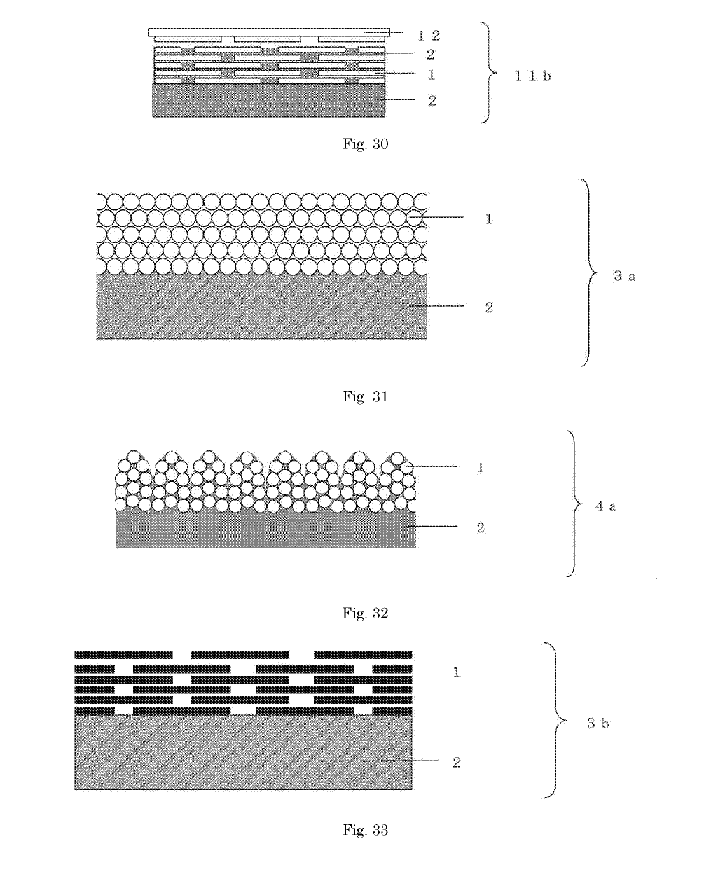

FIG. 30 is a schematic diagram of a stacked inorganic particle composite body 11b obtained by stacking a glass layer 12 on the inorganic particle composite body 4b illustrated in FIG. 4. Although the method for stacking a glass layer is not limited, preferred are a method in which a glass sheet and an inorganic particle composite body are bonded together via an adhesive, a method in which an inorganic particle composite body is coated with a glass precursor and then the glass precursor is vitrified, and a method in which molten glass is extrusion-laminated to an inorganic particle composite body.

FIG. 31 is a schematic diagram of an inorganic particle structural body 3a formed by the above-described Method 1. By forming the inorganic particle structural body 3a, the solid material constituting the substrate in the inorganic particle structural body 3a deforms plastically and some portion thereof gradually fills gaps in the inorganic particle layer of the inorganic particle structural body 3a and, simultaneously, the three-dimensional shape of the surface of a molding machine in contact with the structural body is transferred to the surface of the structural body, so that a three-dimensional design is given to the surface of the structural body. By filling at least some of the gaps in the inorganic particle layer with the material of the plastically deformed substrate and simultaneously shaping it, an inorganic particle composite molded article 4a of FIG. 32 is formed. It is more preferred to leave some gaps unfilled rather than to fill up all gaps because it is easier to perform the following treatment such as painting treatment.

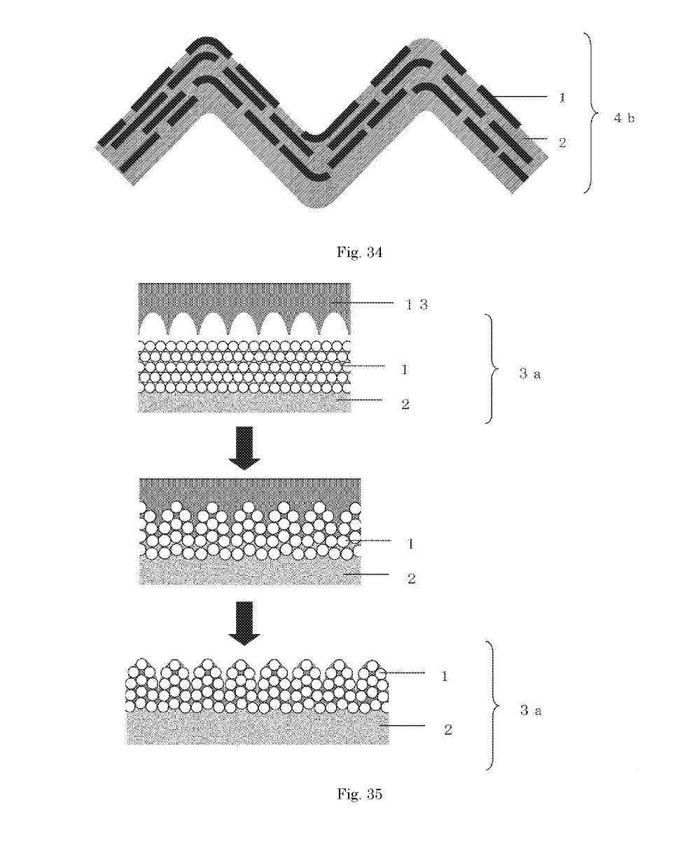

FIG. 33 is a schematic diagram of an inorganic particle structural body 3b formed by the above-described Method 1. By forming the inorganic particle structural body 3b, the solid material constituting the substrate in the inorganic particle structural body 3b deforms plastically and some portion thereof gradually fills gaps in the inorganic particle layer of the inorganic particle structural body 3b and, simultaneously, the three-dimensional shape of the surface of a molding machine in contact with the structural body is transferred to the surface of the structural body, so that a three-dimensional design is given to the surface of the structural body. By filling at least some of the gaps in the inorganic particle layer with the material of the plastically deformed substrate and simultaneously shaping it, an inorganic particle composite molded article 4b of FIG. 34 is formed. It is more preferred to leave some gaps unfilled rather than to fill up all gaps because it is easier to perform the following treatment such as painting treatment.

FIG. 35 is a schematic diagram illustrating a process (press molding) of producing the inorganic particle composite body 4a shown in FIG. 32 from the inorganic particle structural body 3a shown in FIG. 31. It is also permitted to preheat the inorganic particle structural body before press molding or to heat or cool it in a mold during press molding.

Now, a coating liquid containing inorganic particles and a liquid dispersion medium to be used for the formation of an inorganic particle layer is described.

Although the liquid dispersion medium may be any one having a function to disperse inorganic particles and water and volatile organic solvents can be used, water is preferred because it is easy to handle. In order to improve the dispersibility to the solvent, it is permitted to apply surface treatment to inorganic particles and also permitted to add a dispersion medium electrolyte and a dispersion aid.

When dispersing inorganic particles colloidally in a coating liquid, it is permitted to perform pH adjustment or add an electrolyte or a dispersing agent, if necessary. In order to disperse particles uniformly, it is permitted to use techniques, such as stirring with a stirrer, ultrasonic dispersion, and super high pressure dispersion (super high pressure homogenizer), if necessary. Although the inorganic particle concentration of a coating liquid is not particularly limited, it is preferably from 1 to 50% by weight for maintaining the stability of the particles in the solution.

When the inorganic particles are made of alumina and the coating liquid is in a colloidal state, it is preferred to add an anion, such as chloride ion, sulfate ion, and acetate ion, to the coating liquid.

When the inorganic particles are made of silica and the coating liquid is in a colloidal state, it is preferred to add a cation, such as ammonium ion, alkali metal ion, and alkaline earth metal ion, to the coating liquid.

To the coating liquid may be added additives, such as surfactant, polyhydric alcohols, soluble resins, dispersibility resins, and organic electrolytes, for the purpose of, e.g., stabilizing the dispersion of particles.

When the coating liquid contains a surfactant, the content thereof is usually 0.1 parts by weight or less based on 100 parts by weight of the liquid dispersion medium. The surfactant to be used is not particularly limited and examples thereof include anionic surfactants, cationic surfactants, nonionic surfactants, and ampholytic surfactants.

The anionic surfactants include alkali metal salts of carboxylic acids and specifically include sodium caprylate, potassium caprylate, sodium decanoate, sodium caproate, sodium myristate, potassium oleate, tetramethylammonium stearate, and sodium stearate. Especially, alkali metal salts of carboxylic acids with alkyl chains having from 6 to 10 carbon atoms are preferred.

Examples of the cationic surfactants include cetyltrimethylammonium chloride, dioctadecyldimethylammonium chloride, N-octadecylpyridinium bromide, and cetyltriethylphosphonium bromide.

Examples of the nonionic surfactants include sorbitan esters of fatty acids and glycerol esters of fatty acids.

The ampholytic surfactants include 2-alkyl-N-carboxymethyl-N-hydroxyethylimidazolinium betaine, lauric acid amidopropyl betaine, and the like.

When the coating liquid contains a polyhydric alcohol, the content thereof is usually 10 parts by weight or less, preferably 5 parts by weight or less based on 100 parts by weight of the liquid dispersion medium. Addition of a small amount of a polyhydric alcohol can improve the antistatic property of an inorganic particle composite body.

The polyhydric alcohol to be used is not particularly limited, and examples thereof include glycol type polyhydric alcohols, such as ethylene glycol, diethylene glycol, polyethylene glycol, propylene glycol, dipropylene glycol, and polypropylene glycol, glycerol type polyhydric alcohols, such as glycerol, diglycerol, and polyglycerol, and methylol type polyhydric alcohols, such as pentaerythritol, dipentaerythritol, and tetramethylolpropane.

When the coating liquid contains a soluble resin, the content thereof is usually 1 part by weight or less, preferably 0.1 parts by weight or less based on 100 parts by weight of the liquid dispersion medium. Addition of a small amount of a soluble resin can make the formation of an inorganic particle structural body easier and can impart a function of the soluble resin. The soluble resin to be used here is not particularly limited if it is soluble in a liquid dispersion medium, and examples thereof include polyvinyl alcohol type resins, such as polyvinyl alcohol, ethylene-vinyl alcohol copolymers, and copolymers containing vinyl alcohol units, and polysaccharides, such as cellulose, methylcellulose, hydroxymethylcellulose, and carboxymethylcellulose.

When the coating liquid contains a dispersable resin, the content thereof is usually 10 parts by weight or less, preferably 5 parts by weight or less based on 100 parts by weight of the liquid dispersion medium. Addition of a small amount of a dispersable resin can make the formation of an inorganic particle structural body easier and can impart a function of the dispersable resin.

The weight ratio of the inorganic particles to the dispersable resin, which is not limited, is preferably 50/50<(weight fraction of inorganic particles)/(weight fraction of dispersable resin)<99.9/0.1, more preferably 90/10<(weight fraction of inorganic particles)/(weight fraction of dispersable resin)<99.5/0.5, and even more preferably 95/5<(weight fraction of inorganic particles)/(weight fraction of dispersable resin)<99/1. The dispersable resin to be used here is not particularly limited with respect to the type of resin as far as it can be dispersed, and a wide variety of resins can be used. As to the existence form of a resin in a solution, a resin dispersable in the form of particles called suspension or emulsion in a medium is preferably used. Examples thereof include a fluororesin-based particle dispersion liquid, a silicone resin-based particle dispersion liquid, an ethylene-vinyl acetate copolymer resin-based particle dispersion liquid, and a polyvinylidene chloride resin-based particle dispersion liquid. Particularly, examples of the fluororesin-based particle dispersion liquid include DuPont-Mitsui Fluorochemicals PTFE dispersion 31-JR, 34-JR produced by Du Pont-Mitsui Fluorochemicals Co., Ltd. and FluonPTFE dispersion AD911L, AD912L, and AD938L produced by Asahi Glass Co., Ltd.

When the coating liquid contains an organic electrolyte, the content thereof is usually 10 parts by weight or less, preferably 1 part by weight or less based on 100 parts by weight of the liquid dispersion medium. Addition of a small amount of an organic electrolyte can make the formation of an inorganic particle structural body easier and can impart a function of the organic electrolyte. The organic electrolyte to be used here is not particularly limited if it is soluble in a liquid dispersion medium, and examples thereof include combinations of inorganic anions, such as BO₃³⁻, F⁻, PF₆⁻, BF₄⁻, AsF₆⁻, SbF₆⁻, ClO₄⁻, AlF₄⁻, AlCl₄⁻, TaF₆⁻, NbF₆⁻, SiF₆²⁻, CN⁻, and F(HF)ⁿ⁻, wherein n represents a number of from 1 to 4, with organic cations described below, combinations of organic anions with organic cations described below, and combinations of organic anions with inorganic cations, such as lithium ion, sodium ion, potassium ion, and hydrogen ion.

Organic quaternary ammonium cations are quaternary ammonium cations having hydrocarbon groups selected from the group consisting of alkyl groups (having 1 to 20 of carbon atoms), cycloalkyl groups (having 6 to 20 of carbon atoms), aryl groups (having 6 to 20 of carbon atoms), and aralkyl groups (having 7 to 20 of carbon atoms), and organic quaternary phosphonium cations are quaternary phosphonium cations having hydrocarbon groups like those described above. The aforementioned hydrocarbon groups may have a hydroxyl group, an amino group, a nitro group, a cyano group, a carboxyl group, an ether group, an aldehyde group, and so on.

Organic anions are anions containing hydrocarbon groups that may have a substituent, and examples thereof include anions selected from the group consisting of N(SO₂Rf)²⁻, C(SO₂Rf)³⁻, RfCOO⁻, and RfSO³⁻ (Rf represents a perfluoroalkyl group having 1 to 12 carbon atoms), and anions resulting from removal of active hydrogen atoms from organic acids, such as carboxylic acids, organic sulfonic acids, and organic phosphorus acids, or phenol.

A coagulant may be added, if necessary, when obtaining a coating liquid. By the addition of a coagulant, an inorganic particle structural body with controlled structure can be obtained.

Examples of such a coagulant include an acidic substance such as hydrochloric acid or its aqueous solution, an alkaline substance such as sodium hydroxide or its aqueous solution, isopropyl alcohol, and ionic liquids and so on.

The coating liquid can be applied by known methods such as gravure coating, reverse coating, brush roll coating, spray coating, kiss coating, die coating, dipping, and bar coating and so on.

By using such methods as ink jet printing, screen printing, flexographic printing, and gravure printing, arbitrary patterns can be given to an inorganic particle layer.

Although the number of times of applying a coating liquid and the amount of the coating liquid to be applied in one application are arbitrary, the amount to be applied in one application is preferably from 0.5 g/m² to 40 g/m² for applying in a uniform thickness.

In the method of removing the liquid dispersion medium from the applied coating liquid, that is, the method of drying the coating liquid, the pressure and the temperature to be used in the removal of an atmosphere may be chosen appropriately depending upon the inorganic particles, the substrate, and the liquid dispersion medium to be used. For example, when the liquid dispersion medium is water, the liquid dispersion medium can be removed at 25° C. to 60° C. under ordinary pressure.

In the above-described Methods 2 and 3, an inorganic particle structural body is formed by stacking a plate-shaped substrate or a substrate made from a solid material onto an inorganic particle layer formed beforehand. When the substrate component is in the form of particles, a method comprising application of a coating liquid containing the particles to an inorganic particle layer and drying it can be used as a stacking method, and when the substrate is plate-shaped, a method comprising lamination of the substrate onto the inorganic particle layer can be used.

In one embodiment of the present invention, two or more inorganic particle layers of the same composition may be formed, and inorganic particle layers differing in composition may be stacked together. Now, the difference in composition between the inorganic particle layers is described.

First, as to inorganic particles contained in a first inorganic particle layer, the kind and the proportion thereof are specified. For example, suppose that there is an inorganic particle layer including 60% by weight of silica having an average particle diameter of 70 nm, 20% by weight of silica having an average particle diameter of 5 nm, and 20% by weight of fluororesin having an average particle diameter of 10 nm as the first inorganic particle layer. In this case, two kinds of silica, i.e., the silica having an average particle diameter of 70 nm and the silica having an average particle diameter of 5 nm are contained as inorganic particles; as to the proportions thereof, the former is 75% by weight and the latter is 25% by weight. Examples of the inorganic particles differing in composition from the inorganic particles contained in the first inorganic particle layer include the following:

(i) inorganic particles failing to contain at least one of silica having an average particle diameter of 70 nm and silica having an average particle diameter of 5 nm,
(ii) mixed inorganic particles, a mixture of silica that is the same as the silica having an average particle diameter of 70 nm contained in the first inorganic particle layer and silica that is the same as the silica having an average particle diameter of 5 nm contained in the first inorganic particle layer, wherein the mixed proportion of the former is not 75% by weight and the mixed proportion of the latter is not 25% by weight,
(iii) mixed inorganic particles containing 75% by weight of inorganic particles having an average particle diameter of 70 nm and 25% by weight of inorganic particles having an average particle diameter of 5 nm, wherein at least one of them is not silica.

Examples of the method of stacking, to a first inorganic particle layer, a second inorganic particle layer composed of inorganic particles differing in composition from the inorganic particles contained in the first inorganic particle layer include the following methods:

Method 1: a method comprising applying a coating liquid containing inorganic particles and a liquid dispersion medium to the surface of the first inorganic particle layer and removing the liquid dispersion medium from the applied coating liquid,
Method 2: a method comprising stacking a plate-shaped material containing inorganic particles to the surface of an inorganic particle structural body.

Specifically, wet coating methods, such as a reverse coating method, a die coating method, a dip coating method, a gravure coating method, a flexographic coating method, an ink jet coating method, and a screen printing method, and dry coating methods, such as a sputtering method, a CVD method, a plasma CVD method, a plasma polymerization method, and a vacuum deposition method, are preferably used. These may be used singly or two or more of them may be used in combination.

According to the present invention, an inorganic particle composite body can be obtained in which interlayer adhesion force has been improved while the performance derived from each layer is exerted. Moreover, the inorganic particle composite body of the present invention can develop various properties depending upon the kind of inorganic particles or a substrate. In particular, when a single solid material constituting a substrate penetrates respective inorganic particle layers as illustrated in FIGS. 10, 12, 14, and 16, the interface between the substrate and the inorganic particle portion of each inorganic particle layer is a continuous phase, and this probably reduces the brittleness of a film or the ease of delamination between layers. When a substrate fills gaps of an inorganic particle structural body in a very high filling ratio as illustrated in FIG. 14 and FIG. 16, it becomes possible to form an inorganic particle composite body superior also in substance barrier property.

The inorganic particle composite body of the present invention is classified as follows according to the depth of penetration of the solid material of the plastically deformed substrate into the inorganic particle layer:

(1) an inorganic particle composite body in which the solid material of the plastically deformed substrate has not reached the surface of the inorganic particle layer located apart from the substrate and the surface of the inorganic particle layer is exposed completely,
(2) an inorganic particle composite body in which the solid material of the plastically deformed substrate has reached at the surface away from the substrate, in at least a part of the inorganic particle layer and at least a part of the surface of the inorganic particle layer has been covered with a solid material derived from the substrate, the solid material having penetrated through the inorganic particle layer and having oozed out to the surface.

In one preferred embodiment, the surface of the inorganic particle composite body of the present invention has hydrophilicity. Having hydrophilicity referred to herein means that the contact angle with water is 60° or less. By using particles and/or a substrate having hydrophilicity as a raw material of an inorganic particle structural body and applying hydrophilization treatment to an inorganic particle structural body or an inorganic particle composite body, it is possible to impart hydrophilicity to the inorganic particle composite body.

It is permitted to apply hydrophilization treatment to a part of the surface of an inorganic particle structural body and it is also permitted to apply hydrophilization treatment to the whole surface. The hydrophilization treatment in the present invention is not particularly limited if it is a treatment to improve the hydrophilicity of the surface of an inorganic particle structural body. Preferable examples include a method comprising coating the surface of an inorganic particle structural body with a hydrophilizing agent, and cleaning of the surface of a structural body with a solvent, or the like. Hydrophilic inorganic particles may be used as the hydrophilizing agent for coating the surface of an inorganic particle structural body. A hydrophilic inorganic particle is a particle that has a hydrophilic group and is high in affinity to water and examples thereof include calcium carbonate, titanium dioxide, talc, aluminum silicate, calcium silicate, alumina silica trihydrate, alumina, zirconia, ceria, silica, calcium sulfate, and glass microspheres.

The mechanism of coating the surface of an inorganic particle structural body with a hydrophilizing agent is not particularly limited; it is permitted to make the surface of the inorganic particle structural body adsorb the hydrophilizing agent physically and also permitted to react the surface of the inorganic particle structural body with the hydrophilizing agent (chemical adsorption). The method of coating the surface of an inorganic particle structural body with a hydrophilizing agent is not particularly limited, and wet coating methods, such as a reverse coating method, a die coating method, a dip coating method, a gravure coating method, a flexographic coating method, an ink jet coating method, and a screen printing method, and dry coating methods, such as a sputtering method, a CVD method, a plasma CVD method, a plasma polymerization method, and a vacuum deposition method, are preferably used. The thickness of the layer of a hydrophilizing agent to be provided, which is not particular limited, is preferably from 1 to about 50 nm; if the layer is excessively thick, it becomes difficult to develop surface hardness, whereas if it is thinner than 1 nm, hydrophilicity may not be developed enough. The thickness is more preferably from 2 to 30 nm, particularly preferably from 3 to about 10 nm.

The cleaning method, which is one option of the hydrophilization treatment of the present invention is not particularly limited; contact cleaning methods such as solvent cleaning treatment and adhesive roll dust removing treatment, and non-contact cleaning methods such as UV irradiation, corona treatment, plasma treatment, flame plasma treatment, and ultrasonic dust removing treatment, are preferably used. Two or more techniques may be used together as hydrophilization treatment.

In an embodiment where hydrophilization treatment is applied to an inorganic particle structural body, it is preferred to use an inorganic particle structural body, at least a part of the surface of which is constituted of an inorganic particle layer. This is because inorganic particle layers are easy to apply hydrophilization treatment thereto.

The hydrophilic inorganic particle composite body of the present invention is an object in a state that at least some of inorganic particles have been bonded together chemically and/or physically via a substrate.

In one preferred embodiment, the surface of the inorganic particle composite body of the present invention has hydrophobicity. Having hydrophobicity referred to herein means having a contact angle with water greater than 60°. By using particles and/or a substrate having hydrophobicity as a raw material of an inorganic particle structural body and applying hydrophobization treatment to an inorganic particle structural body or an inorganic particle composite body, it is possible to impart hydrophobicity to the inorganic particle composite body.

Although the contact angle with pure water of the surface of the hydrophobic inorganic particle composite body of the present invention is not particularly limited, it is preferred, from the viewpoint of water proofing property and antifouling property, to be 100° or more and the contact angle with oleic acid is preferably 70° or more.

Schematic diagrams of representative embodiments of a hydrophobized inorganic particle composite body are shown in FIG. 21 to FIG. 24, but the present invention is not limited to these. Embodiments resulting from combination of these representative embodiments can also be used.

The method of hydrophobizing the surface of an inorganic particle structural body is not particularly limited. Preferred are a method comprising stacking a layer containing a hydrophobizing agent onto the surface of an inorganic particle structural body and a method comprising reacting a hydrophobizing agent to the surface of an inorganic particle structural body.

As a method for stacking a layer containing a hydrophobizing agent, wet coating methods, such as a reverse coating method, a die coating method, a dip coating method, a gravure coating method, a flexographic coating method, an ink jet coating method, and a screen printing method, and dry coating methods, such as a sputtering method, a CVD method, a plasma CVD method, a plasma polymerization method, and a vacuum deposition method, are preferably used. The thickness of the hydrophobizing agent layer to be formed on the surface of an inorganic particle structural body, which is not particularly limited, is preferably from 1 to about 50 nm; if it is excessively large, surface hardness becomes difficult to develop, whereas if it is less than 1 nm, hydrophobicity is poor. The thickness is more preferably from 2 to 30 nm, particularly preferably from 3 to about 10 nm.

As such a hydrophobizing agent, compounds that contain a fluorine atom and that have low surface energy and low interfacial energy are preferred, examples of which compounds include silicone compounds having a fluorinated hydrocarbon group and polymers containing a fluorinated hydrocarbon group. A fluorine-containing surface-antifouling agent, OPTOOL DSX produced by Daikin Industries, Ltd., and so on can be obtained as commercially available products.

Examples of other preferred hydrophobizing agent can include fluorine-containing silicon compounds having two or more silicon atoms such as those disclosed in JP 2009-53591 A. In the case that an inorganic particle structural body is coated with this type of compound, the chemical adsorption to the inorganic particle structural body does not differ from the case that only one silicon atom is contained. Even if, however, the inorganic particle structural body forms almost no bond with silicon atoms, the silicon atoms bond together to form a long chain to adsorb physically to the structural body, so that a film that is relatively highly resistant to wiping can be formed. For this reason, fluorine-containing silicon compounds having two or more silicon atoms combined with reactive functional groups are suitable.

Specific examples of the fluorine-containing silicon compound having two or more silicon atoms attached to a reactive functional group include (CH₃O)₃SiCH₂CH₂CH₂OCH₂CF₂CF₂O(CF₂CF₂CF₂O)ₚCF₂CF₂CH₂OCH₂CH₂CH₂Si(OCH₃)₃, (CH₃O)₂CH₃SiCH₂CH₂CH₂OCH₂CF₂CF₂O(CF₂CF₂CF₂O)ₚCF₂CF₂CH₂OCH₂CH₂CH₂SiCH₃(OCH₃)₂, (CH₃O)₃SiCH₂CH₂CH₂OCH₂CF₂ (OC₂F₄)_{q}(OCF₂)ᵣOCF₂CH₂OCH₂CH₂CH₂Si(OCH₃)₃, (CH₃O)₂CH₃SiCH₂CH₂CH₂OCH₂CF₂ (OC₂F₄)_{q}(OCF₂)ᵣOCF₂CH₂OCH₂CH₂CH₂SiCH₃ (OCH₃)₂, (C2H5O)3SiCH2CH2CH2OCH2CF2(OC2F4)q(OCF2)rOCF2CH2OCH2CH2CH2Si(OC2H5)₃, (CH₃O)₃SiCH₂C(═CH₂) CH₂CH₂CH₂OCH₂CF₂CF₂O(CF₂CF₂CF₂O)ₚCF₂CF₂CH₂OCH₂CH₂CH₂ (CH₂═)CCH₂S1 (OCH₃)₃, (CH₃O)₃SiCH₂C(═CH₂) CH₂CH₂CH₂OCH₂CF₂ (OC₂F₄)_{q}(OCF₂)ᵣOCF₂CH₂OCH₂CH₂CH₂(CH₂═)CCH₂Si(OCH₃)₃, and (CH₃O)₂CH₃SiCH₂C(═CH₂) CH₂CH₂CH₂OCH₂CF₂(OC₂F₄)_{q}(OCF₂)ᵣOCF₂CH₂OCH₂CH₂CH₂(CH₂═)CCH₂SiCH₃(OCH₃)₂. It is noted that p is an integer of from 1 to 50, q is an integer of from 1 to 50, r is an integer of from 1 to 50, q+r is an integer of from 10 to 100, and the sequence of the repeating units in the formulae is random.

Besides the above, a method comprising forming a monomolecular film possessing a water-repellent function like those disclosed in JP 2008-273784 A, JP 2008-7365 A, and JP 2006-223957A, a method comprising forming a functional organic thin film like that disclosed in JP 2006-188487A, and a method comprising forming a fractal surface structure like those disclosed in WO2005/027611 and JP 8-323280 A and so on may be used as a method for hydrophobilizing at least a part of the surface of a structural body or a composite body.

There is no particular limitation on the shape of hydrophobic inorganic particle composite bodies to be produced by the method of the present invention and a shape according to a required function and an intended application is used. Examples thereof include a tabular shape such as film and sheet, a rod-like shape, a fibrous shape, a spherical shape, and a three-dimensional structure shape. In the case that the intended application is a flat-panel display, a flexible display, or the like, it is preferred that the shape of a hydrophobic inorganic particle composite body be a film-like shape. An inorganic particle structural body to be used preferably has an inorganic particle layer on its surface. In this case, the thickness of the inorganic particle layer, which is not particularly limited, is 100 μm or less, preferably 10 μm or less, more preferably 5 μm or less, and particularly preferably 1 μm or less. In the case that flexibility or the like is further required, the thickness of the inorganic particle layer is 5 μm or less, preferably 1 μm or less, more preferably 0.5 μm or less, and particularly preferably 0.2 μm or less. When the thickness of an inorganic particle layer is greater than 100 μm, the layer tends to become brittle, whereas when it is 0.01 μm or less, hardness tends to be difficult to develop.

According to the present invention, it is possible to obtain a hydrophobic inorganic particle composite body having reduced brittleness or reduced ease in peeling while retaining surface hardness derived from inorganic particles. Moreover, a hydrophobic inorganic particle composite body to be produced by the method of the present invention can develop various properties depending upon the kind of hydrophobization treatment, inorganic particles or a substrate. In particular, when a substrate also serves as a support as illustrated in FIGS. 21 through 24, the interface between the support and an inorganic particle portion is a continuous phase of the substrate, and this probably reduces brittleness or ease of delamination. When the solid material constituting a substrate fills gaps of an inorganic particle structural body in a very high filling ratio as illustrated in FIGS. 22 and 24, it becomes possible to form a hydrophobic inorganic particle composite body superior also in substance barrier property.

The hydrophobic inorganic particle composite body of the present invention is used for various applications by being secondarily processed into a form according to a required function. It is used for optical information media, such as a read only optical disk, an optical recording disk, and a magneto-optical recording disk, a front face plate of a flat-panel display, a window of a portable display (a cellular phone, a portable game device, etc.), a display screen of a personal computer, a flexible display, an electronic paper, a marking film, a poster, display media and optical members, such as lens of glasses, binoculars, telescopes, and microscopes, for the purpose of preventing a surface from scratching and from getting dirty with a fingerprint, or the like. For the purposes of prevention of surface scratching, fouling prevention by hydrophobization, and difficult attachment or easy detachment of snow or ice (prevention of snow/ice attachment), it is used for, for example, roofs of dome stadiums or sports stadiums, roofs of carports, awnings, walls of buildings, windows, traffic markings, acoustical insulation boards for roads or for buildings, building components such as roofs, agricultural components such as films for agricultural houses, films for tunnels, films for curtains, mulching films, sprinkling hoses, sprinkling materials, and seed and seedling boxes, components of instruments for transportation, such as skirt parts, exterior boards, and windows of trains and exterior boards, windows, bumpers, and mirrors of cars, household members, such as surfaces of mirrors, floorings, table tops, tablecloths, chairs, sofas, and home electronics, such as television, personal computers, washing machines, and refrigerators, electric members, such as electric wires, cables, antennas, steel towers for electric wires and cables, and lighting surfaces of solar cells.

When it has both hydrophobicity and antistatic property, it can be used also for antistatic members, such as antistatic films, wrapping films, films for removing electricity, containers for packaging electronic components, and containers for food packaging.

In one preferred embodiment, the surface of the inorganic particle composite body of the present invention has antireflecting property. That is, the inorganic particle composite body of the present invention can be an antireflective inorganic particle composite body. Schematic diagrams of representative embodiments of an antireflective inorganic particle composite body are shown in FIG. 25 to FIG. 28, but the present invention is not limited to these. Embodiments resulting from combination of these representative embodiments can also be used.

The surface of an antireflective inorganic particle composite body has antireflection property. The antireflection property as referred to herein means property to reduce the ratio of light reflected on a surface; the lower the ratio of light reflected on a surface, the more the external light to be reflected in the surface of a resin sheet to be used for applications such as a front face plate of a display can be reduced. In the present invention, having antireflection property means having a reflectance of 5% or less. By using particles and/or a substrate having antireflection property as a raw material of an inorganic particle structural body and applying antireflecting treatment to an inorganic particle structural body or an inorganic particle composite body, it is possible to impart antireflection property to the inorganic particle composite body.

In the present invention, it is preferred to use an inorganic particle structural body in which the surface of an inorganic particle layer, at least a part of the surface, is exposed. Such an inorganic particle structural body is easy to apply antireflecting treatment.

The method of stacking a layer containing an antireflecting agent on the surface of an inorganic particle structural body is not particularly limited. For example, there can be used a method comprising applying a coating liquid containing an antireflecting agent to the surface of an inorganic particle structural body, and then drying the coating liquid. To this method can be applied wet coating methods, such as a reverse coating method, a die coating method, a dip coating method, a gravure coating method, a flexographic coating method, an ink jet coating method, and a screen printing method. Vapor deposition methods, such as a sputtering method, a CVD method, a plasma CVD method, a plasma polymerization method, and a vacuum deposition method, are preferably used. These may be used singly or two or more of them may be used in combination.

A layer containing an antireflecting agent is designed in consideration of various factors, such as the wavelength of the light to be antireflected, the index of refraction of the inorganic particle composite body to be used, and the index of refraction of the atmosphere in which an antireflective inorganic particle composite body is used. The antireflective layer to be stacked may have either a single layer or multiple layers. In the case of a single layer, a composition that affords a low refractive index is used. In the case of multiple layers, the refractive index and the thickness of each layer are determined depending upon optical design. A multilayer is better in antireflecting property, whereas a single layer is better in cost.

In the case of preventing the reflection of a visible radiation by a single-layer antireflective layer, it is preferred to adjust the thickness of the antireflective layer to from 50 to 150 nm, more preferably from 80 to 130 nm.

As to an optical design method, “Characteristics and optimum design of antireflection film/film formation technology” (2001, Technical Information Institute Co., Ltd.), “Optical practical materials—with an eye to various application development—” (2006, Johokiko Co., Ltd.), and “Characteristics and optimum design of antireflection film/film formation technology” (2001, edited by Technical Information Institute Co., Ltd.) can be referred to.

Although the method disclosed in JP 2006-327187 A is described in detail below as one example of antireflecting treatment, the antireflecting treatment in the present invention is not limited thereto.

The mixed inorganic particle dispersion liquid to be used as an antireflecting agent is prepared using inorganic particle chains (A) each composed of three or more particles with a particle diameter of 10 to 60 nm connected in a chain form, inorganic particles (B) with an average particle diameter of 1 to 20 nm, and a liquid dispersion medium and satisfies the following formulae (1) and (2).

0.55≦RVa≦0.90 (1)

0.10≦RVb≦0.45 (2)

wherein RVa is the ratio of the volume of the inorganic particle chains (A) to the total volume of the inorganic particle chains (A) and the inorganic particles (B) in the dispersion liquid, and RVb is the ratio of the volume of the inorganic particles (B) to the total volume of the inorganic particle chains (A) and the inorganic particles (B) in the dispersion liquid.

The chemical composition of the inorganic particle chains (A) may be either the same as or different from the chemical composition of the inorganic particles (B). Examples of inorganic particles which are used as the inorganic particle chains (A) or the inorganic particles (B) include silicon oxide (i.e., silica), titanium oxide, aluminum oxide, zinc oxide, tin oxide, calcium carbonate, barium sulfate, talc, and kaolin and so on. The inorganic particle chains (A) and the inorganic particles (B) are preferably made of silica because particles thereof are high in dispersibility in a solvent, low in refractive index, and easy to obtain a powder being small in particle size distribution.

An inorganic particle chain (A) is a chain in which three or more inorganic particles with a particle diameter of 10 to 60 nm are connected in a chain form. As such inorganic particle chains can be used commercially available products, examples of which can include SNOWTEX (registered trademark) PS-S, PS-SO, PS-M, and PS-MO produced by Nissan Chemical Industries, Ltd., which are silica sols containing water as a dispersion medium, and IPA-ST-UP produced by Nissan Chemical Industries, Ltd., which is silica sol containing isopropanol as a dispersion medium. The particle diameter of the particles forming inorganic particle chains and the shape of the inorganic particle chain can be determined through observation using a transmission electron microscope. The expression “connected in a chain form” as used herein is an expression opposite to “connected in a circular form” and encompasses not only particles connected in a straight form but also particles connected in a bent form.

The average particle diameter of the inorganic particles (B) is from 1 to 20 nm.

The average particle diameter of the inorganic particles (B) is determined by the dynamic light scattering method or the Sears method. Measurement of the average particle diameter by the dynamic light scattering method can be performed by using a commercially available particle size distribution analyzer. The Sears method, which is disclosed in Analytical Chemistry, Vol. 28, p. 1981-1983, 1956, is an analytical method to be applied to the measurement of the average particle diameter of silica particles; it is a method in which the surface area of particles is determined from the amount of NaOH to be consumed for adjusting a colloidal silica dispersion liquid from pH=3 to pH=9 and then a sphere equivalent diameter is calculated from the determined surface area. A spherical equivalent diameter determined in the above way is defined an average particle diameter.

Typically, the mixed inorganic particle dispersion liquid can be prepared by, for example, any of the following methods [1] through [5], but the preparation is not limited to these methods.

[1] A method comprising adding a powder of inorganic particle chains (A) and a powder of inorganic particles (B) simultaneously to a common liquid dispersion medium and then dispersing them.
[2] A method comprising dispersing inorganic particle chains (A) in a first liquid dispersion medium to prepare a first dispersion liquid, separately dispersing inorganic particles (B) in a second liquid dispersion medium to prepare a second dispersion liquid, and then mixing the first and the second dispersion liquids.
[3] A method comprising dispersing inorganic particle chains (A) in a liquid dispersion medium to prepare a dispersion liquid, and then adding a powder of inorganic particles (B) to the dispersion liquid and then dispersing them.
[4] A method comprising dispersing inorganic particles (B) in a liquid dispersion medium to prepare a dispersion liquid, add then adding a powder of inorganic particle chains (A) to the dispersion liquid and then dispersing them.
[5] A method comprising performing grain growth in a dispersion medium to prepare a first dispersion liquid containing inorganic particle chains (A), separately performing grain growth in a dispersion medium to prepare a second dispersion liquid containing a second dispersion liquid, and then mixing the first and second dispersion liquids.

By applying strong dispersion means, such as ultrasonic dispersion and ultrahigh pressure dispersion, it is possible to disperse inorganic particles particularly uniformly in a mixed inorganic particle dispersion liquid. In order to achieve dispersion with higher uniformity, it is preferred that inorganic particles in the dispersion liquid of inorganic particle chains (A) and the dispersion liquid of inorganic particles (B) to be used for the preparation of a mixed inorganic particle dispersion liquid and in a mixed inorganic particle dispersion liquid to be obtained finally be in a colloidal state.

Water and a volatile organic solvent can be used as a dispersion medium.

In the aforementioned method [2], [3], [4], or [5], when the dispersion liquid of the inorganic particle chains (A), the dispersion liquid of the inorganic particles (B), or both the dispersion liquid of the inorganic particle chains (A) and the dispersion liquid of the inorganic particles (B) are colloidal alumina, it is preferred to add an anion, such as chlorine ion, sulfate ion, and acetate ion, as a counter anion, to the colloidal alumina in order to stabilize alumina particles to be positively charged. Although the colloidal alumina is not particularly limited with respect to pH, it preferably has a pH of 2 to 6 from the viewpoint of the stability of a dispersion liquid.

Moreover, also in the aforementioned method [1], when at least one of the inorganic particle chains (A) and the inorganic particles (B) is alumina and the mixed inorganic particle dispersion liquid is in a colloidal state, it is preferred to add an anion, such as chlorine ion, sulfate ion, and acetate ion, to the mixed inorganic particle dispersion liquid.

In the aforementioned method [2], [3], [4], or [5], when the dispersion liquid of the inorganic particle chains (A), the dispersion liquid of the inorganic particles (B), or both the dispersion liquid of the inorganic particle chains (A) and the dispersion liquid of the inorganic particles (B) are colloidal silica, it is preferred to add a cation, such as ammonium ion, alkali metal ion, and alkaline earth metal ion, as a counter cation, to the colloidal silica in order to stabilize silica particles to be negatively charged. Although the colloidal silica is not particularly limited with respect to pH, it preferably has a pH of 8 to 11 from the viewpoint of the stability of a dispersion liquid.

Moreover, also in the aforementioned method [1], when at least one of the inorganic particle chains (A) and the inorganic particles (B) is silica and the mixed inorganic particle dispersion liquid is in a colloidal state, it is preferred to add a cation, such as ammonium ion, alkali metal ion, and alkaline earth metal ion, to the mixed inorganic particle dispersion liquid.

The mixed inorganic particle dispersion liquid satisfies the following formulae (1) and (2):

0.55≦RVa≦0.90 (1)

0.10≦RVb≦0.45 (2)

wherein RVa is the ratio of the volume of the inorganic particle chains (A) to the total volume of the inorganic particle chains (A) and the inorganic particles (B) in the dispersion liquid, and RVb is the ratio of the volume of the inorganic particles (B) to the total volume of the inorganic particle chains (A) and the inorganic particles (B) in the dispersion liquid. In other words, RVa and RVb in the above formulae are equivalent to the volume fraction of the inorganic particle chains (A) and the volume fraction of the inorganic particles (B), respectively. If the inorganic particle chains (A) and the inorganic particles (B) are of the same chemical species, the volume fractions (RVa and RVb) of the inorganic particle chains (A) and the inorganic particles (B) are generally equal to the weight fractions of the inorganic particle chains (A) and the inorganic particles (B). Although the amount of the inorganic particle chains (A) and the inorganic particles (B) contained in the mixed inorganic particle dispersion liquid is not particularly limited, it is preferably from 1 to 20% by weight and more preferably from 3 to 10% by weight from the viewpoint of application property and dispersibility.

Additives, such as a surfactant and an organic electrolyte, may be added to the mixed inorganic particle dispersion liquid for the purpose of stabilization of the dispersion of inorganic particles, and so on.

When the mixed inorganic particle dispersion liquid contains a surfactant, the content thereof is usually 0.1 parts by weight or less based on 100 parts by weight of the dispersion medium. The surfactant to be used is not particularly limited and examples thereof include anionic surfactants, cationic surfactants, nonionic surfactants, and ampholytic surfactants. The compounds provided previously as examples can be used as the surfactant.

When the mixed inorganic particle dispersion liquid contains an organic electrolyte, the content thereof is usually 0.01 parts by weight or less based on 100 parts by weight of the liquid dispersion medium. The compounds provided previously as examples can be used as the organic electrolyte.

An inorganic particle layer is formed on an inorganic particle composite body by applying a mixed inorganic particle dispersion liquid prepared using the inorganic particle chains (A) and inorganic particles (B) onto the inorganic particle composite body, and subsequently removing the liquid dispersion medium by suitable means from the applied mixed inorganic particle dispersion liquid. An antireflective inorganic particle composite body is thereby formed because that inorganic particle layer has an antireflecting property. The thickness of the inorganic particle layer with such an antireflecting property is not particularly limited. In the production of an antireflective inorganic particle composite body suitable for use as a surface layer of a display in order to effectively prevent the reflection of extraneous light inside the display, the thickness of the inorganic particle layer in the antireflective inorganic particle composite body is adjusted preferably to 50 to 150 nm and more preferably to 80 to 130 nm. The thickness of the inorganic particle layer can be adjusted by changing the amounts of the inorganic particle chains (A) and the inorganic particles (B) in the mixed inorganic particle dispersion liquid and the applied amount of the mixed inorganic particle dispersion liquid.

The method of applying the mixed inorganic particle dispersion liquid to the surface of the inorganic particle structural body is not particularly limited, and the liquid can be applied by a wet coating method, such as gravure coating, reverse coating, brush roll coating, spray coating, kiss coating, die coating, dipping, and bar coating.

It is preferred to apply pretreatment, such as corona treatment, ozonization, plasma treatment, flame treatment, electron beam treatment, anchor coat treatment, and rinsing, to the surface of the inorganic particle structural body prior to the application of the mixed inorganic particle dispersion liquid to the inorganic particle structural body.

By removing the liquid dispersion medium from the mixed inorganic particle dispersion liquid applied to the inorganic particle structural body, an inorganic particle layer is formed on the inorganic particle structural body. The removal of the liquid dispersion medium can be executed, for example, by heating performed under normal pressure or reduced pressure. The pressure and the heating temperature to be used in the removal of the liquid dispersion medium may be chosen appropriately according to the materials to be used (that is, the inorganic particle chains (A), the inorganic particles (B), and the liquid dispersion medium). For example, when the dispersion medium is water, drying may be done at 50 to 80° C., preferably at about 60° C.

By using the method of JP 2006-327187 A, it is possible to form an inorganic particle layer having an antireflection function and being superior in hardness on an inorganic particle composite body without performing treatment at high temperature higher than 200° C. This probably is because the formed inorganic particle layer has a structure in which the inorganic particles (B) are located in the gaps of the inorganic particle chains (A) and the inorganic particle chains (A) are bound via the inorganic particles (B).

To an antireflective inorganic particle composite body to be produced by the method of the present invention may be applied antifouling treatment, antistatic treatment, etc., if necessary. Antifouling treatment is treatment for preventing fingerprint attachment or the like or making it easy to wipe away fingerprint soil and it can be done by coating the surface of an antireflective inorganic particle composite body with a hydrophobizing agent or the like or reacting a hydrophobizing agent to the surface of the composite body. By doing antistatic treatment, it is possible to prevent dusts from attaching for securing visibility and to prevent optical elements from being broken by discharge caused by electrification. Addition and lamination of the aforementioned surfactant or a conducting material is often done as antistatic treatment.

In one preferred embodiment, a glass layer is stacked on the surface of an inorganic particle structural body.

In the present invention, it is preferred to use an inorganic particle structural body in which the surface of an inorganic particle layer, at least a part of the surface, is exposed. Such an inorganic particle structural body is easy to stack with a glass layer.

Although the method of stacking an inorganic particle composite body with glass is not particularly limited, a method comprising bonding an inorganic particle composite body to a glass sheet via an adhesive, a method comprising coating an inorganic particle structural body with a glass precursor and then converting the glass precursor into glass, and a method comprising extrusion-laminating molten glass to an inorganic particle composite body are preferred as described below.

Examples of the method comprising bonding an inorganic particle composite body to a glass via an adhesive include a method comprising applying an adhesive to a surface of the inorganic particle structural body, and then curing the adhesive with the applied portion stacked on a glass sheet, a method comprising applying an adhesive to a glass sheet, and then curing the adhesive with the applied portion stacked on the surface of an inorganic particle structural body, and a method comprising applying an adhesive to both a glass sheet and an inorganic particle structural body, and then curing the adhesive with the applied portions kept in contact with each other. The kind of the adhesive is not particularly limited. Ceramics, water glass, rubber-based adhesives, epoxy type adhesives, acrylic adhesives, urethane type adhesives, and the like can be used. Use of a water-soluble adhesive is preferred in ease to handle. Examples of the water-soluble adhesive include glue, starch, polyvinyl alcohol, polyvinylpyrrolidone, polyacrylamide, and acrylamide-diacetone acrylamide copolymers. Moreover, the adhesive can contain additives such as a tackifier, a plasticizer, a filler, an antioxidant, a stabilizer, a pigment, diffusion particles, a curing agent, and a solvent. The thickness of the adhesive layer, which is not particularly limited, is preferably 100 nm or less.

The composition, the production method and so on of glass that can be used are not particularly limited. Soda glass, crystal glass, borosilicate glass, quartz glass, aluminosilicate glass, borate glass, phosphate glass, alkali-free glass, composite glass with ceramics, and the like can be used.

The method comprising coating an inorganic particle structural body with a glass precursor and then converting the glass precursor into glass is not particularly limited. Examples thereof include heating by an oven or the like and local heating of the glass precursor by electromagnetic wave radiation or the like.

Silane compounds, metal alkoxides, water glass, glass paste, and so on can be used as the glass precursor. Example of the silane compounds include tetramethoxysilane, tetraethoxysilane, methyltrimetoxysilane, phenyltrimethoxysilane, vinyltrimethoxysilane, 3-glycidoxypropyltrimetoxysilane, p-styryltrimethoxysilane, 3-(meth)acryloxypropyltrimethoxysilane, 3-aminopropyltrimethoxysilane, 3-ureidopropyltriethoxysilane, 3-chloropropyltrimethoxysilane, 3-mercaptopropyltrimethoxysilane, and 3-isocyanatopropyltriethoxysilane. Examples of the metal alkoxides include alkoxides of titanium (e.g., tetraisopropoxytitanium), alkoxides of zirconium (e.g., tetra-n-butoxyzirconium), alkoxides of aluminum (e.g., tri-sec-butoxyaluminum), and condensates thereof. Such a condensate may be either a condensate of a single kind of compound or a complex condensate of two or more compounds. Silane compounds and metal alkoxides may be used in the form of a solution.

The method of coating an inorganic particle composite body with a glass precursor is not particularly limited. Wet coating methods, such as a reverse coating method, a die coating method, a dip coating method, a gravure coating method, a flexographic coating method, an ink jet coating method, and a screen printing method, are preferably used.

The method of extrusion-laminating molten glass to an inorganic particle composite body is not particularly limited.

When inorganic particles constituting an inorganic particle layer are hydrophilic, since the inorganic particle composite body has a portion with superior hydrophilicity, it has antifouling performance (self-cleaning performance), by which dirt can be removed by water, and performance of difficult attachment or easy detachment of snow or ice (prevention of snow/ice attachment) in addition to performance to prevent surface scratching, and therefore it is suited as building components such as a roof of a dome stadium, a roof of a stadium, a roof of a carport, roofs of other types of buildings, an awning, a wall of a building, a window, a traffic display, and acoustical insulation boards for roads or buildings, agricultural components such as a film for agricultural houses, a film for tunnels, a film for curtains, a mulch film, a sprinkling hose, sprinkling materials, and a seed and seedling box, components of instruments for transportation, such as skirt parts, exterior boards, and windows of trains and exterior boards, windows, bumpers, and mirrors of cars, furniture members, such as mirrors, floorings, table tops, chairs, and sofas, and household appliances, such as television, personal computers, washing machines, and refrigerators, electric members, such as electric wires, cables, antennas, steel towers for electric wires and cables, and lighting surfaces of solar cells. Moreover, taking advantage of antistatic property which a hydrophilic particles film easily exerts, it is suitable also as antistatic members, such as an antistatic film, a film for packaging, a film for removing electricity, a material for packaging electronic components, and a material for food packaging.

Examples of hydrophilic inorganic particles include particles of metal oxides. Inorganic particles to which hydrophilization treatment has been applied can also be used.

While the inorganic particle composite body of the present invention is not particularly limited with respect to its rate of gaps, the rate of gaps is preferably 90% by volume or less, more preferably 50% by volume or less, even more preferably 30% by volume or less, particularly preferably 10% by volume or less, and most preferably 5% by volume or less or 1% by volume or less. When the rate of gaps is higher than 90% by volume, strength as an inorganic particle composite body tends to be short. An inorganic particle composite body increases in strength as it decreases in the rate of gaps, and ideally, it preferably has no gaps. When the shape of the inorganic particles of the inorganic particle composite body of the present invention is spherical, the rate of gaps is preferably 30% by volume or less, more preferably 10% by volume or less, even more preferably 5% by volume or less, and particularly preferably 1% by volume or less. When the shape of the inorganic particles of the inorganic particle composite body of the present invention is layer-form, the rate of gaps is preferably 50% by volume or less, more preferably 30% by volume or less, even more preferably 10% by volume or less, particularly preferably 5% by volume or less, and most preferably 1% by volume or less.

In place of the rate of gaps, a volume fraction of a part in which gaps have been filled with a substrate, calculated when the volume of a region where there are inorganic particles is defined as 100, is represented by V (%), which is used as a measure of the rate of gaps. The larger the V, the less the gaps in an inorganic particle layer, whereas the smaller the V, the more the gaps.

The range of V is 0<V<100, preferably 1<V<99, more preferably 10<V<95, and particularly preferably 50<V<90.

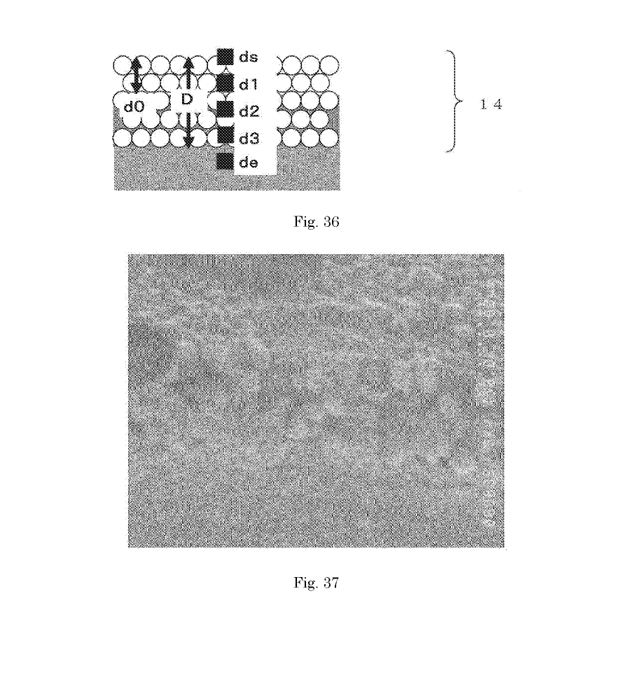

Although there is no limitation on the method of determining V, V can be calculated by the following method when an inorganic particle structural body composed of a plate-shaped substrate with plasticity and an inorganic particle layer stacked together has been hybridized to form an inorganic particle composite body like that illustrated in FIG. 36.

While a region 14 (having a thickness D) of an inorganic particle composite body, in which inorganic particles are present, is etched gradually from a surface ds in which inorganic particles are present to a part de at which there is only a substrate, the amount A (d) of element A derived from the inorganic particles and the amount B (d) of element B derived from the substrate are measured at several points (for example, five points separated in the depth direction, ds, d1, d2, d3, and de) using XPS (X-ray probe spectroscopy). Taking d1, d2, and d3 on an abscissa and B(d)/A(d) on an ordinate, the depth d0 at which B(d)/A(d) becomes zero is determined by extrapolation. V can be expressed by Formula (1) using d0 and D.

V=100×(D−d0)/D Formula (1)

The inorganic particle composite body of the present invention, which is an object in a state that at least some of inorganic particles have been bonded together chemically and/or physically via a substrate, can be obtained by irradiating an inorganic particle structural body with an electromagnetic wave to plastically deform a substrate contained in the inorganic particle structural body and filling therewith at least some of the gaps in the inorganic particle structural body.

The inorganic particle composite body of the present invention, which is an object in a state that at least some of inorganic particles have been bonded together chemically and/or physically via a substrate, can be obtained by plastically deforming a substrate contained in an inorganic particle structural body and filling therewith at least some of the gaps in the inorganic particle structural body.

There is no limitation on means for plastically deforming a solid material constituting a substrate. Examples thereof include a method of pressurizing an inorganic particle structural body and a method of heating an inorganic particle structural body; these may be used together. Examples thereof include a method that comprises heating an inorganic particle structural body to plastically deform a substrate and then pressurizing the substrate to further plastically deform, a method that comprises pressurizing an inorganic particle structural body to plastically deform a substrate and then heating the substrate to further plastically deform, and a method that comprises performing heating and pressurizing simultaneously to plastically deform a substrate in an inorganic particle structural body. As a method of plastically deforming a substrate, a method of at least pressurizing an inorganic particle structural body is preferred. Examples of the pressurizing method include a pressing method comprising pressurizing an inorganic particle structural body while sandwiching it between plates, a roll pressing method comprising continuously pressurizing an inorganic particle structural body while nipping it between rolls, and a method comprising applying a static pressure while placing an inorganic particle structural body in a liquid.

The pressure to be applied is not limited as far as it is higher than the atmospheric pressure, and it depends on the degree of the plasticity of the substrate. That is, a low pressure can be used when softening progresses and a large permanent strain is produced by a low stress, whereas a high pressure is needed when a high stress is needed. The pressure is for example 0.1 kgf/cm² or more, preferably 1 kgf/cm² or more, more preferably 10 kgf/cm² or more, and particularly preferably 100 kgf/cm² or more. The number of times of pressurization is arbitrary and pressurizing operations under two or more conditions may be combined.

There is no limitation also on a pressurizing condition and it is determined according to the property of a substrate. That is, it is preferred to take conditions of pressurizing time, pressurizing temperature, pressure and means of pressurization under and by which inorganic particles substantially fail to plastically deform and a substrate plastically deforms and can fill gaps of an inorganic particle structural body.

Examples of the method of heating an inorganic particle structural body to plastically deform a substrate include a method comprising heating the whole of the inorganic particle structural body, and a method comprising locally heating the substrate in the inorganic particle structural body. Examples of the method of heating the whole include a method comprising feeding an inorganic particle structural body into a heating atmosphere using an oven, a heater, or the like, a method comprising bringing an inorganic particle structural body into contact with a heat medium, such as a heated metal plate, a method comprising bringing an inorganic particle structural body into contact with a hot roll and then pressurizing it, and a method comprising bringing it into contact with a hot roll, and examples of the method of locally heating a substrate include a method comprising heating it by irradiation with an electromagnetic wave, such as an infrared radiation, a laser, a microwave, irradiation in a high quantity of light in a very short time (the flash-annealing method), and radiation, such as electron beam, and a method comprising keeping only an arbitrary portion of an inorganic particle structural body into contact with a heat medium and simultaneously cooling other portion. When the substrate is metal, induction heating using a magnetic force line and the aforementioned irradiation with an electromagnetic wave are preferably used.

The temperature of heating an inorganic particle structural body is not particularly limited because it varies depending upon the property of a substrate, and conditions suitable for the substrate to be filled into gap portions are used. When the substrate is film-shaped polypropylene, the heating temperature is preferably 120° C. or higher, more preferably 140° C. or higher. When the substrate is film-shaped polymethyl methacrylate, the heating temperature is preferably 80° C. or higher, more preferably 100° C. or higher.

In order to plastically deform a substrate more easily, auxiliary means may be added. The auxiliary means referred to herein means a method of increasing the plasticity of the substrate having plasticity. Examples of the method of increasing the plasticity of a substrate having plasticity include a method comprising softening the substrate using a chemical substance and a method comprising increasing the affinity or the slipping property at the interface of a substrate and a gap. Particularly, a method comprising adding heat to soften a substrate is preferably used.

Examples of the method of adding heat to soften a substrate include a method comprising heating the whole of the inorganic particle structural body, and a method comprising locally heating the substrate in the inorganic particle structural body. Examples of the method of heating the whole include a method comprising feeding an inorganic particle structural body into a heating atmosphere using an oven, a heater, or the like, a method comprising bringing an inorganic particle structural body into contact with a heat medium, such as a heated metal plate, a method comprising bringing an inorganic particle structural body into contact with a hot roll and then pressurizing it, and a method comprising bringing it into contact with a hot roll, and examples of the method of locally heating a substrate include a method comprising heating it by irradiation with an electromagnetic wave, such as an infrared radiation, a laser, a microwave, irradiation in a high quantity of light in a very short time, e.g. a flash lamp, and radiation, such as electron rays, and a method comprising keeping only an arbitrary portion of an inorganic particle structural body into contact with a heat medium and simultaneously cooling other portion. When the substrate is metal, induction heating using a magnetic force line and the aforementioned irradiation with an electromagnetic wave are preferably used.

A substrate contained in an inorganic particle structural body can be plastically deformed by irradiating the inorganic particle structural body with an electromagnetic wave. An electromagnetic wave is preferred as means for plastically deforming a substrate because it can be applied selectively to a substrate in an inorganic particle structural body. By applying an electromagnetic wave to an inorganic particle structural body, it is possible to plastically deform a substrate selectively and fill it into at least some of the gaps contained in the inorganic particle structural body without softening or melting inorganic particles contained in the inorganic particle structural body.

The electromagnetic wave is preferably at least one selected from the group consisting of proton beam, electron beam, neutron beam, gamma rays, X-rays, ultraviolet rays, visible rays, infrared rays, microwaves, low frequency waves, high frequency waves, and laser beams thereof. When the substrate is metal, it is preferred to choose any of electron beam, gamma rays, X-rays, visible rays, infrared rays, microwaves and their laser beams.

The optimal values of application conditions, such as the wavelength, output, and application time of an electromagnetic wave, to be used when an electromagnetic wave is applied to an inorganic particle structural body vary depending upon the electromagnetic wave absorbing characteristics of the inorganic particle structural body, the inorganic particles, and the substrate. By applying an electromagnetic wave within a wavelength range in which inorganic particles have small absorption and a substrate has large absorption, it is possible to plastically deform the substrate efficiently without damaging inorganic particles, an inorganic particle structural body, or an inorganic particle composite body.

In addition to electromagnetic wave irradiation, an auxiliary method may be used in order to make plastic deformation of the substrate easier. Examples of such an auxiliary method include a method comprising adding heat to soften a substrate, a method comprising applying a chemical to soften a substrate, and a method comprising increasing the affinity or slipping property between a substrate and a gap interface; among these the method comprising adding heat to soften a substrate is preferably used. Examples of the method of heating the whole to soften a substrate include a method comprising feeding an inorganic particle structural body into a heating atmosphere using an oven, a heater, or the like and a method comprising bringing an inorganic particle structural body into contact with a heat medium, such as a heated metal plate or roll.

There is no particular limitation on the shape of the inorganic particle composite body of the present invention and a shape according to a required function and an intended application is used. Examples thereof include a tabular shape such as film and sheet, a rod-like shape, a fibrous shape, a spherical shape, and a three-dimensional structure shape. In the case that the intended application is a flat-panel display, a flexible display, or the like, it is preferred that the shape of the inorganic particle composite body of the present invention also be a film-like shape. In this case, the thickness of the inorganic particle composite body, which is not particularly limited, is 100 μm or less, preferably 10 μm or less, more preferably 5 μm or less, and particularly preferably 1 μm or less. In the case that flexibility or the like is further required, the thickness of the inorganic particle composite body is 5 μm or less, preferably 1 μm or less, more preferably 0.5 μm or less, and particularly preferably 0.2 μm or less. When the thickness of an inorganic particle composite body is greater than 100 μm, the composite body tends to become brittle, whereas when it is 0.01 μm or less, hardness tends to be difficult to develop.

It is also permitted to use by further stacking a resin layer or a metal thin film on the inorganic particle composite body of the present invention.

The inorganic particle composite body of the present invention can develop various properties depending upon the kind of inorganic particles or a substrate. In particular, when a substrate also serves as a support as illustrated in FIG. 2 and FIG. 4, the interface between the support and an inorganic particle portion is a continuous layer, and this probably reduces brittleness or ease of delamination. When a substrate fills gaps of an inorganic particle structural body in a very high filling ratio as illustrated in FIG. 2 and FIG. 4, it becomes possible to form an inorganic particle composite body superior in substance barrier property.

### EXAMPLES

The present invention will be described in detail below with reference to Examples, to which the present invention is not limited. Main materials used are as follows.

### [Inorganic Particle]

SNOWTEX (registered trademark) ST-XS (colloidal silica produced by Nissan Chemical Industries, Ltd.; average particle diameter: 4 to 6 nm; solid concentration: 20% by weight), which is hereinafter referred to as “ST-XS.”

SNOWTEX (registered trademark) ST-ZL (colloidal silica produced by Nissan Chemical Industries, Ltd.; average particle diameter: 78 nm; solid concentration: 40% by weight), which is hereinafter referred to as “ST-ZL.”

SNOWTEX (registered trademark) PS-M (chain-like colloidal silica produced by Nissan Chemical Industries, Ltd.; particle diameter of spherical particles: 18 to 25 nm; average particle diameter determined by a dynamic light scattering method: 111 nm; solid concentration: 20% by weight), which is hereinafter referred to as “PS-M.”

SNOWTEX (registered trademark) PS-S (chain-like colloidal silica produced by Nissan Chemical Industries, Ltd.; particle diameter of spherical particles: 10 to 18 nm; average particle diameter determined by a dynamic light scattering method: 106 nm; solid concentration: 20% by weight), which is hereinafter referred to as “PS-S.”

### [Coating Liquid A]

A coating liquid prepared by mixing and stirring ST-XS (200 g), ST-ZL (400 g), pure water (100 g), and isopropyl alcohol (300 g).

### [Coating Liquid B]

A coating liquid prepared by mixing and stirring ST-XS (200 g), ST-ZL (400 g), and pure water (400 g).

### [Coating Liquid C]

A coating liquid prepared by mixing and stirring ST-XS (200 g), ST-ZL (400 g), pure water (300 g), and isopropyl alcohol (100 g).

### [Coating Liquid D]

A coating liquid prepared by mixing and stirring ST-XS (200 g), ST-ZL (400 g), pure water (394 g), and glycerol (6 g).

### [Coating Liquid E]

A coating liquid prepared by mixing and stirring ST-XS (200 g), ST-ZL (400 g), pure water (380 g), and glycerol (20 g).

### [Coating Liquid F]

A coating liquid prepared by mixing and stirring ST-XS (200 g), ST-ZL (400 g), pure water (360 g), and glycerol (40 g).

### [Coating Liquid G]

A coating liquid prepared by mixing and stirring ST-XS (100 g), ST-ZL (200 g), and pure water (700 g).

### [Coating Liquid H] (Hydrophilic)

A coating liquid prepared by mixing and stirring ST-XS (30 g), ST-ZL (15 g), and pure water (5 g).

### [Coating Liquid I]

A coating liquid prepared by mixing and stirring pure water (15 g) and glycerol (5.0 g).

### [Coating Liquid J]

A coating liquid prepared by mixing and stirring an antifouling coating (OPTOOLDSX; produced by Daikin Industries, Ltd.) (1.5 g), and fluorine oil (DEMNUM (registered trademark) SOLVENT; produced by Daikin Industries, Ltd.) (598.5 g).

### [Coating Liquid K]

A coating liquid prepared by mixing and stirring ST-XS (300 g), ST-ZL (600 g), PTFE30-J (25 g), and pure water (575 g).

### [Coating Liquid L]

A coating liquid prepared by mixing and stirring OPTOOL DSX (1.0 g) and DEMNUM SOLVENT (199.0 g).

### [Coating Liquid M]

A coating liquid prepared by mixing and stirring ST-XS (54 g), ST-ZL (12.5 g), PS-M (67.5 g), PS-S (10 g), and pure water (356 g)

### [Plate-Shaped Substrate A]

A film made of a polypropylene homopolymer (melting point: 160° C., thickness: about 100 μm).

### [Plate-Shaped Substrate B]

SUMIPEX E000 (registered trademark) (polymethyl methacrylate sheet produced by Sumitomo Chemical Co., Ltd.; 1 mm in thickness).

### [Plate-Shaped Substrate C]

TECHNOLLOY (trademark registration) S001G (polymethyl methacrylate produced by Sumitomo Chemical Co., Ltd.; 125 μm in thickness)

### [Plate-Shaped Substrate D]

EMBLET (registered trademark) (PET film produced by Unitika, Ltd.).

### [Adhesive]

2-wt % aqueous solution of polyvinyl alcohol (degree of saponification: 99.6%, degree of polymerization: 1700).

The methods of evaluating properties are as follows.

### [Degree of Scratch Resistance]

Using steel wool (#0000, produced by Nippon Steel Wool Co., Ltd.), the surface of an inorganic particle composite body was rubbed ten strokes under a load of 125 to 500 gf/cm² and then the presence of scratches was checked visually. The case that there were 10 or less scratches was judged as Level 1, the case that there were more than 10 but not more than 20 scratches was judged as Level 2, and the case that there were more than 20 scratches was judged as Level 3.

### [Pencil Hardness Evaluation]

Evaluation was carried out under a load of 500 gf in accordance with JIS K5400.

### [Cross-Cutting Evaluation]

Cross-cutting evaluation was performed as a method of evaluating the adhesion between inorganic particles and a substrate. Evaluation followed JIS K5600-5-6. A smaller number of a class means that the adhesion between inorganic particles and a substrate is better.

### [Surface Resistivity Evaluation]

A surface resistivity was measured under an applied voltage of 1000 V using a super insulation meter SM-8220 manufactured by Hioki E.E. Corp.

### [Coefficient of Friction]

A coefficient of friction was measured in accordance with JIS K7125.

### [Reflectance]

An aluminum relative specular reflection intensity at an incident angle of 5 deg in the visible range was measured by using a spectrophotometer UV-3150 manufactured by Shimadzu Corporation. In the measurement, a black tape was stuck on the rear surface of a film.

### [Evaluation of Adhesion]

In order to evaluate the adhesion between glass and a substrate and the adhesion between glass and an inorganic particle composite body, a 180-degrees peel test was carried out by using an Autograph (manufactured by Shimadzu Corporation). A 1.5 cm wide sample was peeled in a length of 200 mm at a tensile speed of 300 mm/min, and then a peak value of test force was measured.

### [Electron Microscopic Observation]

After cutting a sample with a microtome, osmium coating was applied thereto and observation using a field emission scanning electron microscope (FE-SEM) (model: S-800; manufactured by Hitachi, Ltd.) was performed for Examples 1 to 39 and Comparative Examples 1 to 25.

### [Oxygen Permeability]

Oxygen permeability was measured by using an oxygen permeability analyzer OX-TRAN manufactured by MOCON (measurement conditions: 23° C., 0% RH).

### Example 1

Coating liquid A was applied to substrate A by using a MicroGravure roll (manufactured by Yasui Seiki Co., Ltd., 230 meshes) and then was dried at 50° C., so that inorganic particle structural body (1) was obtained. Coating liquid B was applied to the inorganic particle structural body (1) by using a MicroGravure roll (manufactured by Yasui Seiki Co., Ltd., 230 meshes) and then was dried at 50° C., so that inorganic particle structural body (2) was obtained. According to the cross-section observation of the inorganic particle structural body, the thickness of the layer made up of a composition containing inorganic particles was about 0.8 μm. The inorganic particle structural body (2) obtained above was pressed by using a compression molding machine (manufactured by SHINTO Metal Industries Corporation) under a certain condition, i.e., primary compression: at 140° C., 70 kgf/cm², for 5 minutes, secondary compression: at 30° C., 70 kgf/cm² for 5 minutes, so that inorganic particle composite body (1) was obtained. The inorganic particle composite body (1) had a pencil hardness of 2B and a degree of scratch resistance under a 125 g load of Level 2.

### Examples 2 to 4

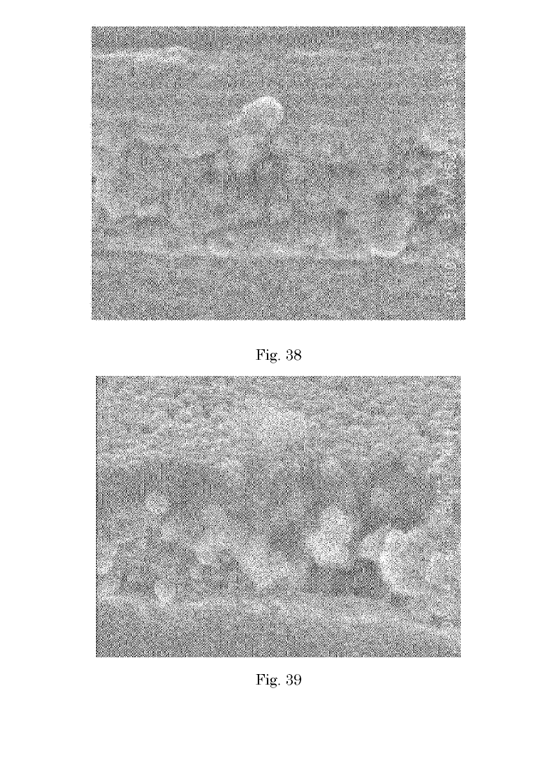

The inorganic particle structural body (2) obtained in Example 1 was pressed in the same manner as in Example 1 except for varying only temperature under the conditions given in Table 1, so that inorganic particle composite bodies (2) to (4) were obtained. The results were better in comparison to Comparative Examples 1 to 8 with respect to pencil hardness as shown in Table 1. A SEM observation photograph of the inorganic particle composite body of Example 2 is shown in FIG. 37 and a SEM observation photograph of the inorganic particle composite body of Example 4 is shown in FIG. 38.

### Comparative Example 1

Coating liquid A was applied to substrate A by using a MicroGravure roll (manufactured by Yasui Seiki Co., Ltd., 230 meshes) and then was dried at 50° C., so that inorganic particle structural body (1) was obtained. Coating liquid B was applied to the inorganic particle structural body (1) by using a MicroGravure roll (manufactured by Yasui Seiki Co., Ltd., 230 meshes) and then was dried at 50° C., so that inorganic particle structural body (2) was obtained. According to the cross-section observation of the inorganic particle structural body, the thickness of the layer made up of a composition containing inorganic particles was about 0.8 μm. The inorganic particle structural body (2) had a pencil hardness of 6B or lower and a degree of scratch resistance under a 125 g load of Level 3. A SEM observation photograph of the inorganic particle structural body of Comparative Example 1 is shown in FIG. 39.

### Comparative Example 2

The substrate A had a pencil hardness of 6B or lower and a degree of scratch resistance under a 125 g load of Level 3.

### Comparative Example 3

Using a compression molding machine, substrate A was preheated at 120° C. for 5 minutes and then was pressed under a certain condition, i.e., primary compression: at 120° C., 70 kgf/cm², for 5 minutes, secondary compression: at 30° C., 70 kgf/cm² for 5 minutes, so that compressed film (1) was obtained. The compressed film (1) had a pencil hardness of 5B and a degree of scratch resistance under a 125 g load of Level 3.

### Comparative Examples 4 to 8

Substrate A was pressed in the same manner as in Comparative Example 1 except for varying only temperature under the conditions given in Table 1, so that compressed films (2) to (6) were obtained. The results were shown in Table 1.

TABLE 1

| | | | Degree of |
|---|---|---|---|
| | | | scratch |
| | Pressing | Pencil | resistance |
| | temperature | hardness | (125 g load) |
| Example 1 | 140° C. | 2B | Level 2 |
| Example 2 | 150° C. | B | Level 2 |
| Example 3 | 155° C. | B | Level 1 |
| Example 4 | 160° C. | B | Level 2 |
| Comparable | No pressing | 6B or less | Level 3 |
| Example1 | | | |
| Comparative | No pressing | 6B or less | Level 3 |
| Example 2 | | | |
| Comparative | 120° C. | 5B | Level 3 |
| Example 3 | | | |
| Comparative | 130° C. | 5B | Level 3 |
| Example 4 | | | |
| Comparative | 140° C. | 5B | Level 3 |
| Example 5 | | | |
| Comparative | 150° C. | 5B | Level 3 |
| Example 6 | | | |
| Comparative | 155° C. | 5B | Level 3 |
| Example 7 | | | |
| Comparative | 160° C. | 4B | Level 3 |
| Example8 | | | |

### Example 5

Coating liquid A was applied to substrate A by using a MicroGravure roll (manufactured by Yasui Seiki Co., Ltd., 230 meshes) and then was dried at 50° C., so that inorganic particle structural body (1) was obtained. Coating liquid B was applied to the inorganic particle structural body (1) by using a MicroGravure roll (manufactured by Yasui Seiki Co., Ltd., 230 meshes) and then was dried at 50° C. These operations were each performed three times, so that an inorganic particle structural body (3) was obtained. According to the cross-section observation of the inorganic particle structural body, the thickness of the layer made up of a composition containing inorganic particles was about 1.6 μm. The inorganic particle structural body (3) obtained above was preheated at 160° C. for 5 minutes by using a compression molding machine and then pressed under a certain condition, i.e., primary compression: at 160° C., 70 kgf/cm², for 15 seconds, secondary compression: at 30° C., 70 kgf/cm² for 5 minutes, so that inorganic particle composite body (5) was obtained. The inorganic particle composite body (5) had a pencil hardness of HB, a degree of scratch resistance under a 250 g load of Level 1, and a degree of peeling by cross-cutting evaluation of Class 0.

### Example 6 to Example 8

The inorganic particle structural body (3) obtained in Example 5 was pressed in the same manner as in Example 5 except for varying only temperature under the conditions given in Table 2, so that inorganic particle composite bodies (6) to (8) were obtained. These inorganic particle composite bodies were superior in pencil hardness in comparison to Comparative Example 2 and Comparative Example 9 as shown in Table 2.

### Comparative Example 9

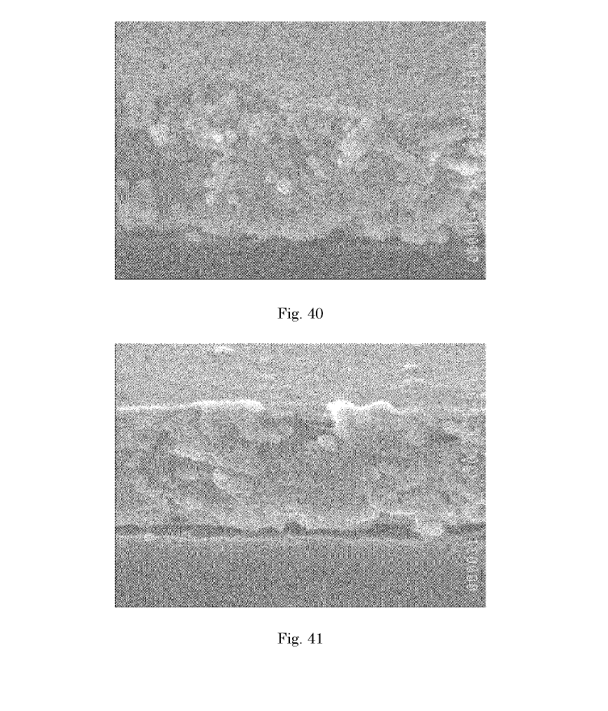

The inorganic particle structural body (3) had a pencil hardness of 6B or less, a degree of scratch resistance under a 250 g load of Level 3, and a degree of peeling by cross-cutting evaluation of Class 4. A SEM observation photograph of the inorganic particle structural body of Comparative Example 9 is shown in FIG. 40.

TABLE 2

| | | | Degree of | |
|---|---|---|---|---|
| | | | scratch | |
| | | | resistance | |
| | Pressing | Pencil | (250 g | Cross-cutting |
| | temperature | hardness | load) | evaluation |
| Example 5 | 160° C. | B | Level 2 | Class 0 |
| Example 6 | 165° C. | B | Level 2 | No evaluation |
| Example 7 | 170° C. | 2B | Level 2 | No evaluation |
| Example 8 | 175° C. | 2B | Level 1 | No evaluation |
| Comparative | No pressing | 6B or | Level 3 | No evaluation |
| Example 2 | | less | | |
| Comparative | No pressing | 6B or | Level 3 | Class 4 |
| Example 9 | | less | | |

### Example 9

The inorganic particle structural body (3) obtained in Example 5 was preheated at 160° C. for 5 minutes by using a compression molding machine and then pressed under a certain condition, i.e., primary compression: at 160° C., 20 kgf/cm², for 15 seconds, secondary compression: at 30° C., 20 kgf/cm² for 5 minutes, so that inorganic particle composite body (9) was obtained. The inorganic particle composite body (9) had a pencil hardness of HB and a degree of scratch resistance under a 250 g load of Level 2.

### Example 10 to Example 12

The inorganic particle structural body (3) obtained in Example 5 was pressed in the same manner as in Example 9 except for varying only temperature under the conditions given in Table 3, so that inorganic particle composite bodies (10) to (12) were obtained. These inorganic particle composite bodies were superior in pencil hardness in comparison to Comparative Example 2 and Comparative Example 9 as shown in Table 3.

TABLE 3

| | | | Degree of |
|---|---|---|---|
| | | | scratch |
| | Pressing | Pencil | resistance |
| | temperature | hardness | (250 g load) |
| Example 9 | 160° C. | HB | Level 2 |
| Example 10 | 165° C. | F | Level 2 |
| Example 11 | 170° C. | B | Level 1 |
| Example 12 | 175° C. | B | Level 1 |
| Comparative | No pressing | 6B or less | Level 3 |
| Example 2 | | | |
| Comparative | No pressing | 6B or less | Level 3 |
| Example 9 | | | |

### Example 13 to Example 15

The inorganic particle structural body (3) obtained in Example 5 was pressed in the same manner as in Example 9 except for varying only pressing time under the conditions given in Table 4, so that inorganic particle composite bodies (13) to (15) were obtained. These inorganic particle composite bodies were superior in pencil hardness in comparison to Comparative Example 2 and Comparative Example 9 as shown in Table 4.

TABLE 4

| | | | Degree of |
|---|---|---|---|
| | | | scratch |
| | Pressing | Pencil | resistance |
| | time | hardness | (250 g load) |
| Example 13 | 1 minute | B | Level 2 |
| Example 14 | 5 minutes | HB | Level 2 |
| Example 15 | 10 minutes | HB | Level 2 |
| Comparative | No | 6B or less | Level 3 |
| Example 2 | pressing | | |
| Comparative | No | 6B or less | Level 3 |
| Example 9 | pressing | | |

### Example 16

The inorganic particle structural body (3) obtained in Example 5 was preheated at 160° C. for 5 minutes by using a compression molding machine and then pressed under a certain condition, i.e., primary compression: at 160° C., 1 kgf/cm² or lower, for 5 minutes, secondary compression: at 30° C., 70 kgf/cm² for 5 minutes, so that inorganic particle composite body (16) was obtained. The inorganic particle composite body (16) had a pencil hardness of B and a degree of scratch resistance under a 250 g load of Level 2.

### Example 17 to Example 18

The inorganic particle structural body (3) obtained in Example 5 was pressed in the same manner as in Example 16 except for varying only pressing pressure under the conditions given in Table 5, so that inorganic particle composite bodies (17) to (18) were obtained. These inorganic particle composite bodies were superior in pencil hardness in comparison to Comparative Example 2 and Comparative Example 9 as shown in Table 5. A SEM observation photograph of the inorganic particle composite body of Example 17 is shown in FIG. 41.

TABLE 5

| | | | Degree of |
|---|---|---|---|
| | | | scratch |
| | | Pencil | resistance |
| | Pressing pressure | hardness | (250 g load) |
| Example 16 | 1 kgf/cm² or less | B | Level 2 |
| Example 17 | 18 kgf/cm² | F | Level 1 |
| Example 18 | 50 kgf/cm² | B | Level 2 |
| Comparative | No pressing | 6B or | Level 3 |
| Example 2 | | less | |
| Comparative | No pressing | 6B or | Level 3 |
| Example 9 | | less | |

### Example 19

Coating liquid B was applied to the inorganic particle structural body (1) by using a MicroGravure roll (manufactured by Yasui Seiki Co., Ltd., 120 meshes) and then was dried at 50° C., so that inorganic particle structural body (4) was obtained. The inorganic particle structural body (4) was preheated at 160° C. for 5 minutes by using a compression molding machine and then pressed under a certain condition, i.e., primary compression: at 160° C., 70 kgf/cm², for 5 minutes, secondary compression: at 30° C., 70 kgf/cm² for 5 minutes, so that inorganic particle composite body (19) was obtained. The inorganic particle composite body (19) had a surface resistivity of 3×10¹⁴Ω/□, a pencil hardness of 2B, and a scratch resistance of Level 2.

### Example 20 to Example 21

Coating liquid C was applied to substrate A by using a MicroGravure roll (manufactured by Yasui Seiki Co., Ltd., 230 meshes) and then was dried at 50° C., so that inorganic particle structural body (5) was obtained. Coating liquid D was applied to the inorganic particle structural body (5) by using a MicroGravure roll (manufactured by Yasui Seiki Co., Ltd., 120 meshes), dried at 50° C., and then pressed under a certain condition, i.e., primary compression: at 160° C., 70 kgf/cm², for 5 minutes, secondary compression: at 30° C., 70 kgf/cm² for 5 minutes, so that inorganic particle composite body (20) was obtained. In a similar manner, coating liquid E was applied to the inorganic particle structural body (5), dried, and then compressed, so that an inorganic particle composite body (21) was obtained. Surface resistivities and pencil hardnesses are as shown in Table 6.

TABLE 6

| | | | | Degree of |
|---|---|---|---|---|
| | | Surface | | scratch |
| | Coating | resistivity | Pencil | resistance |
| | liquid | (Ω/□) | hardness | (250 g load) |
| Example 19 | Coating | 3 × 10¹⁴ Ω/□ | 2B | Level 2 |
| | liquid B | | | |
| Example 20 | Coating | 2 × 10¹³ Ω/□ | 2B | Level 1 |
| | liquid D | | | |
| Example 21 | Coating | 4 × 10¹⁰ Ω/□ | 2B | Level 2 |
| | liquid E | | | |

### Example 22

Coating liquid A was applied to substrate B by using a bar coater (manufactured by Dai-ichi Rika Co., Ltd., wire gage: #1) and was dried at 60° C., so that inorganic particle structural body (6) was obtained. Coating liquid B was applied to the inorganic particle structural body (6) by using a bar coater (manufactured by Dai-ichi Rika Co., Ltd., wire gage: #1) and was dried at 60° C., so that inorganic particle structural body (7) was obtained. According to the cross-section observation of the inorganic particle structural body, the thickness of the layer made up of a composition containing inorganic particles was about 0.8 μm. The inorganic particle structural body (7) obtained above was preheated at 90° C. for 5 minutes by using a compression molding machine and then pressed under a certain condition, i.e., primary compression: at 90° C., 70 kgf/cm², for 5 minutes, secondary compression: at 30° C., 70 kgf/cm² for 5 minutes, so that inorganic particle composite body (22) was obtained. The inorganic particle composite body (22) had a pencil hardness of 4H and a degree of scratch resistance under a 500 g load of Level 1.

### Example 23 to Example 24

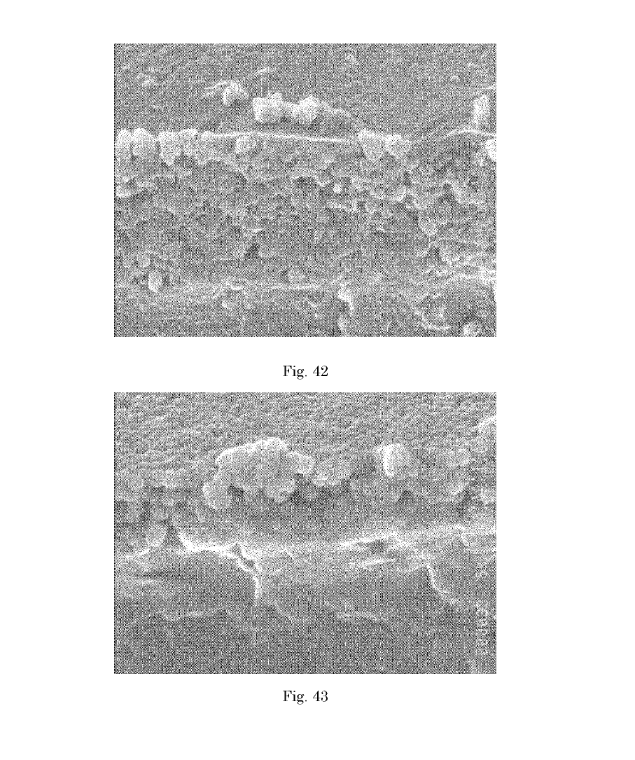

The inorganic particle structural body (7) obtained in Example 22 was pressed in the same manner as in Example 22 except for varying only pressing temperature under the conditions given in Table 7, so that inorganic particle composite bodies (23) to (24) were obtained. The results were better in comparison to Comparative Examples 10 and Comparative Example 11 with respect to pencil hardness as shown in Table 7. The degree of peeling by cross-cutting evaluation of the inorganic particle composite body (24) was Class 0. A SEM observation photograph of the inorganic particle composite body of Example 24 is shown in FIG. 42.

### Comparative Example 10

The substrate B had a pencil hardness of H and a degree of scratch resistance under a 500 g load of Level 3.

### Comparative Example 11

Coating liquid A was applied to substrate B by using a bar coater (manufactured by Dai-ichi Rika Co., Ltd., wire gage: #1) and was dried at 60° C., so that inorganic particle structural body (6) was obtained. Coating liquid B was applied to the inorganic particle structural body (6) by using a bar coater (manufactured by Dai-ichi Rika Co., Ltd., wire gage: #1) and was dried at 60° C., so that inorganic particle structural body (7) was obtained. According to the cross-section observation of the inorganic particle structural body, the thickness of the layer made up of a composition containing inorganic particles was about 0.8 μm. The inorganic particle structural body (7) had a pencil hardness of H, a degree of scratch resistance of Level 3, and a degree of peeling by cross-cutting evaluation of Class 4. A SEM observation photograph of the inorganic particle structural body of Comparative Example 11 is shown in FIG. 43.

TABLE 7

| | | | Degree of | |
|---|---|---|---|---|
| | | | scratch | |
| | | | resistance | |
| | Pressing | Pencil | (500 g | Cross-cutting |
| | temperature | hardness | load) | evaluation |
| Example 22 | 90° C. | 4H | Level 1 | No evaluation |
| Example 23 | 100° C. | 4H | Level 2 | No evaluation |
| Example 24 | 110° C. | 4H | Level 1 | Class 0 |
| Comparative | No pressing | H | Level 3 | No evaluation |
| Example 10 | | | | |
| Comparative | No pressing | H | Level 3 | Class 4 |
| Example 11 | | | | |

### Example 25

Coating liquid G was applied to the inorganic particle structural body (1) by using a MicroGravure roll (manufactured by Yasui Seiki Co., Ltd., 230 meshes) and then was dried at 50° C., so that inorganic particle structural body (8) was obtained. While conveying the inorganic particle structural body at 0.2 m/min, laser irradiation was applied thereto by using a laser heating machine (manufacturer: Onizca Glass Co., Ltd., name of machine: seal-off type carbon dioxide gas laser machine, oscillation wavelength: 10.6 μm, irradiation width: 12 cm) at an output of 30 W, so that inorganic particle composite body (25) was obtained. The pencil hardness of the inorganic particle composite body (25) was 6B.

### Comparative Example 12

Substrate A that had been irradiated with laser at an output of 30 W by using a laser heating machine while being conveyed at 0.2 m/min had a pencil hardness of 6B or less.

### Comparative Example 13

The pencil hardness of the inorganic particle structural body (8) was 6B or less.

### Example 26

Coating liquid B was applied to the inorganic particle structural body (1) by using a MicroGravure roll (manufactured by Yasui Seiki Co., Ltd., 230 meshes) and then was dried at 50° C. These operations were each performed five times, so that an inorganic particle structural body (9) was obtained. The inorganic particle structural body was irradiated with laser at an output of 30 W by using a laser heating machine while being conveyed at 0.2 m/min, so that inorganic particle composite body (26) was obtained. The pencil hardness of the inorganic particle composite body (26) was 6B.

### Comparative Example 14

The pencil hardness of the inorganic particle structural body (9) was 6B or less.

### Example 27

Coating liquid H was applied to substrate B by using a bar coater (manufactured by Dai-ichi Rika Co., Ltd., wire gage: #8) and was dried at 50° C., so that inorganic particle structural body (10) was obtained. Coating liquid H was applied to the inorganic particle structural body (10) by using a bar coater (manufactured by Dai-ichi Rika Co., Ltd., wire gage: #1) and was dried at 50° C., so that hydrophilic inorganic particle structural body (11) was obtained. The estimated thickness of the inorganic particle layer formed by the application of the coating liquid H to the substrate B was about 10 μm. The hydrophilic inorganic particle structural body (11) was preheated at 110° C. for 5 minutes by using a compression molding machine and then pressed under a certain condition, i.e., primary compression: at 110° C., 70 kgf/cm², for 5 minutes, secondary compression: at 30° C., 70 kgf/cm² for 5 minutes, so that hydrophilic inorganic particle composite body (27) was obtained. The hydrophilic inorganic particle composite body (27) had a water contact angle of 27°, a pencil hardness of 5H, and a degree of peeling by cross-cutting evaluation of Class 2.

### Example 28 to Example 31

The hydrophilic inorganic particle structural body (11) obtained in Example 27 was pressed in the same manner as in Example 27 except for varying temperature under the conditions given in Table 8, so that hydrophilic inorganic particle composite bodies (27) to (31) were obtained. The results were better in comparison to Comparative Examples 14 and Comparative Example 15 with respect to pencil hardness as shown in Table 8.

### Comparative Example 15

The substrate B had a water contact angle of 72° and a pencil hardness of H.

### Comparative Example 16

The aforementioned hydrophilic inorganic particle structural body (11) had a water contact angle of 7°, a pencil hardness of 6B or less, and a degree of peeling by cross-cutting evaluation of Class 5.

TABLE 8

| | Pressing | Contact | Pencil | Cross-cutting |
|---|---|---|---|---|
| | temperature | angle | hardness | evaluation |
| Example 29 | 110° C. | 27° | 5H | Class 2 |
| Example 28 | 115° C. | 33° | 5H | Class 2 |
| Example 29 | 120° C. | 37° | 7H | Class 2 |
| Example 30 | 130° C. | 40° | 7H | Class 2 |
| Example 31 | 140° C. | 48° | 9H | Class 1 |
| Comparative | No pressing | 72° | H | No evaluation |
| Example 15 | | | | |
| Comparative | No pressing | 7° | 6B or less | Class 5 |
| Example 16 | | | | |

### Example 32

Coating liquid A was applied to substrate D by using a MicroGravure roll (manufactured by Yasui Seiki Co., Ltd., 230 meshes) and then was dried at 50° C., so that inorganic particle structural body (12) was obtained. Coating liquid B was applied to the inorganic particle structural body (12) by using a MicroGravure roll (manufactured by Yasui Seiki Co., Ltd., 230 meshes) and then was dried at 50° C. These operations were each performed seven times, so that an inorganic particle structural body (13) was obtained. The inorganic particle structural body (13) obtained above was pressed by using a compression molding machine (manufactured by SHINTO Metal Industries Corporation) under a certain condition, i.e., primary compression: at 200° C., 70 kgf/cm², for 5 minutes, secondary compression: at 30° C., 70 kgf/cm² for 5 minutes, so that inorganic particle composite body (32) was obtained. Coating liquid I was applied to the inorganic particle composite body (32) by using a bar coater (manufactured by Dai-ichi Rika Co., Ltd., wire gage: #1), so that inorganic particle composite body (33) was obtained. The inorganic particle composite body (33) had a pencil hardness of 2H and a contact angle of 11°.

### Comparative Example 17

The inorganic particle structural body (12) had a pencil hardness of 2B and a contact angle of 10°.

### Example 33

Coating liquid B was applied to substrate C by using a MicroGravure roll (manufactured by Yasui Seiki Co., Ltd., 70 meshes) and then was dried at 50° C., so that inorganic particle structural body (13) was obtained. The inorganic particle structural body (13) was immersed in coating liquid J and was naturally dried, so that inorganic particle structural body (14) was obtained. The inorganic particle structural body (14) obtained above was pressed by using a compression molding machine (manufactured by SHINTO Metal Industries Corporation) under a certain condition, i.e., primary compression: at 120° C., 70 kgf/cm², for 5 minutes, secondary compression: at 30° C., 70 kgf/cm² for 5 minutes, so that inorganic particle composite body (34) was obtained. The inorganic particle composite body (34) had a contact angle of 127°, a coefficient of static friction of 0.4, a coefficient of dynamic friction of 0.4, and a degree of scratch resistance under a load of 500 g of Level 2.

### Comparative Example 18

The inorganic particle structural body (13) had a contact angle of 13°, a coefficient of static friction of 0.4, a coefficient of dynamic friction of 0.4, and a degree of scratch resistance under a load of 500 g of Level 3.

### Comparative Example 19

The inorganic particle structural body (13) obtained above was pressed by using a compression molding machine (manufactured by SHINTO Metal Industries Corporation) under a certain condition, i.e., primary compression: at 120° C., 70 kgf/cm², for 5 minutes, secondary compression: at 30° C., 70 kgf/cm² for 5 minutes, so that inorganic particle composite body (35) was obtained. The inorganic particle composite body (31) had a contact angle of 13°, a coefficient of static friction of 0.6, a coefficient of dynamic friction of 0.6, and a degree of scratch resistance under a load of 500 g of Level 2.

### Comparative Example 20

The inorganic particle structural body (14) had a contact angle of 128°, a coefficient of static friction of 0.4, a coefficient of dynamic friction of 0.4, and a degree of scratch resistance under a load of 500 g of Level 3.

TABLE 9

| | | | | Degree of |
|---|---|---|---|---|
| | | | | scratch |
| | | Coefficient | Coefficient | resistance |
| | Contact | of static | of dynamic | (500 g |
| | angle | friction | friction | load) |
| Example 33 | 127° | 0.4 | 0.4 | Level 2 |
| Comparative | 13° | 0.4 | 0.4 | Level 3 |
| Example 18 | | | | |
| Comparative | 13° | 0.6 | 0.6 | Level 2 |
| Example 19 | | | | |
| Comparative | 128° | 0.4 | 0.4 | Level 3 |
| Example 20 | | | | |

### Example 34

Coating liquid K was applied to substrate C by using a MicroGravure roll (manufactured by Yasui Seiki Co., Ltd., 70 meshes) and then was dried at 50° C., so that inorganic particle structural body (15) was obtained. The inorganic particle structural body (15) was immersed in coating liquid J and was naturally dried, so that inorganic particle structural body (16) was obtained. The inorganic particle structural body (16) obtained above was pressed by using a compression molding machine (manufactured by SHINTO Metal Industries Corporation) under a certain condition, i.e., primary compression: at 120° C., 70 kgf/cm², for 5 minutes, secondary compression: at 30° C., 70 kgf/cm² for 5 minutes, so that inorganic particle composite body (36) was obtained. The inorganic particle composite body (36) had a contact angle of 126°, a coefficient of static friction of 0.4, a coefficient of dynamic friction of 0.4, and a degree of scratch resistance under a load of 500 g of Level 1.

### Comparative Example 21

The inorganic particle structural body (15) had a contact angle of 36°, a coefficient of static friction of 0.4, a coefficient of dynamic friction of 0.4, and a degree of scratch resistance under a load of 500 g of Level 2.

### Comparative Example 22

The inorganic particle structural body (16) had a contact angle of 130°, a coefficient of static friction of 0.4, a coefficient of dynamic friction of 0.4, and a degree of scratch resistance under a load of 500 g of Level 2.

TABLE 10

| | | | | Degree of |
|---|---|---|---|---|
| | | | | scratch |
| | | Coefficient | Coefficient | resistance |
| | Contact | of static | of dynamic | (500 g |
| | angle | friction | friction | load) |
| Example 33 | 127° | 0.4 | 0.4 | Level 1 |
| Comparative | 36° | 0.4 | 0.4 | Level 2 |
| Example 21 | | | | |
| Comparative | 130° | 0.5 | 0.4 | Level 2 |
| Example 22 | | | | |

### Example 35

The inorganic particle composite body (36) was worn on its surface in a scratch resistance strength test under a load of 500 g, so that an inorganic particle composite body (37) was obtained. The inorganic particle composite body (37) had a contact angle of 127°.

### Example 36

The inorganic particle composite body (34) was worn on its surface in a scratch resistance strength test under a load of 500 g, so that inorganic particle composite body (38) was obtained. The inorganic particle composite body (38) had a contact angle of 60°.

### Example 37

The inorganic particle structural body (15) obtained above was pressed by using a compression molding machine (manufactured by SHINTO Metal Industries Corporation) under a certain condition, i.e., primary compression: at 120° C., 70 kgf/cm², for 5 minutes, secondary compression: at 30° C., 70 kgf/cm² for 5 minutes, so that inorganic particle composite body (39) was obtained. It was immersed in coating liquid Land then was naturally dried, so that inorganic particle composite body (40) was obtained. The inorganic particle composite body (40) had a contact angle of 130° and its scratch resistance strength under a load of 500 g was at Level 1.

### Example 38

The inorganic particle composite body (40) was worn on its surface in a scratch resistance strength test under a load of 500 g, so that inorganic particle composite body (41) was obtained. The inorganic particle composite body (41) had a contact angle of 126°.

TABLE 11

| | Contact |
|---|---|
| | angle |
| Example 35 | 127° |
| Example 36 | 60° |
| Example 37 | 130° |
| Example 38 | 126° |

### Example 39

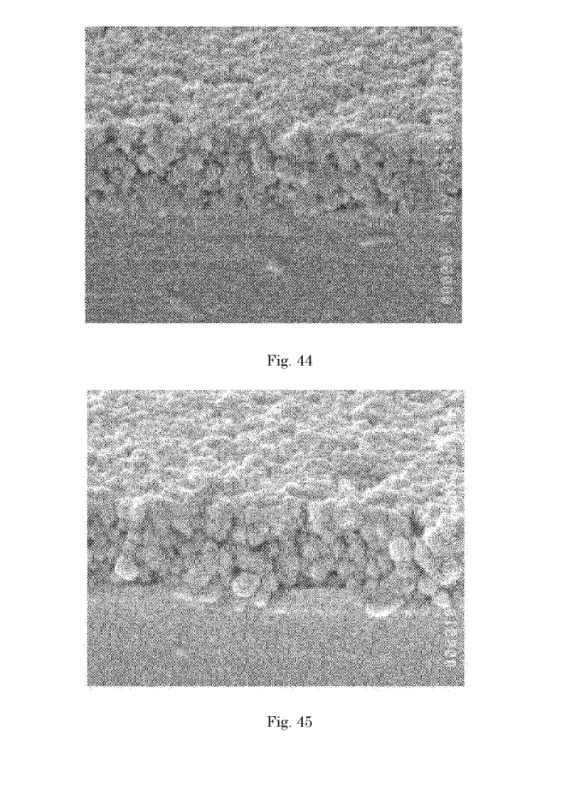

Coating liquid M was applied to the inorganic particle structural body (2) by using a MicroGravure roll (manufactured by Yasui Seiki Co., Ltd., 230 meshes) and then was dried at 50° C., so that antireflection-treated inorganic particle structural body (16) was obtained. The inorganic particle structural body (16) obtained above was pressed by using a compression molding machine (manufactured by SHINTO Metal Industries Corporation) under a certain condition, i.e., primary compression: at 150° C., 70 kgf/cm², for 5 minutes, secondary compression: at 30° C., 70 kgf/cm² for 5 minutes, so that antireflective inorganic particle composite body (42) was obtained. According to the cross-section observation of the antireflective inorganic particle composite body (42), the thickness of the layer made up of a composition containing inorganic particles was about 0.9 μm. A SEM cross-sectional observation image is shown in FIG. 44. The antireflective inorganic particle composite body (42) had a pencil hardness of B, a degree of scratch resistance under a load of 125 g of Level 1, and a reflectance at 500 nm of 1.3%.

### Comparative Example 23

The inorganic particle structural body (2) had a pencil hardness of 6B or less, a degree of scratch resistance under a load of 125 g of Level 3, and a reflectance at 500 nm of 1.9%.

### Comparative Example 24

The inorganic particle structural body (2) was pressed by using a compression molding machine (manufactured by SHINTO Metal Industries Corporation) under a certain condition, i.e., primary compression: at 150° C., 70 kgf/cm², for 5 minutes, secondary compression: at 30° C., 70 kgf/cm² for 5 minutes, so that inorganic particle composite body (43) was obtained. The inorganic particle composite body (43) had a pencil hardness of B, a degree of scratch resistance under a load of 125 g of Level 2, and a reflectance at 500 nm of 2.7%.

### Comparative Example 25

According to the cross-section observation of the inorganic particle structural body (16), the thickness of the layer made up of a composition containing inorganic particles was about 0.9 μm. A SEM cross-sectional observation image is shown in FIG. 45. The inorganic particle structural body (16) had a pencil hardness of 6B or less, a degree of scratch resistance under a load of 125 g of Level 3, and a reflectance at 500 nm of 0.7%.

TABLE 12

| | | | Degree of |
|---|---|---|---|
| | | | scratch |
| | Reflectance | Pencil | resistance |
| | at 500 nm | hardness | (125 g load) |
| Example 38 | 1.3 | B | Level 1 |
| Comparative | 1.9 | 6B or less | Level 3 |
| Example 23 | | | |
| Comparative | 2.8 | B | Level 2 |
| Example 24 | | | |
| Comparative | 0.7 | 6B or less | Level 3 |
| Example 25 | | | |

### Example 40

Coating liquid A was applied to substrate A by using a MicroGravure roll (manufactured by Yasui Seiki Co., Ltd., 230 meshes) and then was dried at 50° C., so that inorganic particle structural body (1) was obtained. Coating liquid B was applied to the inorganic particle structural body (1) by using a MicroGravure roll (manufactured by Yasui Seiki Co., Ltd., 230 meshes) and then was dried at 50° C., so that inorganic particle structural body (2) was obtained. The inorganic particle structural body (2) was pressed by using a compression molding machine (manufactured by SHINTO Metal Industries Corporation) under a certain condition, i.e., primary compression: at 140° C., 70 kgf/cm², for 10 minutes, secondary compression: at 30° C., 70 kgf/cm² for 5 minutes, so that inorganic particle composite body (1) was obtained. No substrate component oozed out to the surface where silica particles were exposed. Adhesive A was applied to the silica particles exposing surface of the inorganic particle composite body (1) by using a bar coater (manufactured by Dai-ichi Rika Co., Ltd., wire gage: #8) and then a glass plate was laminated. The estimated coating thickness of the adhesive is 300 nm. The peak of test force applied in peeling the inorganic particle composite body (1) from the glass was 3 N, and therefore the adhesiveness to a glass plate was better in comparison to Comparative Example 1.

### Comparative Example 26

Adhesive A was applied to substrate A by using a bar coater (manufactured by Dai-ichi Rika Co., Ltd., wire gage: #8) and then a glass plate was laminated. The estimated coating thickness of the adhesive is 300 nm. The peak of test force in peeling the substrate A from the glass was 0.3 N.

### Example 41

Coating liquid B was applied to the inorganic particle structural body (1) by using a MicroGravure roll (manufactured by Yasui Seiki Co., Ltd., 230 meshes) and then was dried at 50° C., so that inorganic particle structural body (2) was obtained. The same procedure was repeated further twice, so that inorganic particle structural body (3) was obtained. Pressing treatment by using a compression molding machine (manufactured by SHINTO Metal Industries Corporation) under a certain condition, i.e., primary compression: at 140° C., 70 kgf/cm², for 10 minutes, secondary compression: at 30° C., 70 kgf/cm² for 5 minutes afforded inorganic particle composite body (2). No substrate component oozed out to the surface where silica particles were exposed. Adhesive A was applied to the silica particles exposing surface of the inorganic particle composite body (2) by using a bar coater (manufactured by Dai-ichi Rika Co., Ltd., wire gage: #2) and then a 100 μm thick glass plate was laminated, so that a stacked inorganic particle composite body (1) was obtained. The estimated coating thickness of the adhesive is 70 nm. When the stacked inorganic particle structural body (1) was bent, the glass was broken at the time when both ends were approached to a distance of 2.5 cm; flexibility was improved than glass itself.

### Comparative Example 27

When the 100 μm thick glass plate used in Example 2 was bent, the glass was broken at the time when both ends were approached to a distance of 4 cm.

### Example 42

Coating liquid A was applied to substrate A by using a MicroGravure roll (manufactured by Yasui Seiki Co., Ltd., 230 meshes) and then was dried at 50° C., so that inorganic particle structural body (1) was obtained. The inorganic particles-applied side of the inorganic particle structural body (1) was stacked with a plate-shaped mold and then was pressed by using a planar compression molding machine (manufactured by SHINTO Metal Industries Corporation) under a certain condition, i.e., primary compression: at 160° C., 270 kgf/cm², for 3 minutes, secondary compression: at 30° C., 270 kgf/cm² for 3 minutes, so that inorganic particle composite article (1) to which the pattern of the mold had been transferred was obtained. The pencil hardness of the inorganic particle composite article (1) was H.

### Comparative Example 28

Substrate A was stacked with a plate-shaped mold and then was pressed by using a planar compression molding machine (manufactured by SHINTO Metal Industries Corporation) under a certain condition, i.e., primary compression: at 160° C., 270 kgf/cm², for 3 minutes, secondary compression: at 30° C., 270 kgf/cm² for 3 minutes, so that a substrate to which the pattern of the mold had been transferred was obtained. The pencil hardness of the substrate was 2B.

### INDUSTRIAL APPLICABILITY

An inorganic particle composite body of the present invention, in which a substrate made of a solid material having plasticity has been filled into gap portions in an inorganic particle layer, is superior in strength and hardness. It can exhibit various characteristics depending upon the kinds of the inorganic particles and the substrate. For example, when the substrate is made of metal, such effects as electrical conductivity, paramagnetism, ferromagnetism, light reflexibility, light absorptivity by plasmon resonance, rigidity, low linear expansion, ductility, heat resistance, thermal conductivity, chemistry activity, and/or catalytic activity are exhibited. Because of this, a film-shaped inorganic particle composite body of the present invention is possible to be applied to antistatic films, electric conduction films, transparent electric conduction films, electromagnetic wave shielding films, magnetic films, reflection films, ultraviolet shielding films, light diffusing films, antireflection films, antiglare films, hardcoat films, polarizing films, retardation films, light diffusing films, front plates of flat panel displays, windows of portable displays (e.g., cellular phones), films for flexible transparent substrates, gas barrier films, heat conduction films, heat radiation films, antibacterial films, catalyst support films, capacitor electrode films, electrode films of secondary batteries, electrode films of fuel cells, and so on. Moreover, when the inorganic particles are made of a clay mineral, the composite body is extremely superior in substance barrier property due to a maze effect caused by a high aspect ratio of the clay mineral. Because of this, the film-shaped inorganic particle composite body of the present invention is expected to have a substance barrier property that is comparable to that of metal foil and is useful particularly for films for flexible transparent substrates, gas barrier films, transparent electric conduction films, and the like. Moreover, when the substrate is a thermoplastic resin substrate, the part located on the particle side and the substrate are difficult to peel off from each other. Therefore, when an inorganic particle composite body is formed on a film-shaped substrate, it can preferably serve as, for example, an antistatic film, an electric conduction film, a transparent electric conduction film, a magnetic film, a reflection film, an ultraviolet shielding film, a light diffusing film, an antireflection film, an antiglare film, a hardcoat film, a polarizing film, a retardation film, a light diffusing film, a front plate of a flat panel display, a window of a portable display (e.g., a cellular phone), a film for a flexible transparent substrate, an antifouling film, an antifogging film, an agricultural film, an awning, a marking film, a decoration sheet, a surface decoration sheet for insert molding, a gas barrier film, a heat conduction film, a heat radiation film, a heat ray shielding film, an antibacterial film, a catalyst support film, a water-repellent film, a glass adhesive film, an easily cuttable film, a base film for lamination, a base film for extrusion lamination, a capacitor electrode film, an electrode film of a secondary battery, an electrode film of a fuel cell, a solar cell member, a film for solar cell sealing, and an antifouling film of a solar cell surface. When the substrate is made of a thermoplastic resin, the inorganic particle composite body is preferably used for various resin molding material applications, such as an optical lens made of resin, a tire, an automotive interior material, and a bumper material for automobiles, as an additive for resin. Because of superior hardness, the inorganic particle composite body of the present invention is used for optical information media such as a read only optical disk, an optical recording disk, and a magneto-optical recording disk, and display medium members and optical members such as a display screen of a personal computer, a flexible display, an electronic paper, and a contact lens for the purpose of preventing a surface from scratching.

1. An inorganic particle composite body comprising a layer of a substrate formed of a plastically deformable solid material and an inorganic particle layer that is composed of inorganic particles that do not plastically deform under a condition under which the solid material plastically deforms, that contains gaps defined by the inorganic particles, and that adjoins the layer of the substrate, wherein part of the solid material is in at least part of the gaps in the inorganic particle layer.

2. The inorganic particle composite body according to claim 1, wherein the surface of the inorganic particle composite body has hydrophilicity.

3. The inorganic particle composite body according to claim 1, wherein the surface of the inorganic particle composite body has hydrophobicity.

4. The inorganic particle composite body according to claim 1, wherein the surface of the inorganic particle composite body is antireflective.

5. The inorganic particle composite body according to claim 1, wherein the inorganic particle composite body further has a glass layer adjoining to the inorganic particle layer.

6. The inorganic particle composite body according to claim 1, wherein the inorganic particles comprise silica.

7. The inorganic particles composite body according to claim 1, wherein the inorganic particles comprise an inorganic layered compound.

8. The inorganic particle composite body according to claim 1, wherein the solid material is a resin.

9. The inorganic particle composite body according to claim 1, wherein the solid material is a metal.
